(19) United States
(12) Patent Application Publication
(10) Pub. No.: US 2026/0050152 A1
(43) Pub. Date: Feb. 19, 2026

(54) OPTICAL DEVICE

(71) Applicant: HITACHI HIGH-TECH CORPORATION, Tokyo (JP)

(72) Inventor: Takashi ANAZAWA, Tokyo (JP)

(21) Appl. No.: 19/100,960

(22) PCT Filed: Sep. 14, 2022
(86) PCT No.: PCT/JP2022/034453

§ 371 Date: Feb. 4, 2025

(51) Int. Cl. G02B 21/18; G02B 21/00; G02B 21/02; G02B 21/08; G02B 21/36; G02B 27/14

(52) U.S. Cl. CPC G02B 21/18; G02B 21/0076; G02B 21/02; G02B 21/08; G02B 21/361; G02B 27/141; G02B 2207/113

(57) ABSTRACT

An optical device in which a two-dimensionally distributed sample, a single condensing lens, a dichroic-mirror array in which plural dichroic mirrors are arrayed, and an image sensor are lined up in this order along an optical axis of the condensing lens, a direction in which plural dichroic mirrors are arrayed is perpendicular to the optical axis, an image of a measurement region on the sample is split into plural images having different wavelength components by the dichroic-mirror array and measured by the image sensor, and the dichroic-mirror array is closer to the image sensor than the condensing lens.

### TECHNICAL FIELD

The present invention relates to an optical device that performs spectral imaging, i.e., imaging two-dimensionally or three-dimensionally distributed measurement objects while acquiring spectral information of each element of each object using an optical system and an image sensor.

### BACKGROUND ART

Spectral imaging is an important technology utilized in various scientific and technical fields or industrial fields. For example, a foreign substance mixed in a food manufacturing process is identified, strong ultraviolet rays emitted from a galaxy ten billion light years away are detected, localization of nuclei, mitochondria, and actin in a cell is identified, mapping of types of minerals on the ground surface from a satellite is performed, and a site to be resected during surgery for colorectal cancer is identified.

An optical system used for spectral imaging is arbitrary, and an objective lens for a microscope, a telephoto lens for a telescope, or a general camera lens may be used. In the fields of bioanalysis and in vitro diagnostics, spectral imaging using an objective lens for a microscope is active, and is applied to next generation sequencing, digital PCR, flow cytometry, immunohistochemistry, or the like.

For example, in next generation sequencers, while imaging a large number of colonies from a sample dispersed on a two-dimensional plane with a fluorescence microscope, it is identified which of four kinds of fluorophores corresponding to four kinds of bases in each colony is emitting fluorescence, thereby implementing a large-scale DNA sequencing. In immunohistochemistry, cancer diagnosis is performed and a treatment policy is determined by imaging existence and localization of a plurality of types of tumor markers in a tissue section with an optical microscope.

Various measurement methods have been proposed and put into practical use for spectral imaging. Spectral-imaging measurement methods can be classified into four types of (1) a point-scanning method, (2) a line-scanning method, (3) a wavelength-scanning method, and (4) a snapshot method.

In the point-scanning method, lights from one point in a two-dimensionally distributed measurement region are spectrally measured at a time, and the position of the one point is scanned in two dimensions over the measurement region to obtain spectral information of the entire measurement region. In the line-scanning method, lights from one line in a two-dimensionally distributed measurement region are spectrally measured at a time, and the position of the one line is scanned in one dimension over the measurement region to obtain spectral information of the entire measurement region. In the wavelength-scanning method, lights from a two-dimensionally distributed measurement region are measured at a time for one wavelength, and the wavelength of the one wavelength is scanned over the measurement wavelength range to obtain spectral information of the entire measurement region. In the snapshot method, lights from a two-dimensionally distributed measurement region are spectrally measured at a time without scanning anything.

When described in this way, the snapshot method seems to be the most excellent, but this is not always the case. This is because various performances in spectral imaging such as time resolution, spatial resolution, wavelength resolution, and measurement-region size have a trade-off relationship in any of these measurement methods. For example, the snapshot method has higher time resolution but smaller measurement-region size than the wavelength-scanning method in a case where both the methods have the same spatial resolution and wavelength resolution using the same optical system and image sensor.

There are various sub-methods in each of these measurement methods. These methods have, depending on each device configuration and the like, various advantages and disadvantages in terms of device size, cost, and the like as well as above-described the various performances.

Accordingly, it is important to select an appropriate measurement method and device according to the purpose of spectral imaging.

As one of the snapshot methods, an image-splitting method using a dichroic mirror has been put into practical use. The image-splitting method is highly sensitive because both lights transmitted through a dichroic mirror and lights reflected by the dichroic mirror are used with high efficiency.

For example, MultiSplit V2 manufactured by CAIRN Research and Quad-View manufactured by Optical Insights have been commercialized as spectral imaging devices by the image-splitting method. Conventionally, a digital camera, i.e., an image sensor is connected to a camera port of a microscope to measure an image of a two-dimensionally or three-dimensionally distributed measurement region of a sample. By inserting one of these devices between the microscope and the digital camera, namely, by connecting the microscope, the spectral imaging device by the image-splitting method, and the image sensor in this order, the two-dimensionally or three-dimensionally distributed measurement region of the sample can be simultaneously measured as up to four split images with four different wavelength bands.

In the present specification, different wavelength bands may be referred to as different colors, and four different wavelength bands may be referred to as four colors. In the present specification, hereinafter, a two-dimensionally or three-dimensionally distributed measurement region of a sample, or a two-dimensionally or three-dimensionally distributed sample may be referred to as a two-dimensionally distributed sample or simply as a sample. That is, in the present specification, “two-dimensionally distributed” does not exclude the case of “three-dimensionally distributed”. These devices are characterized in that it is possible to perform up to four-split, four-color imaging of the measurement region of the sample at the same time even though one image sensor is used.

FIG. 9 of PTL 1 illustrates a configuration of the above-described spectral imaging device by the image-splitting method. A light from a two-dimensionally distributed measurement region O of a sample is condensed by a first condensing lens 14 and a first image-formation lens 16, and a first image 18 of the measurement region O is formed on a first iris 20. A first aperture having an appropriate size is provided at an appropriate position on the first iris 20.

Of the light from the first image 18, a light that can pass through the first aperture is collimated by a second condensing lens 24, passes through a second aperture provided in a second iris 29, and is incident on a dichroic mirror (dichroic filter) 60 inclined at 45° with respect to a light traveling direction. The incident light is split into a transmitted light and a reflected light having different wavelength components by the dichroic mirror 60. Each of the transmitted light and the reflected light forms second images at different positions on an image sensor 36 by a second image-formation lens 34 through a mirror 28 and a filter 30. The two second images of the measurement region O having different wavelength components are formed at different positions on the image sensor 36 so as not to overlap each other. That is, in FIG. 9, two-split, two-color imaging of the measurement region of the two-dimensionally distributed sample is simultaneously performed using the one dichroic mirror and the one image sensor. As illustrated in FIG. 9, each of the transmitted light and the reflected light is incident on the second image-formation lens 34 with an angle with respect to an optical axis A by the mirror 28.

In a device configuration similar to that of FIG. 9, the number of splits and the number of colors can be increased by increasing the number of dichroic mirrors. For example, when two dichroic mirrors are combined, an incident light can be split into three emitted lights having different wavelength components. Thereby, three-splitting, three-color imaging of a measurement region of a two-dimensionally distributed sample can be simultaneously performed while one image sensor is used. Alternatively, when three dichroic mirrors are combined, an incident light can be split into four emitted lights having different wavelength components. Thereby, four-splitting, four-color imaging of a measurement region of a two-dimensionally distributed sample can be simultaneously performed while one image sensor is used.

One of the features in the configuration of the above spectral imaging device by the image-splitting method using the dichroic mirror is that the light from the measurement region of the two-dimensionally distributed sample forms the first image before being incident on the dichroic mirror, and the iris and the aperture are provided at the position of the first image. This is because, when such a configuration is not adopted, different split images overlap on an image sensor and split images cannot be measured independently.

PTL 2 discloses a device configuration in which not a two-dimensionally distributed sample but a plurality of samples as a plurality of light-emitting points configuring a light-emitting-point array is a measurement target, and a light emitted from each light-emitting point is detected in multiple colors independently with high sensitivity using a dichroic-mirror array in which plural dichroic mirrors are arrayed.

That is, the multicolor-detection device of PTL 2 is different from the spectral imaging device of PTL 1, but the both devices have in common that the light from the measurement target is split into the lights with a plurality of wavelength components by using one or more dichroic mirrors, and the multicolor detection is simultaneously performed with high efficiency. In PTL 2, downsizing and cost reduction of the multicolor detection device are implemented.

FIG. 7 of PTL 2 illustrates a configuration example of a four-color detection device. As illustrated in FIG. 7(a), a light emitted from each of four light-emitting points 1 arrayed at equal intervals on a straight line (a light-emitting-point array) is condensed by each of four condensing lenses 2 arrayed in the same manner (a condensing-lens array) to form a light beam 9. As illustrated in FIG. 7(b), each light beam 9 is transmitted through one long-pass filter 10 and split into four light beams 21, 22, 23, and 24 having four different types of wavelength components by a dichroic-mirror array (four types of dichroic mirrors 17, 18, 19, and 20 are arrayed in a direction perpendicular to both a direction in which the four condensing lenses 2 are arrayed and an optical axis direction of the condensing lens 2). As a result, a total of sixteen light beams are incident on one image sensor 30.

As illustrated in FIG. 7(c), a total of sixteen light beams form four sets of light-emitting-point images 25, 26, 27, and 28 at different positions on the one image sensor 30, and are independently and simultaneously measured. That is, four-color detection of the light emissions from the four light-emitting points is simultaneously performed. In order to measure the light emission from each light-emitting point with high sensitivity, for example, as illustrated in [Expression 6], it is effective to reduce a focal length of each condensing lens. In order to independently measure the light emission from each light-emitting point, for example, as illustrated in [Expression 17], it is effective to reduce the optical-path length of the light beam having the maximum optical-path length among the plurality of split light beams and to reduce image magnification of each light-emitting-point image. That is, it is effective to position the light-emitting-point array, the condensing-lens array, the dichroic-mirror array, and the image sensor close to each other to reduce the size of the multicolor detection device including these.

In PTL 2, as described in [0065], it is defined that a maximum width of a parallel light beam that can be split by a dichroic-mirror array as designed, namely, can be split without vignetting inside the dichroic-mirror array is an aperture width. It is important to increase the aperture width in order to secure a light amount to improve sensitivity.

As is clear from a comparison between FIGS. 14 and 15 of PTL 2, it is illustrated that when plural dichroic mirrors having the same size are arrayed at the same interval, the aperture width can be made larger by arraying the plural dichroic mirrors in a stepwise manner rather than arraying the plural dichroic mirrors on the same plane.

Meanwhile, in PTL 2, as illustrated in FIG. 24(a), because plural split lights generated by a dichroic-mirror array have different optical-path lengths to an image sensor, all images of the split lights cannot be focused on the image sensor. However, as illustrated in FIG. 24(b), by inserting optical-path-length-adjustment elements having different lengths into the optical paths of the plurality of split lights, the optical-path lengths can be adjusted to be equal to each other to focus on all the images of the split lights.

In the multicolor detection device of PTL 2, when the number of dichroic mirrors is increased, and the number of splits and the number of simultaneously detectable colors are increased, the maximum optical-path length among the optical-path lengths of the plurality of split lights is increased and the optical-path-length difference that is the difference between the maximum optical-path length and the minimum optical-path length is increased. Thereby, it becomes difficult to independently measure the light emissions from the plurality of light-emitting points or to focus on all the split images of the light emissions from the plurality of light-emitting points.

On the other hand, in PTL 3, in order to solve the above problem, as illustrated in FIG. 1, plural dichroic mirrors are arrayed along two directions opposite to each other instead of being arrayed along one direction as in PTL 2. In a multicolor detection device using a dichroic-mirror array having such a configuration, the maximum optical-path length and the optical-path-length difference can be halved. Thereby, the number of splits and the number of simultaneously detectable colors can be increased using a larger number of dichroic mirrors.

FIG. 29 of PTL 3 illustrates a configuration example of a nine-color-detection device. Five dichroic mirrors are arrayed along a right direction from a center in a bottom row. In addition, another five dichroic mirrors are arrayed along a left direction from the center in a top row. That is, a dichroic-mirror array including a total of ten dichroic mirrors is illustrated. Similarly to PTL 2, a large aperture width is secured by arraying the dichroic mirrors in a stepwise manner.

### CITATION LIST

### Patent Literature

PTL 1: U.S. Pat. No. 5,982,497
PTL 2: Japanese Patent No. 6820907
PTL 3: WO 2020/075293 A

### SUMMARY OF INVENTION

### Technical Problem

The spectral imaging device by the image-splitting method represented by FIG. 9 of PTL 1 has been commercialized and put into practical use. Because lights are spectrally split using one or more dichroic mirrors, light-utilization efficiency and sensitivity are high.

However, it is a problem that the device is large, complicated, and expensive. Depending on the structure of the device, the maximum number of splits and the maximum number of colors are four, and it is difficult to have five or more splits and colors on the device.

The reason for the above will be described below by extending the device in FIG. 9 of PTL 1 to a four-split, four-color imaging device using a combination of three dichroic mirrors as an example.

A first image 18 of a measurement region O of a two-dimensionally distributed sample is a microscopic image and is an image enlarged to a size of an image sensor 36, for example, 10-mm square. In order to perform four-split, four-color imaging, a size of a first aperture may be set to ¼ of the size of the image sensor 36, for example, 5-mm square. A second image formed by a second condensing lens 24 and a second image-formation lens 34 is preferably an equal-magnification image of the first image. That is, four 5-mm-square second images having four types of wavelength components are formed on the image sensor 36 having the size of 10-mm square so as not to overlap each other.

A total of four second images of 5-mm square are arranged, two in a vertical direction (y-axis direction) and two in a depth direction (x-axis direction) in FIG. 9 of PTL 1. Because the second condensing lens 24 is required to efficiently and uniformly collimate the light emission from the region of 5-mm square, a diameter of the collimated light beam needs to be greater than or equal to 10 mm. In addition, in order to split the collimated light beam having the diameter of at least 10 mm into four light beams having a diameter of at least 10 mm so as not to overlap each other, central axes of the split light beams are required to be separated from an optical axis A by at least 5 mm.

Because each dichroic mirror is inclined at 45° with respect to the optical axis A, each size is required to be greater than or equal to 14-mm square. In this case, a space within 15 mm from the optical axis A is substantially filled with any of the four light beams. Furthermore, as illustrated in FIG. 9 of PTL 1, each of the split light beams is incident on the second image-formation lens 34 from a position greater than or equal to 10 mm away from the optical axis A while being angled with respect to the optical axis A. Thus, the four second images formed at different positions on the image sensor 36 by the second image-formation lens 34 do not overlap each other.

With the above conditions as a starting point, it is assumed that at least one dichroic mirror is added to perform five-split, five-color imaging. In order to split a collimated light beam having a diameter greater than or equal to 10 mm into five light beams having a diameter greater than or equal to 10 mm so as not to overlap each other, the central axis of any one of the split light beams is required to be at least 20 mm away from the optical axis A.

In this case, the angle at which the light beam is incident on the second image-formation lens 34 is significantly larger than that in the case of the four-split, four-color imaging. Therefore, a portion of the second image of the light beam may not be captured in an image sensor 36, and the rest of the second image may be captured in the image sensor 36 but highly distorted, that is, the image quality is degraded. The same applies to imaging with more than five splits, more than five colors.

PTL 2 provides the multicolor-detection device in which a plurality of samples, i.e., the light-emitting-point array is the measurement target instead of spectral imaging of the measurement region of the two-dimensionally distributed sample. When this multicolor-detection device is used for spectral imaging of measurement regions of the plurality of samples each of which is two-dimensionally distributed, split images of the measurement regions overlap each other on the image sensor, and each split image cannot be independently measured.

The reason for the above will be described with reference to the detailed configuration of the multicolor-detection device illustrated in FIGS. 7 and 15 according to the specification of PTL 2.

Four light-emitting points 1 having a diameter of 0.075 mm are arrayed at an interval of 1 mm. Four condensing lenses 2 having a focal length of 1.5 mm and an effective diameter of 1 mm are arrayed at an interval of 1 mm. A light emitted from each light-emitting point 1 is condensed by each condensing lens 2. Each condensed light beam is transmitted through a long-pass filter 10 having a width of 2.5 mm, a thickness of 1 mm, and a depth of 5 mm, and is split into four by a dichroic-mirror array including dichroic mirrors 17, 18, 19, and 20 having a width of 2.5 mm, a thickness of 1 mm, and a depth of 5 mm.

In FIG. 15 of PTL 2, an array interval of the dichroic mirrors 17, 18, 19, and 20 in a horizontal direction is set to x=2.5 mm. The dichroic mirror 18 is shifted upward (a direction toward the condensing lens 2) by y=0.7 mm relative to the dichroic mirror 17. The dichroic mirror 19 is shifted upward by z=0.3 mm relative to the dichroic mirror 18. The dichroic mirror 20 is shifted upward by z=0.3 mm relative to the dichroic mirror 19. Under these conditions, an aperture width 63 of the dichroic-mirror array is 1.3 mm. The aperture width in a direction perpendicular to the paper surface of FIG. 15 of PTL 2 (the depth direction) is 5 mm that is the same as the depth of each dichroic mirror. Accordingly, the aperture width in the depth direction can be increased by increasing the depth of each dichroic mirror.

As a result, a maximum optical-path length 64 between the condensing lens 2 and an image sensor 30 is 21 mm. Each light-emitting point 1 having the diameter of 0.075 mm forms an image on the image sensor 30 at image magnification of 13 times. Therefore, the diameter of each light-emitting-point image is 0.98 mm. An interval in a light-emitting-point-array direction (the vertical direction in FIG. 7(c) of PTL 2) and an interval in an image-splitting direction (the horizontal direction in FIG. 7(c)) of the total of sixteen light-emitting-point images are 1 mm and 2.5 mm, respectively. Accordingly, the light-emitting-point images can be measured independently without overlapping each other.

However, when the diameter of each light-emitting point 1 increases to 0.085 mm or more, the diameter of each light-emitting-point image increases to 1.1 mm or more, so that the light-emitting-point images overlap each other in the light-emitting-point-array direction. In addition, when the diameter of each light-emitting point 1 increases to 0.2 mm or more, the diameter of each light-emitting-point image increases to 2.6 mm or more, so that the light-emitting-point images also overlap each other in the image-splitting direction. When the light-emitting-point images overlap each other in this manner, the light-emitting-point images cannot be measured independently.

On the other hand, the measurement region of each two-dimensionally distributed sample is larger than the above increased diameter of each light-emitting point 1. Accordingly, when the multicolor-detection device is used for spectral imaging of the measurement regions of the two-dimensionally distributed samples, the split images on the image sensor overlap each other, and they cannot be independently measured.

Subsequently, it is considered that the dichroic-mirror array disclosed in PTL 2 is applied to the spectral imaging device by the image-splitting method of PTL 1. Specifically, in FIG. 9 of PTL 1, a set of the second iris 29 and the second aperture, the dichroic mirror 60, the mirrors 28, and the filters 30 is replaced with a set of the long-pass filter 10 and the dichroic-mirror array including the dichroic mirrors 17, 18, 19, and 20 illustrated in FIG. 15 of PTL 2.

The above components are disposed so that a light beam collimated by the second condensing lens 24 traveling in the right direction (the z-axis positive direction) in FIG. 9 of PTL 1 is first perpendicularly incident on the long-pass filter 10 and then incident on the dichroic mirror 17 at 45°. That is, the long-pass filter 10 and the dichroic mirror 17 are disposed on the optical axis A, and the dichroic mirrors 18, 19, and 20 are disposed in this order below the optical axis A (in the y-axis negative direction).

The light beam transmitted through the long-pass filter 10 is split into four by the dichroic-mirror array. The light beam transmitted through the dichroic mirror 17 travel to the right side on the optical axis A, and the other three light beams travel to the right side along the optical axis A below the optical axis A. Accordingly, the second image-formation lens 34 and the image sensor 36 are disposed such that the centers thereof are aligned with a center of the four-split light beams.

When four-split, four-color imaging of the measurement region of the two-dimensionally distributed sample is performed by the device having the above configuration, the following problems are generated.

A first problem is that, because the light beam collimated by the second condensing lens 24 has the diameter greater than or equal to 10 mm as described above, whereas the aperture width 63 of the dichroic-mirror array is only 1.3 mm as described above, a light-utilization efficiency of the light beam is less than or equal to 13%, and sensitivity of the spectral imaging device is lowered. Here, because the aperture width in the depth direction (the x-axis direction) of FIG. 9 of PTL 1 can be enlarged to 10 mm or more, the light-utilization efficiency is not lowered due to the aperture width in the depth direction.

A second problem is that, because all the four-split-light beams are parallel to the optical axis A, the second images of these light beams are formed at the same position on the image sensor 36 by the second image-formation lens 34. Namely, the four-split second images overlap one another, so that it is difficult to independently measure each split image.

Subsequently, in order to avoid the second problem, it is assumed that the second image-formation lens 34 is excluded and the first image 18 is directly formed at the same magnification on the image sensor 36 by the second condensing lens 24. The four-split second images (i.e., the four-split first images in this case) is 5-mm square as described above. On the other hand, the interval between the four-split second (first) images is the same as the array interval of the four dichroic mirrors, i.e., 2.5 mm. Accordingly, a third problem is that the four-split second (first) images overlap each other and each split image cannot independently be measured.

### Solution to Problem

An example according to the present invention is an optical device in which
a two-dimensionally distributed sample, a single condensing lens, a dichroic-mirror array in which plural dichroic mirrors are arrayed, and an image sensor are lined up in this order along an optical axis of the condensing lens,
a direction in which plural dichroic mirrors are arrayed is perpendicular to the optical axis,
an image of a measurement region of the sample is split into plural images having different wavelength components and measured on the image sensor, and
the dichroic-mirror array is closer to the image sensor than the condensing lens.

An example according to the present invention is an optical device in which
in a right-handed XYZ-orthogonal-coordinate system,
a sample two-dimensionally distributed in parallel with the YZ-plane, a single condensing lens having an optical axis aligned with the X-axis, a dichroic-mirror array in which m dichroic mirrors are arrayed parallel to each other and along the Y-axis with m being an integer greater than or equal to 2, and an image sensor parallel with the YZ-plane are disposed along the X-axis positive direction in the above order,
an image of a measurement region of the sample is split into m images having different wavelength components and measured on the image sensor,
an aperture of the dichroic-mirror array, provided in an iris, is located close to the dichroic-mirror array, on the condensing-lens side of the dichroic-mirror array, and on the X-axis, and
when a distance in the X-axis direction between the condensing lens and the image sensor is h, and a distance in the X-axis direction between the condensing lens and the aperture is x,

$$[ Mathematical formula 1 ]$$

$$0.5 < \frac{x}{h} < 1$$

is satisfied.

### Advantageous Effects of Invention

According to the present invention, spectral imaging by the snapshot method in which an image of a measurement region of a two-dimensionally distributed sample with spectral information of each point of the measurement region is acquired at a time without scanning anything is implemented by a small, simple, and low-cost device as compared with the related art.

The present optical device has high utilization efficiency of lights from the measurement region, so that highly-sensitive spectral imaging can be performed.

Furthermore, the present optical device is capable of spectral imaging with five or more colors, i.e., five or more kinds of wavelength bands.

Accordingly, the present optical device can be applied to spectral imaging performed in various science and technology fields and industrial fields, and contribute to development of these fields.

Objects, configurations, and advantageous effects other than those described above will be clarified by the descriptions of the following embodiments.

### BRIEF DESCRIPTION OF DRAWINGS

FIG. 1 is a schematic diagram of an optical device in which three light-emitting regions are imaged.

FIG. 2 is a schematic diagram of an optical device in which an aperture is disposed at a center of the optical device and three light-emitting regions are imaged.

FIG. 3 is a schematic diagram of an optical device in which an aperture and one dichroic mirror are disposed at a center of the optical device and three light-emitting regions are imaged.

FIG. 4 is a schematic diagram of an optical device in which an aperture and two dichroic mirrors are disposed at a center of the optical device and three light-emitting regions are imaged.

FIG. 5 is a schematic diagram of an optical device in which an aperture and three dichroic mirrors are disposed at a center of the optical device and three light-emitting regions.

FIG. 6 is a schematic diagram of an optical device in which an aperture is disposed in a vicinity of an image sensor and three light-emitting regions are imaged.

FIG. 7 is a schematic diagram of an optical device in which an aperture and one dichroic mirror are disposed in a vicinity of an image sensor and three light-emitting regions are imaged.

FIG. 8 is a schematic diagram of an optical device in which an aperture and two dichroic mirrors are disposed in a vicinity of an image sensor and three light-emitting regions are imaged.

FIG. 9 is a schematic diagram of an optical device in which an aperture and three dichroic mirrors are disposed in a vicinity of an image sensor and three light-emitting regions are imaged.

FIG. 10 illustrates a first notation setting in a schematic diagram of an optical device in which an aperture is disposed and a light-emitting region is imaged.

FIG. 11 is a revised version of FIG. 7 of PTL 2 aligned with the first notation setting.

FIG. 12 illustrates a second notation setting in a schematic diagram of an optical device in which an aperture is disposed and a light-emitting region is imaged.

FIG. 13 is a schematic diagram of a spectral imaging device by a snapshot method configured by combining an epi-fluorescence microscope with laser excitation.

FIG. 14 is a detailed view of the spectral imaging device in FIG. 13.

FIG. 15 is a detailed view of a four-split dichroic-mirror array and its surroundings.

FIG. 16 is a graph illustrating a change in E versus x with y as a parameter.

FIG. 17 is a graph illustrating the change in E versus y with x as a parameter.

FIG. 18 is a schematic diagram of a two-dimensionally distributed sample plane.

FIG. 19 is a schematic diagram of a measurement region 50 on a two-dimensionally distributed sample plane.

FIG. 20 is a schematic diagram illustrating four-split images of the measurement region 50.

FIG. 21 is a schematic diagram illustrating four-color, four-split images of the measurement region 50.

FIG. 22 is a schematic diagram of a measurement region 56 on a two-dimensionally distributed sample plane.

FIG. 23 is a schematic diagram illustrating four-color, four-split images of the measurement region 56.

FIG. 24 is a schematic diagram of a measurement region 56(1) on the two-dimensionally distributed sample plane.

FIG. 25 is a schematic diagram of a measurement region 56(2) on the two-dimensionally distributed sample plane.

FIG. 26 is a schematic diagram of a measurement region 56(3) on the two-dimensionally distributed sample plane.

FIG. 27 is a schematic diagram of a measurement region 56(4) on the two-dimensionally distributed sample plane.

FIG. 28 is a schematic diagram of a measurement region 56(5) on the two-dimensionally distributed sample plane.

FIG. 29 is a schematic diagram illustrating four-split images of the measurement region 56(1).

FIG. 30 is a schematic diagram illustrating four-split images of the measurement region 56(2).

FIG. 31 is a schematic diagram illustrating four-split images of the measurement region 56(3).

FIG. 32 is a schematic diagram illustrating four-split images of the measurement region 56(4).

FIG. 33 is a schematic diagram illustrating four-split images of the measurement region 56(5).

FIG. 34 is a detailed view of a four-split dichroic-mirror array in which optical-path-length-adjustment elements are inserted and its surroundings.

FIG. 35 is a detailed view of a four-split dichroic-mirror array in which optical-path-length-adjustment elements with light-absorbing thin films are inserted and its surroundings.

FIG. 36 is a detailed view of a nine-split dichroic-mirror array and its surroundings.

FIG. 37 is a detailed view of a nine-split dichroic-mirror array in which optical-path-length-adjustment elements with light-absorbing thin films are inserted and its surroundings.

FIG. 38 illustrates the optical-path-length-adjustment elements with the light-absorbing thin films observed from an image sensor side.

FIG. 39 is a schematic diagram of a measurement region 84 on a two-dimensionally distributed sample plane.

FIG. 40 is a schematic diagram illustrating nine-split images of the measurement region 84.

### DESCRIPTION OF EMBODIMENTS

### Overview

In an optical device that images a measurement region of a two-dimensionally distributed sample by forming an image of lights from the measurement region on an image sensor using a single condensing lens, a dichroic-mirror array in which m (m is an integer greater than or equal to 2) dichroic mirrors are arrayed is disposed between the single condensing lens and the image sensor, the lights from the measurement region is split into m lights having different wavelength components, and m images are formed at different positions on the image sensor, thereby performing spectral imaging of the measurement region.

In the optical device, a lens is not disposed between the dichroic-mirror array and the image sensor. The dichroic-mirror array is disposed closer to the image sensor than the single condensing lens. More specifically, an aperture of the dichroic-mirror array is disposed closer to the image sensor than the single condensing lens. The aperture diameter in a direction in which the m dichroic mirrors of the dichroic-mirror array are arrayed is smaller than the effective diameter of the single condensing lens. The m dichroic mirrors may include a simple mirror having low wavelength dependency. The single condensing lens does not necessarily mean a single lens, but may mean a structure equivalent to the single condensing lens (for example, a compound lens or a combined lens obtained by combining plural single lenses).

In the present specification, a right-handed XYZ-orthogonal-coordinate system is defined as follows to further clarify the structure of the optical device. A principal point of the single condensing lens is placed at the origin. The optical axis of the single condensing lens is taken as the X-axis. The positive direction of the X-axis is the direction from the measurement region of the sample toward the single condensing lens and the direction from the single condensing lens toward the image sensor. The Y-axis and the Z-axis are taken as directions perpendicular to the optical axis of the single condensing lens. The direction in which the m dichroic mirrors configuring the dichroic-mirror array are arrayed is taken as the Y-axis. An incident surface of each dichroic mirror is inclined at 45° with respect to both the X-axis and the Y-axis, and is parallel to the Z-axis. A filter of which an incident surface is perpendicular to the X-axis or the Y-axis may be included in the dichroic-mirror array.

The effective diameter of the single condensing lens is defined as D. A distance between the single condensing lens and the image sensor is defined as a sensor distance h. That is, an X-coordinate of the image sensor is h. The aperture is provided at an entrance where a light beam formed by condensing the light from the measurement region by the single condensing lens is incident on the side of the dichroic-mirror array facing the single condensing lens. It is assumed that the dichroic-mirror array and the aperture are close to each other.

“The dichroic-mirror array and the aperture are close to each other” means that, for example, the distance between the dichroic-mirror array and the aperture is sufficiently shorter than the distance between the dichroic-mirror array and the image sensor or the distance between the dichroic-mirror array and the condensing lens, but is not limited thereto.

In general, the “aperture” is a “physical hole” that is provided in an “iris” that blocks a light and allows the light to pass therethrough. In the present specification, a portion that blocks the light is referred to as the “iris”, and a portion that allows the light to pass is referred to as the “aperture”, and both are distinguished. The iris and the aperture are on the same plane perpendicular to the X-axis. The aperture and the first dichroic mirror of the m dichroic mirrors on which the light beam is incident are disposed on the X-axis.

On the other hand, in PTL 2, an “aperture width” of the dichroic-mirror array is defined as follows. The “aperture width” is a maximum width of a parallel light beam that the dichroic-mirror array can split as designed. That is, the “aperture width” is the maximum width of the parallel light beam that is incident on, split by, and emitted from the dichroic-mirror array without any part of it being vignetted internally.

The aperture corresponding to the aperture width will be referred to as a “virtual hole” in comparison with the “physical hole”. The “virtual hole” is disposed at the same position and the same orientation as the “physical hole”. That is, it is assumed that the “virtual hole” and the “physical hole” are perpendicular to the X-axis, are positioned at the entrance where the light beam formed by condensing the light from the measurement region with the single condensing lens is incident on the side of the dichroic-mirror array facing the single condensing lens, and are close to the dichroic-mirror array.

Based on the above, in the present specification, a smaller one of the “physical hole” and the “virtual hole” is referred to as the “aperture”. That is, the smaller one of the size of the “physical hole” and the size of the “virtual hole” is set as the “aperture width”.

Note that, the size and width of the hole are individually defined in the Y-axis direction and the Z-axis direction. That is, the “aperture width” in one direction may be the size of the “physical hole”, and the “aperture width” in the other direction may be the size of the “virtual hole”. Also in the case where the “aperture” is the “virtual hole”, it is assumed that a “virtual iris” exists outside the “virtual hole”, and the light is blocked by the “virtual iris”. Hereinafter, the expressions “physical” and “virtual” are omitted. Taking the above into consideration, the distance between the single condensing lens and the aperture is redefined as the aperture distance x. That is, the X-coordinate of the iris and the aperture is x. The width of the aperture in the Y-axis direction is defined as the aperture width w, and the width of the aperture in the Z-axis direction is defined as the aperture width v.

When defined as described above, the above-described “disposing the dichroic-mirror array closer to the image sensor than the single condensing lens” can be expressed as h/2<x<h. “The aperture diameter in the direction in which the m dichroic mirrors of the dichroic-mirror array are arrayed is smaller than the effective diameter of the single condensing lens” can be expressed as D>w.

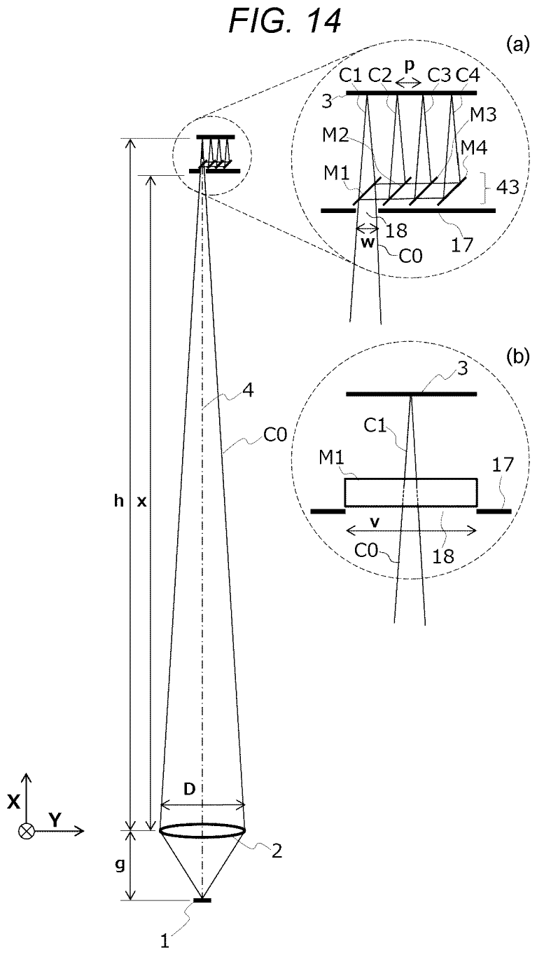

In this specification, the distances h and x strictly mean optical-path lengths. That is, when the light is bent along the way, the optical-path length is a distance along the bending, and the optical-path length changes according to a refractive index of a medium through which the light passes. However, as illustrated in FIG. 14 (described later), in the present specification, since both the bending of the light and the passage of the light through the medium other than air are relatively small proportions, the distances h and x can be approximated by physical distances, namely, the shortest distances not considering the refractive index of the medium along the optical path.

With the configuration of the above optical device (the present optical device), m-split, m-color images of the measurement region can be captured by the image sensor with the images not overlapping each other while decrease in light-utilization efficiency of the light from the measurement region of the two-dimensionally distributed sample is prevented. Thereby, spectral imaging of the measurement region can be performed by the highly sensitive snapshot method.

A light from one point in the vicinity of the optical axis in the measurement region of the two-dimensionally distributed sample is condensed by the condensing lens, made into a light beam with an effective diameter D, then narrowed as approaching the image sensor, and focused at one point on the image sensor. Accordingly, when the dichroic-mirror array is disposed close to the image sensor, the light beam is narrowed at the position of the aperture of the dichroic-mirror array, and the narrowed light beam is located near the center of the aperture, so that most of the light can pass through the aperture.

Similarly, a light from one point away from the optical axis in the measurement region of the two-dimensionally distributed sample is condensed by the condensing lens, made into a light beam with the effective diameter D, then narrowed as approaching the image sensor, and focused at one point on the image sensor. However, because the narrowed light beam is located at a position away from the aperture, a ratio at which the light can pass through the aperture decreases with the distance from the optical axis to the one point where the light is emitted. That is, the measurement region of the sample imaged by the image sensor is limited to the vicinity of the optical axis. Accordingly, by making the array interval of the m dichroic mirrors in the Y-axis direction larger than a size of each image of the measurement region, the m-split images of the measurement region can be prevented from overlapping each other. Therefore, each of the m-split images can be simultaneously measured with high sensitivity and independently by the image sensor.

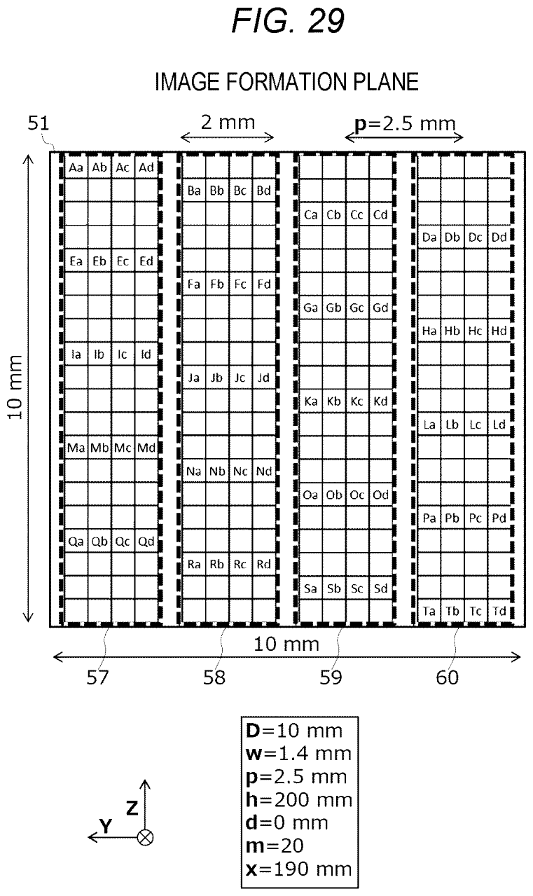

The present optical device is characterized by being small, simple, and low cost as compared with the conventional spectral imaging devices including PTL 1. Furthermore, it is easy to set the number of splits m and the number of colors m for simultaneous imaging to five or more. For example, when the dichroic-mirror array illustrated in FIG. 29 of PTL 3 is used in the present optical device, nine-color detection with m=9 is possible.

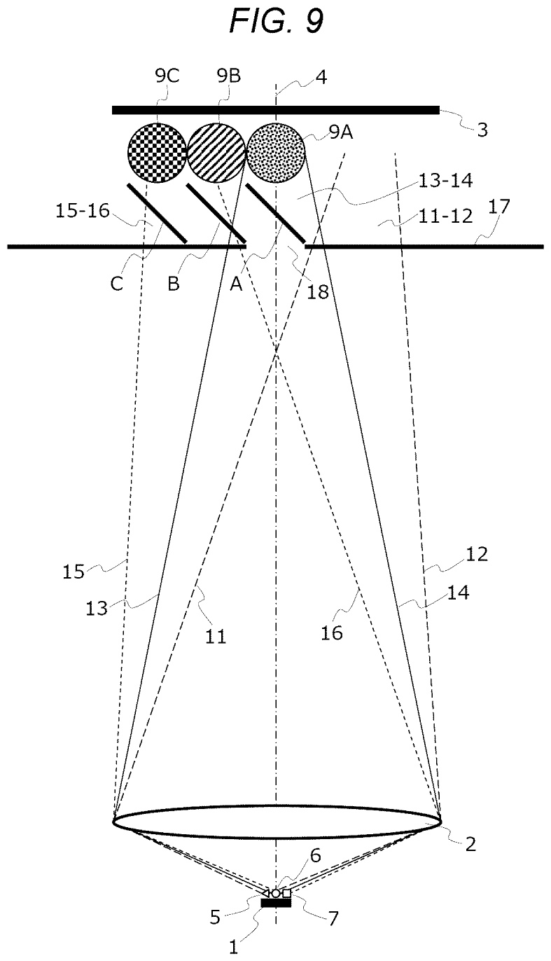

Hereinafter, the configuration of the present optical device is compared with the configuration of the conventional optical device in FIG. 9 of PTL 1.

In the conventional optical device, the first image of the measurement region of the two-dimensionally distributed sample is formed on the first iris by the first condensing lens and the first image-formation lens, and the second image of the first image is formed on the image sensor by the second condensing lens and the second image-formation lens. The plurality of dichroic mirrors is disposed between the second condensing lens and the second image-formation lens.

On the other hand, in the present optical device, the first image of the measurement region of the two-dimensionally distributed sample is formed on the image sensor only by the first condensing lens. The plurality of dichroic mirrors is disposed between the first condensing lens and the image sensor. The position of the image sensor of the present optical device corresponds to the position of the first iris 20 of the conventional optical device. Accordingly, the size of the present optical device can be greatly reduced as compared with the size of the conventional optical device. The size of each dichroic mirror in the present optical device can also be greatly reduced. Furthermore, the number of components in the present optical device can be greatly reduced.

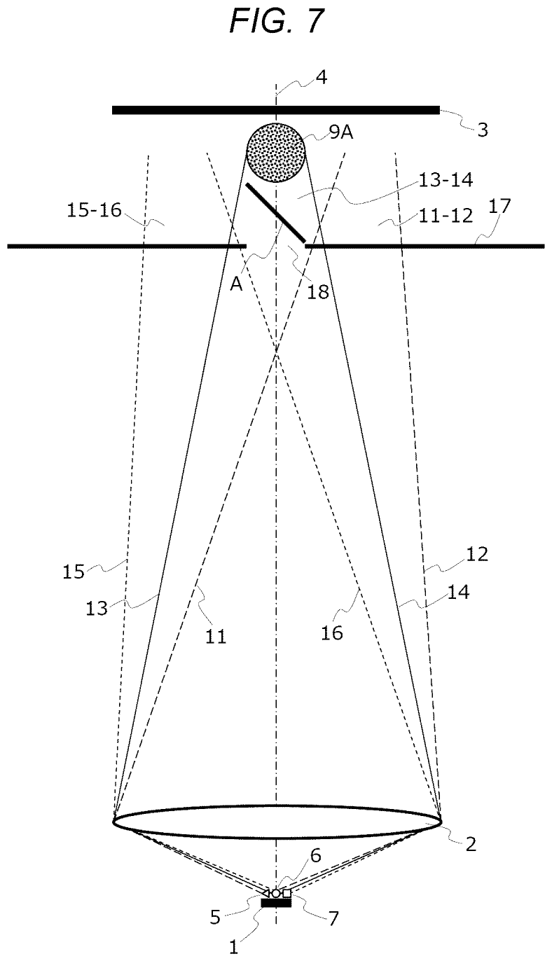

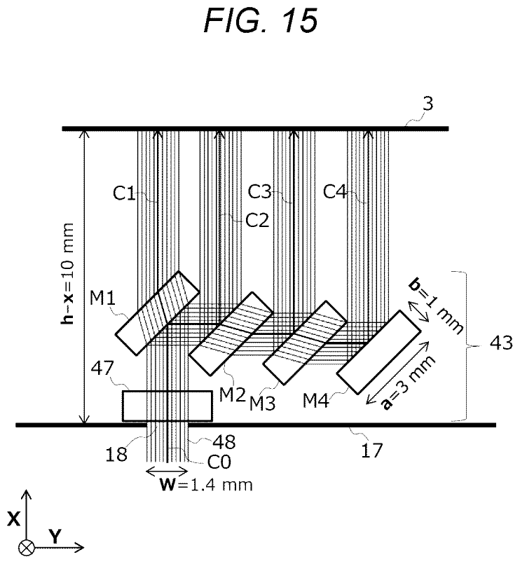

Hereinafter, the configuration of the present optical device is compared with the configurations of the conventional optical devices in FIGS. 7 and 15 of PTL 2.

In the optical device of PTL 2, while the light-emitting-point array is a plurality of samples, images of the lights from the plural light-emitting points are formed on the image sensor by the plural condensing lenses, respectively. The dichroic-mirror array is disposed between the condensing lenses and the image sensor. Note that, in order to shorten the maximum optical-path length and at the same time to reduce the optical device size, the aperture of the dichroic-mirror array is disposed closer to the condensing lenses than the image sensor. In order to improve efficiency of incidence of the light beams condensed by the respective condensing lenses on the dichroic-mirror array, the aperture width in the direction in which the plural dichroic mirrors are arrayed is made equal to or greater than the effective diameter of the respective condensing lenses.

On the other hand, in the present optical device, the image of the measurement region of the two-dimensionally distributed sample is formed on the image sensor by the single condensing lens. The dichroic-mirror array is disposed between the condensing lens and the image sensor. Note that, in order to improve efficiency of incidence of the light beam condensed by the condensing lens on the dichroic-mirror array, the aperture of the dichroic-mirror array is disposed closer to the image sensor than the single condensing lens. In order to prevent the plural split images from overlapping each other on the image sensor, the aperture width in the direction in which the plural dichroic mirrors are arrayed is made smaller than the effective diameter of the single condensing lens. As described above, the present optical device and the conventional optical devices of FIGS. 7 and 15 of PTL 2 have different purposes and basically different configurations.

### [Formulation]

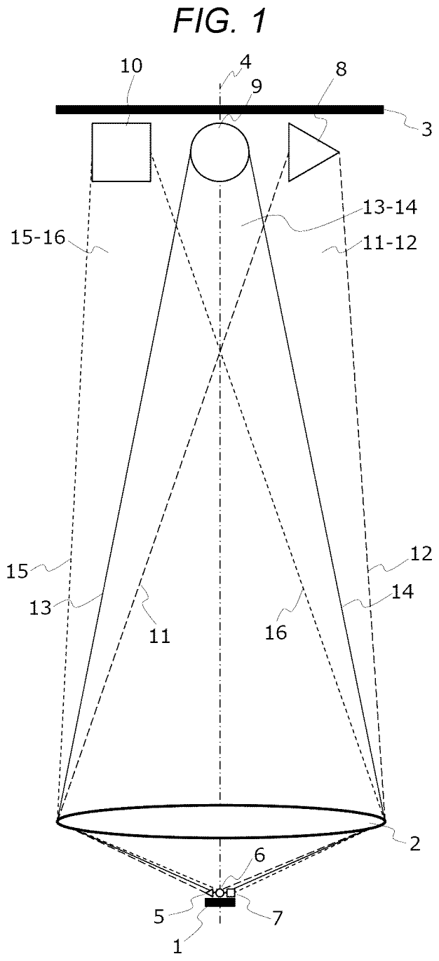

Using the schematic diagrams of FIGS. 1 to 10 and 12, the understanding of the contents described in the above-described [Problems to be Solved by the Invention] and [Overview] is deepened, and an optical device configuration according to an example of the present invention is formulated.

FIG. 1 is a schematic diagram illustrating an optical device that images a measurement region of a two-dimensionally distributed sample. On an optical axis 4 of a condensing lens 2, a center of a measurement region 1 of a two-dimensionally distributed sample and a center of an image sensor 3 are positioned with the condensing lens 2 interposed therebetween.

Three light-emitting regions 5, 6 and 7 exist in the measurement region 1 of the sample, and are denoted by a triangle, a circle, and a square, respectively. The light-emitting region 6 exists on the optical axis 4, and the light-emitting regions 5, 6 and 7 are arranged at equal intervals. The condensing lens 2 condenses lights emitted from the light-emitting regions 5, 6 and 7, respectively, and forms light-emitting-region images 8, 9 and 10 on the image sensor 3, respectively, which are also denoted by a triangle, a circle, and a square, respectively. The light-emitting-region image 9 is on the optical axis 4, and the light-emitting-region images 8, 9 and 10 are arranged at equal intervals. In FIG. 1, a magnification optical system that enlarges the light-emitting-region images is illustrated. Alternatively, an equal magnification optical system or a reduced magnification optical system may be used.

A left-side contour 11 and a right-side contour 12 of a light beam 11-12 that directs a light emitted from the light-emitting region 5 into the light-emitting-region image 8 are indicated by broken lines. A left-side contour 13 and a right-side contour 14 of a light beam 13-14 that directs a light emitted from the light-emitting region 6 into the light-emitting-region image 9 are indicated by solid lines. A left-side contour 15 and a right-side contour 16 of a light beam 15-16 that directs a light emitted from the light-emitting region 7 into the light-emitting-region image 10 are indicated by dotted lines.

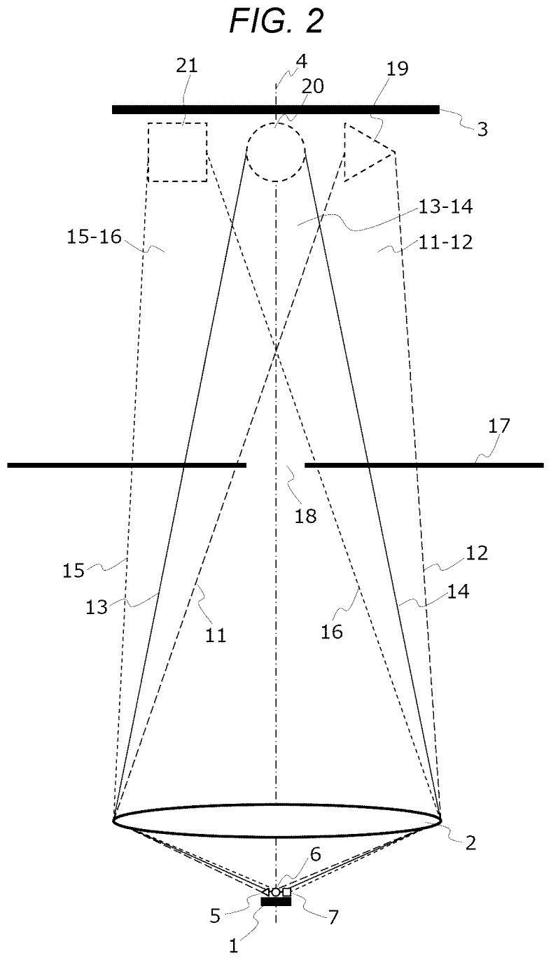

FIG. 2 is a schematic diagram illustrating an optical device in which an iris 17 and an aperture 18 are disposed at the center between the condensing lens 2 and the image sensor 3 in FIG. 1. A plane formed by the iris 17 and the aperture 18 is perpendicular to the optical axis 4, and the center of the aperture 18 is aligned with the optical axis 4. As shown in FIG. 2, parts of the light beams 11-12, 13-14 and 15-16 are blocked by the iris 17, while the rest passes through the aperture 18 to reach the image sensor 3. As a result, the light-emitting-region images 8, 9 and 10 become weak light-emitting-region images 19, 20 and 21, respectively. In order to schematically denote this change, contours of the light-emitting-region images are changed from solid lines to broken lines.

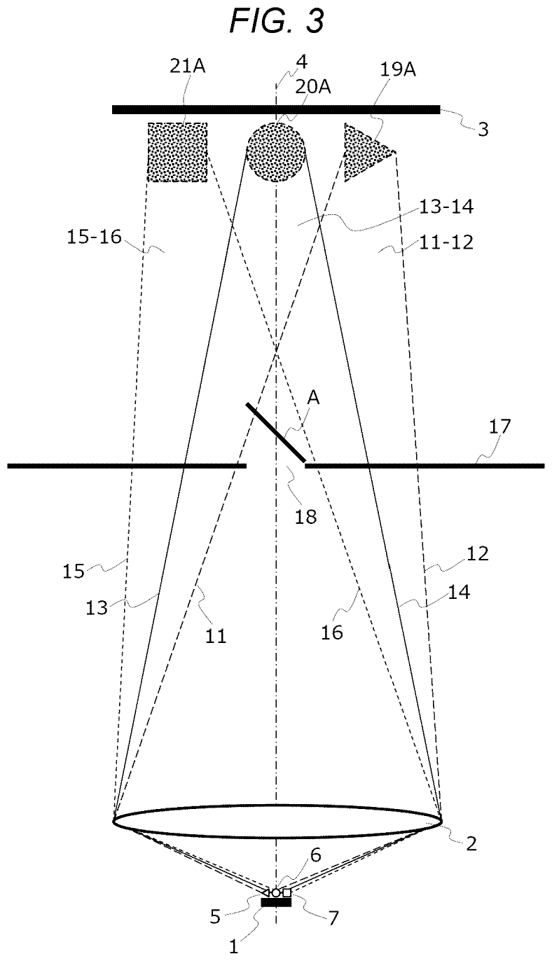

FIG. 3 is a schematic diagram illustrating an optical device in which a dichroic mirror A is disposed directly behind the aperture 18 (on the side of the aperture 18 facing the image sensor 3) in FIG. 2. The incident surface of the dichroic mirror A is inclined at 45° with respect to the optical axis 4, and the center of the dichroic mirror A is aligned with the optical axis 4. The size of the dichroic mirror A is set so that all of the light beams 11-12, 13-14 and 15-16 passed through the aperture 18 is just incident on the dichroic mirror A. As shown in FIG. 3, parts of the light beams 11-12, 13-14 and 15-16 transmitted through the dichroic mirror A reach the image sensor 3, the weak light-emitting-region images 19, 20 and 21 become weak A light-emitting-region images 19A, 20A and 21A having light components in the transmission-wavelength band of the dichroic mirror A. In order to schematically denote this change, a pattern of the light-emitting-region images is changed from white to dots.

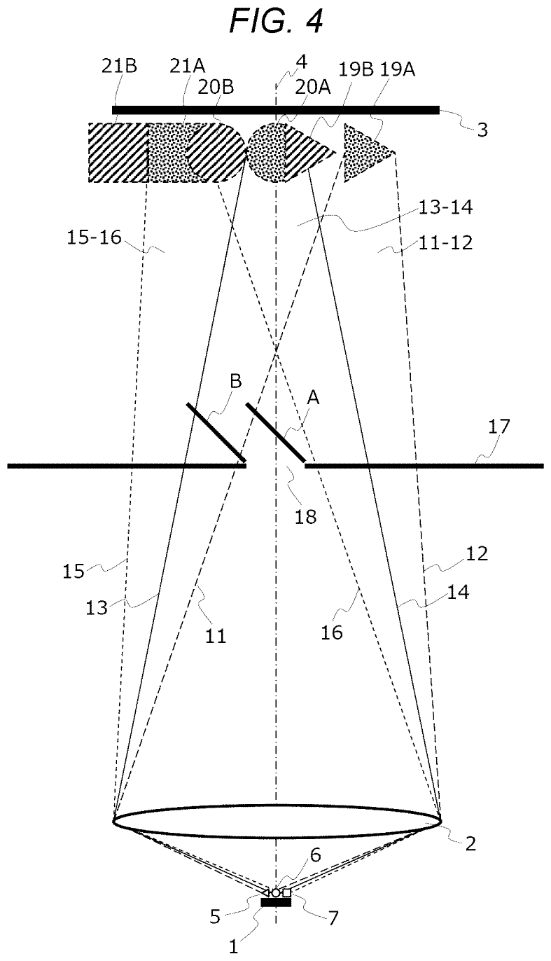

FIG. 4 is a schematic diagram illustrating an optical device in which a dichroic mirror B is disposed to the left of the dichroic mirror A in FIG. 3. The incident surface of the dichroic mirror B is parallel to the incident surface of the dichroic mirror A. The size of the dichroic mirror B is set so that all of the light beams 11-12, 13-14 and 15-16 reflected by the dichroic mirror A is just incident on the dichroic mirror B. As shown in FIG. 4, in addition to the parts of the light beams 11-12, 13-14 and 15-16 transmitted through the dichroic mirror A, parts of the light beams 11-12, 13-14 and 15-16 reflected by the dichroic mirror A and reflected by the dichroic mirror B reach the image sensor 3. Thereby, the weak light-emitting-region images 19, 20 and 21 become two-split images of the weak A light-emitting-region images 19A, 20A and 21A having the light components in the transmission-wavelength band of the dichroic mirror A, and weak B light-emitting-region images 19B, 20B and 21B having light components in a wavelength band obtained by multiplying a reflection-wavelength band of the dichroic mirror A and a reflection-wavelength band of the dichroic mirror B. A pattern of the weak B light-emitting-region images is indicated by hatching.

A wavelength band obtained by “multiplying” two or more wavelength bands means, for example, a wavelength band denoted by a spectrum obtained by integrating two or more spectra denoting the two or more wavelength bands. The same applies hereinafter.

A distance between the two-split images, for example, a distance between the weak A light-emitting-region image 19A and the weak B light-emitting-region image 19B is equal to the distance between the dichroic mirror A and the dichroic mirror B. Because the distance between the two-split images is smaller than the mutual distance between the weak light-emitting-region images 19, 20 and 21, the two-split images are measured while partially overlapping each other. In the present specification, a distance between two images may mean a distance between two points corresponding to each other on the two image.

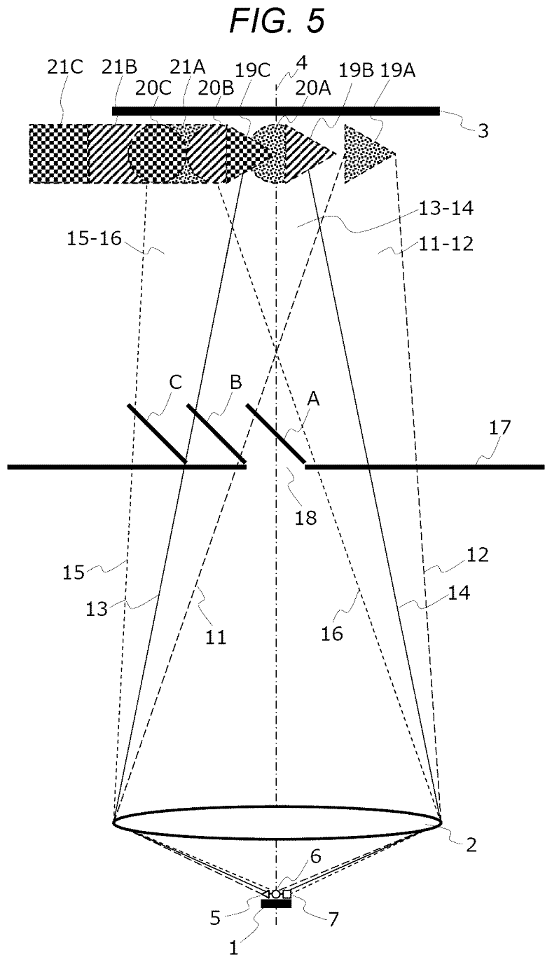

FIG. 5 is a schematic diagram illustrating an optical device in which a dichroic mirror C is disposed to the left of the dichroic mirror B in FIG. 4. The incident surface of the dichroic mirror C is parallel to the incident surfaces of the dichroic mirrors A and B. The size of the dichroic mirror C is set so that all of the light beams 11-12, 13-14 and 15-16 reflected by the dichroic mirror A and transmitted through the dichroic mirror B is just incident on the dichroic mirror C. As shown in FIG. 5, in addition to the parts of the light beams 11-12, 13-14 and 15-16 transmitted through the dichroic mirror A and the parts of the light beams 11-12, 13-14 and 15-16 reflected by the dichroic mirror A and reflected by the dichroic mirror B, parts of the light beams 11-12, 13-14 and 15-16 reflected by the dichroic mirror A, transmitted through the dichroic mirror B, and reflected by the dichroic mirror C reach the image sensor 3. Thereby, the weak light-emitting-region images 19, 20 and 21 become three-split images of the weak A light-emitting-region images 19A, 20A and 21A having the light components in the transmission-wavelength band of the dichroic mirror A, the weak B light-emitting-region images 19B, 20B and 21B having the light components in the wavelength band obtained by multiplying the reflection-wavelength band of the dichroic mirror A and the reflection-wavelength band of the dichroic mirror B, and weak C light-emitting-region images 19C, 20C and 21C having light components in a wavelength band obtained by multiplying the reflection-wavelength band of the dichroic mirror A, a transmission-wavelength band of the dichroic mirror B, and a reflection-wavelength band of the dichroic mirror C. A pattern of the weak C light-emitting-region images is indicated by a check.

A mutual distance between the three-split images, for example, a distance between the weak A light-emitting-region image 19A and the weak B light-emitting-region image 19B or a distance between the weak B light-emitting-region image 19B and the weak C light-emitting-region image 19C is equal to the distance between the dichroic mirror A and the dichroic mirror B or the distance between the dichroic mirror B and the dichroic mirror C. Because the mutual distance between the three-split images is smaller than the mutual distance between the weak light-emitting-region images 19, 20 and 21, the three-split images are measured while partially overlapping each other.

In FIGS. 4 and 5, spectral imaging acquiring split images with plural different wavelength bands, namely, split images with plural different colors is performed, but there are the following two problems. One is that, as is clear from comparison between FIGS. 1 and 2, because only parts of the light beams 11-12, 13-14 and 15-16 condensed by the condensing lens 2 are measured, signal intensity is weak and sensitivity is low. Another reason is that, as is clear from FIGS. 4 and 5, because the split images with plural different colors are measured while overlapping each other, the split images cannot be measured independently. Both problems are fatal in performing spectral imaging.

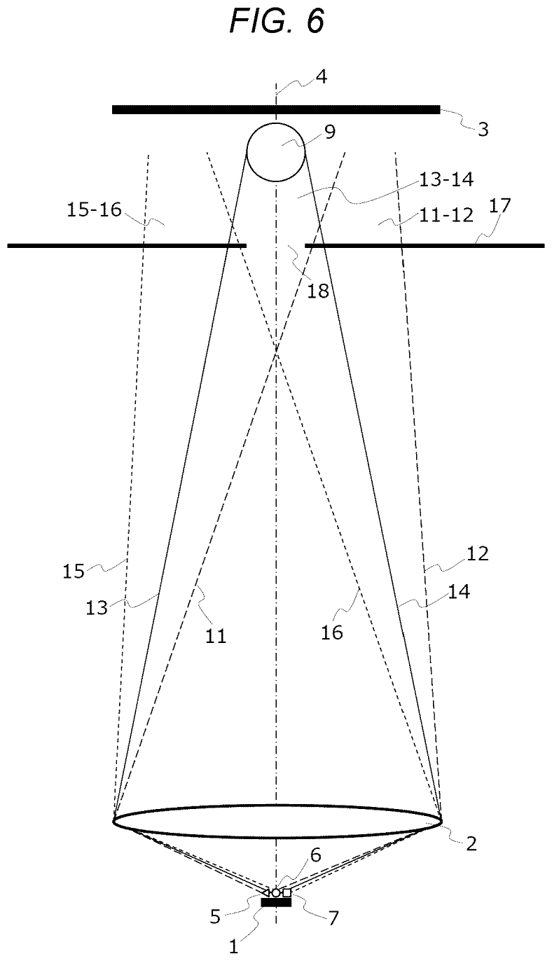

FIG. 6 is a schematic diagram illustrating an optical device in which the iris 17 and the aperture 18 in FIG. 2 are moved in parallel along the optical axis 4 and close to the image sensor 3. That is, the width of the aperture 18 in FIGS. 2 and 6 is the same. As shown in FIG. 6, while most of the light beam 13-14 passes through the aperture 18 to reach the image sensor 3, all of the light beams 11-12 and 15-16 are blocked by the iris 17 and do not reach the image sensor 3. As a result, while the light-emitting-region image 9 is measured in the same manner as in FIG. 1, the light-emitting-region images 8 and 10 are not measured at all.

FIG. 7 is a schematic diagram illustrating an optical device in which the dichroic mirror A is disposed, similarly to FIG. 3, directly behind the aperture 18 (on the side of the aperture 18 facing the image sensor 3) in FIG. 6. As shown in FIG. 7, because a part of the light beam 13-14 transmitted through the dichroic mirror A only reaches the image sensor 3, the light-emitting-region image 9 becomes an A light-emitting-region image 9A having light components in the transmission-wavelength band of the dichroic mirror A.

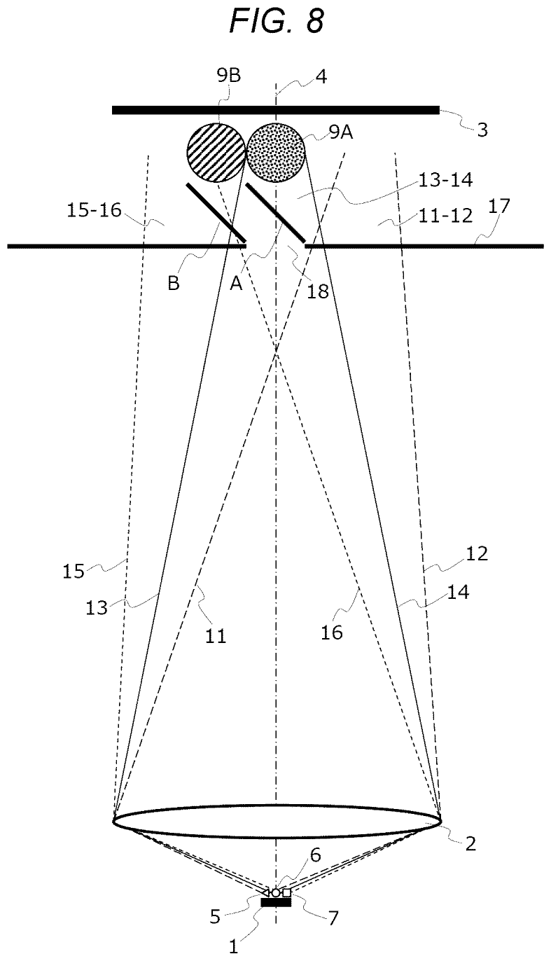

FIG. 8 is a schematic diagram illustrating an optical device in which the dichroic mirror B is disposed, similarly to FIG. 4, to the left of the dichroic mirror A in FIG. 7. In addition to the part of the light beam 13-14 transmitted through the dichroic mirror A, a part of the light beam 13-14 reflected by the dichroic mirror A and reflected by the dichroic mirror B reaches the image sensor 3. Thereby, the light-emitting-region image 9 becomes two-split images of the A light-emitting-region image 9A having the light components in the transmission-wavelength band of the dichroic mirror A and a B light-emitting-region image 9B having light components in the wavelength band obtained by multiplying the reflection-wavelength band of the dichroic mirror A and the reflection-wavelength band of the dichroic mirror B.

A distance between these two-split images is equal to the distance between the dichroic mirror A and the dichroic mirror B. Because the distance between these two-split images is larger than the size of the light-emitting-region image 9, namely, the sizes of the A light-emitting-region image 9A and the B light-emitting-region image 9B, these two-split images are measured without overlapping each other.

FIG. 9 is a schematic diagram illustrating an optical device in which the dichroic mirror C is disposed, similarly to FIG. 5, to the left of the dichroic mirror B in FIG. 8. In addition to the part of the light beam 13-14 transmitted through the dichroic mirror A and the part of the light beam 13-14 reflected by the dichroic mirror A and reflected by the dichroic mirror B, a part of the light beam 13-14 reflected by the dichroic mirror A, transmitted through the dichroic mirror B, and reflected by the dichroic mirror C reaches the image sensor 3. Thereby, the light-emitting-region image 9 becomes three-split images of the A light-emitting-region image 9A having the light components in the transmission-wavelength band of the dichroic mirror A, the B light-emitting-region image 9B having the light components in the wavelength band obtained by multiplying the reflection-wavelength band of the dichroic mirror A and the reflection-wavelength band of the dichroic mirror B, and a C light-emitting-region 9C having light components in the wavelength band obtained by multiplying the reflection-wavelength band of the dichroic mirror A, the transmission-wavelength band of the dichroic mirror B, and the reflection-wavelength band of the dichroic mirror C.

Mutual distances between these three-split images are equal to the distance between the dichroic mirror A and the dichroic mirror B, and the distance between the dichroic mirror B and the dichroic mirror C. Because the mutual distances between these three-split images are larger than the size of the light-emitting-region image 9, namely, the sizes of the A light-emitting-region image 9A, the B light-emitting-region image 9B, and the C light-emitting-region image 9C, these three-split images are measured without overlapping each other.

In FIGS. 8 and 9, spectral imaging is performed to acquire split images with plural different wavelength bands, namely, plural different colors. Unlike in FIGS. 4 and 5, most of the light beam 13-14 condensed by the condensing lens 2 is measured, so that signal intensity is strong and sensitivity is high. Moreover, as is clear from FIGS. 8 and 9, the split images with plural different colors are measured without overlapping each other, so that each split image can be measured independently. Both sensitive and independent measurement of split images is basic performance in spectral imaging. Therefore, it is suitable and advantageous in spectral imaging to have that performance at a high level.

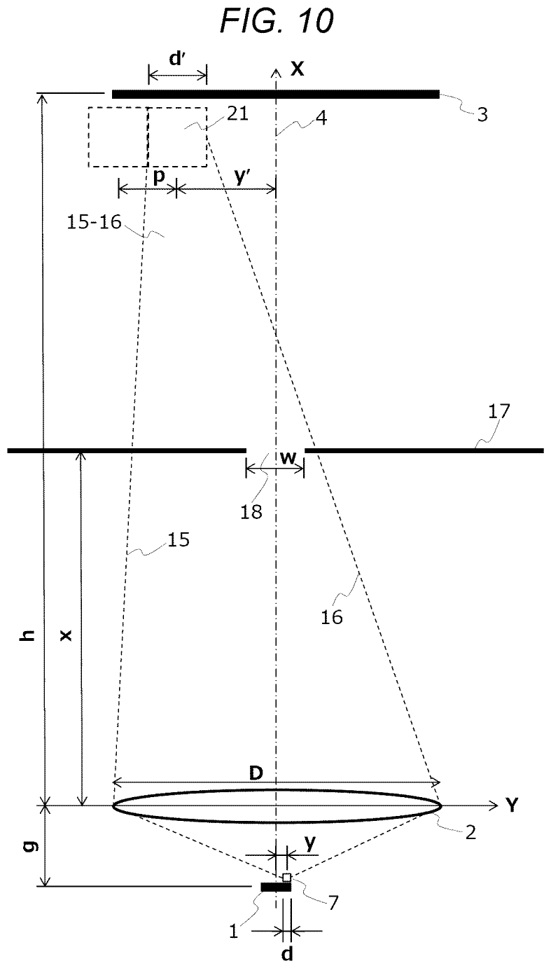

FIG. 10 is a schematic diagram for formulating conditions suitable for spectral imaging. In FIG. 10, a right-handed XYZ-orthogonal-coordinate system is defined. The principal point of the condensing lens is defined as the origin. The optical axis 4 is defined as the X-axis. The direction perpendicular to the optical axis 4 and parallel to the paper surface is defined as the Y-axis. The direction perpendicular to the paper surface is defined as the Z-axis. The X-axis is directed upward in the paper. The Y-axis is directed rightward in the paper. The Z-axis is directed in the depth direction in the paper.

The effective diameter of the condensing lens 2 is denoted by D. The focal length of the condensing lens 2 is denoted by f (not illustrated). A distance between the condensing lens 2 and the measurement region 1 is denoted by g (an absolute value of the X-coordinate of the measurement region 1 is g). The distance between the condensing lens 2 and the image sensor 3 is denoted by h (the X-coordinate of the image sensor 3 is h). The distance between the condensing lens 2 and the iris 17 or the aperture 18 is denoted by x (the X-coordinates of the iris 17 or the aperture 18 is x). The width of the aperture 18 in the Y-axis direction is denoted by w. The width of the aperture 18 in the Z-axis direction is denoted by v (not illustrated in FIG. 10).

In FIG. 10, the light-emitting regions 5 and 6, the light beams from the light-emitting regions 5 and 6, and the light-emitting-region images thereof in FIG. 2 are omitted, and attention is paid to the light-emitting region 7, the light beam 15-16 from the light-emitting region 7, and the weak light-emitting-region image 21. The size of the light-emitting region 7 in the Y-axis direction is denoted by d. The Y-coordinate of the light-emitting region 7 (the distance between the light-emitting region 7 and the optical axis 4) is denoted by y. The size of the weak light-emitting-region image 21 in the Y-axis direction is denoted by d′. The absolute value of the Y-coordinate of the weak light-emitting-region image 21 is denoted by y′ (the distance between the weak light-emitting-region image 21 and the optical axis 4). The image magnification is denoted by m.

Plural split images can be obtained by disposing plural dichroic mirrors (not illustrated in FIG. 10). The distance between any two adjacent split images, namely, a splitting pitch is denoted by p. Basically, p is regarded as being substantially constant regardless of the split images. When the distance between the two adjacent split images is not constant, an average value or a mode of the distance between the two adjacent split images is set as the splitting pitch p. Alternatively, a minimum value of the distance between the two adjacent split images is set as the splitting pitch p. On the other hand, the distance between the two adjacent split images is often equal to the distance between the two adjacent dichroic mirrors through which the light beams that generate the respective split images finally transmit or reflect, but may not necessarily be equal depending on the structure.

The following expressions are derived from FIG. 10 using geometric optics.

$$[ Mathematical Formula 2 ]$$

$$g = f + \frac{{f}^{2}}{h - f} \qquad ( Expression 1 )$$

$$m = \frac{h - f}{f} \qquad ( Expression 2 )$$

$${d}^{′} = m \cdot d = ( \frac{h - f}{f} ) \cdot d \qquad ( Expression 3 )$$

$${y}^{′} = m \cdot y = ( \frac{h - f}{f} ) \cdot y \qquad ( Expression 4 )$$

As is clear from the comparison between FIGS. 5 and 9, it is advantageous for spectral imaging that the iris 17 and the aperture 18 are positioned closer to the image sensor 3 than the center position between the condensing lens 2 and the image sensor 3. This condition can be expressed by the following expression.

$$[ Mathematical Formula 3 ]$$

$$0.5 < \frac{x}{h} < 1 \qquad ( Expression 5 )$$

As is clear from FIG. 9, it is advantageous for spectral imaging that only the light beam 13-14 passes through the aperture 18 and the light beams 11-12 and 15-16 do not pass through the aperture 18. This condition can be expressed by the following expression.

$$[ Mathematical Formula 4 ]$$

$$D > w \qquad ( Expression 6 )$$

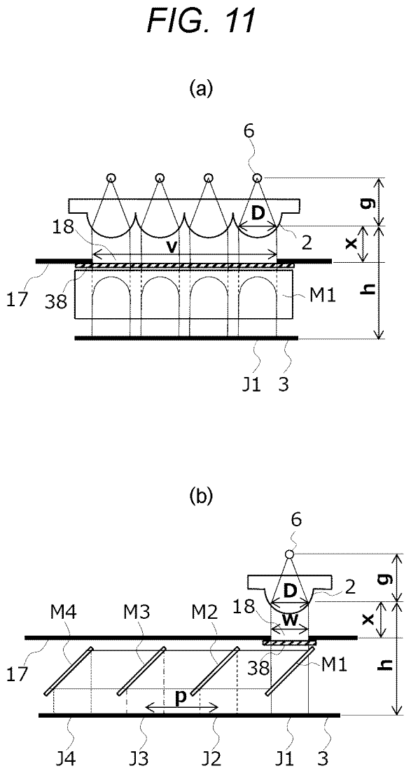

FIGS. 11(a) and 11(b) are obtained by modifying notations in accordance with the present specification in FIGS. 7(a) and 7(b) of PTL 2, respectively. For example, because the four light-emitting points correspond to the four samples, and each light-emitting point corresponds to the light-emitting region 6 in FIG. 9, the light-emitting region 6 is denoted as a light-emitting point. An iris and an aperture omitted in FIG. 7 of PTL 2 are denoted as the iris 17 and the aperture 18.

The lights emitted: from the four light-emitting regions 6 (the light-emitting-point array) are respectively collected by the four condensing lenses 2 (the condensing-lens array) having the effective diameters D, passed through one long-pass filter 38, split into the four lights with four colors by the four types of dichroic mirrors M1, M2, M3 and M4 (the dichroic-mirror array). The four-split lights from each light-emitting regions 6 are projected as four-color, four-split images J1, J2, J3 and J4 to different positions on the image sensor 3.

The focal length of the condensing lens 2 is denoted by f (not illustrated). The distance in the X-axis direction between the condensing lens 2 and the corresponding light-emitting region 6 is denoted by g. The distance in the X-axis direction between the condensing lens 2 and the image sensor 3 is denoted by h. The distance in the X-axis direction between the condensing lens 2 and the iris 17 or the aperture 18 is denoted by x. The width of the aperture 18 in the direction in which the four types of dichroic mirrors M1, M2, M3 and M4 are arranged is denoted by w. The width of the aperture 18 in the direction in which the four condensing lenses 2 are arrayed is denoted by v. The array interval of four-split images corresponding to the array interval of the four dichroic mirrors M1, M2, M3 and M4 is denoted by p.

As described in [Background Art], in PTL 2, in order to perform highly sensitive and independent detection of lights emitted from plural light-emitting points with multiple colors, it is important to make a light-emitting-point array, a condensing lens array, a dichroic-mirror array, and an image sensor close to each other, that is, to reduce a size of a multicolor detection device configured by these, and to secure a large aperture width of the dichroic-mirror array to measure most of the lights condensed by the condensing lenses. Accordingly, as is clear from FIG. 11,

$$[ Mathematical Formula 5 ]$$

$$0 < \frac{x}{h} \leq 0.5 \qquad ( Expression 7 )$$

$$D \leq w \qquad ( Expression 8 )$$

are satisfied. Because (Expression 7) and (Expression 8) are clearly different from (Expression 5) and (Expression 6), it can be seen that the device configuration of the present specification is different from that of PTL 2.

### First Embodiment

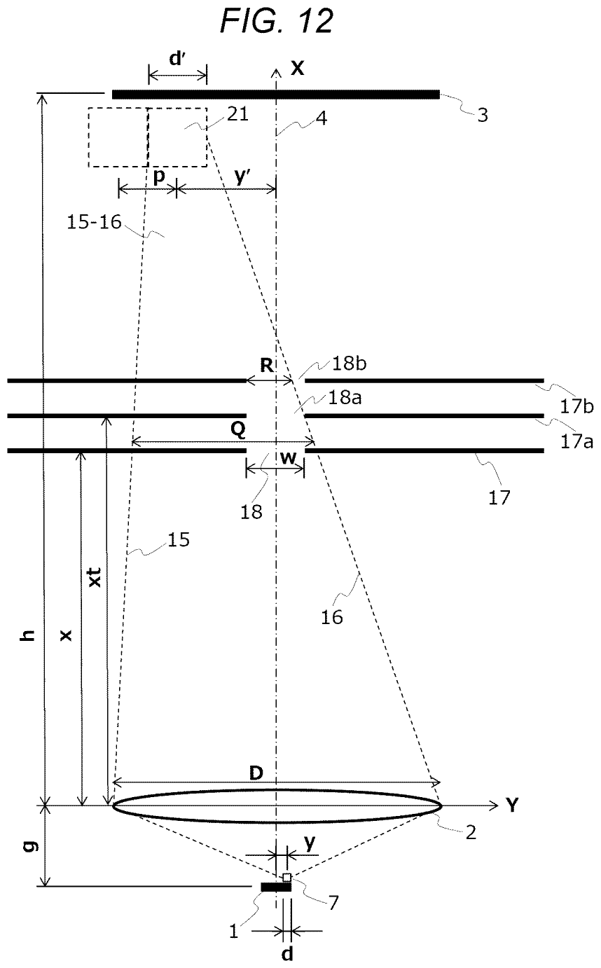

FIG. 12 is a schematic diagram for formulating more suitable conditions for spectral imaging. Three sets of irises and apertures with different X coordinates, i.e., in addition to the iris 17 and the aperture 18 in FIG. 10, an iris 17a and an aperture 18a, and an iris 17b and an aperture 18b, are overlaid.

The iris 17a and the aperture 18a are positioned so that the right-side contour 16 of the light beam 15-16 emitted from the light-emitting region 7 passes through a right end of the aperture 18a. When the X-coordinates of the iris 17a and the aperture 18a are denoted by xt,

$$\begin{matrix}[ Mathematical formula 6 ] & \\ x t = \frac{( D - w ) \cdot h}{m \cdot ( 2 \cdot y - d ) + D} & ( Expression 9 )\end{matrix}$$

is obtained. The iris 17 and the aperture 18 illustrate an example in the case where the X-coordinate x is x<xt. The iris 17b and the aperture 18b illustrate an example in the case where the X-coordinate x is x>xt.

As illustrated in FIG. 12, when a width of the light beam 15-16 in the Y-axis direction is denoted by Q at an arbitrary X-coordinate x of the iris 17 and the aperture 18,

$$\begin{matrix}[ Mathematical formula 7 ] & \\ Q = \frac{1}{h} \cdot ( m \cdot d - D ) \cdot x + D & ( Expression 10 )\end{matrix}$$

is obtained. As illustrated in FIG. 12, when a width of a portion of the light beam 15-16 passing through the aperture 18 in the Y-axis direction is denoted by R at an any X-coordinate x of the iris 17 and the aperture 18 where x≥xt,

$$\begin{matrix}[ Mathematical formula 8 ] & \\ R = \frac{1}{h} \cdot \{ m \cdot ( y - \frac{d}{2} ) + \frac{D}{2} \} \cdot x + \frac{D + w}{2} & ( Expression 11 )\end{matrix}$$

is obtained. A ratio of the light beam 15-16 passing through the aperture 18 is defined as a detection efficiency E. As is clear from FIG. 12, when the X-coordinate x of the iris 17 and the aperture 18 is x<xt,

$$\begin{matrix}[ Mathematical formula 9 ] & \\ E = \frac{w}{Q} & ( Expression 12 )\end{matrix}$$

is obtained. When the X-coordinate x of the iris and the aperture 18 is x≥xt,

$$\begin{matrix}[ Mathematical formula 10 ] & \\ E = \frac{R}{Q} & ( Expression 13 )\end{matrix}$$

is obtained. Note that, if E<0 according to (Expression 12) and (Expression 13), then E=0. Alternatively, if E>1 or Q=0 according to (Expression 12) and (Expression 13), then E=1. The width v of the aperture 18 in the Z-axis direction is sufficiently larger than the width of the light beam. Therefore, it is assumed that there is no decrease in detection efficiency E due to the width v of the aperture 18 in the Z-axis direction.

When the size of the light-emitting region 7 in the Y-axis direction is sufficiently small, for example, when the light-emitting region 7 is the light-emitting point, it can be approximated as d=0. In this case, (Expression 9), (Expression 10), and (Expression 11) are rewritten as follows.

$$\begin{matrix}[ Mathematical formula 11 ] & \\ x {t}_{0} = \frac{( D - w ) \cdot h}{2 \cdot m \cdot y + D} & ( Expression 14 )\end{matrix}$$

$${Q}_{0} = ( 1 - \frac{x}{h} ) \cdot D \qquad ( Expression 15 )$$

$${R}_{0} = ( 1 - \frac{x}{h} ) \cdot \frac{D}{2} + \frac{w}{2} - \frac{m \cdot x \cdot y}{h} \qquad ( Expression 16 )$$

When the X-coordinate x of the iris 17 and the aperture 18 is x<xt₀,

$$\begin{matrix}[ Mathematical Formula 12 ] & \\ E = \frac{w}{{Q}_{0}} & ( Expression 17 )\end{matrix}$$

is obtained. When the X-coordinate x of the iris 17 and the aperture 18 is x≥xt₀,

$$\begin{matrix}[ Mathematical Formula 13 ] & \\ E = \frac{{R}_{0}}{{Q}_{0}} & ( Expression 18 )\end{matrix}$$

is obtained. Note that, if E<0 according to (Expression 17) and (Expression 18), then E=0. Alternatively, if E>1 or Q=0 according to (Expression 17) and (Expression 18), then E=1. The width v of the aperture 18 in the Z-axis direction is sufficiently larger than the width of the light beam. Therefore, it is assumed that there is no decrease in detection efficiency E due to the width v of the aperture 18 in the Z-axis direction. In the case of x≥xt₀, and in the case of d=0 and y=0, namely, when the size of the light-emitting region 7 in the Y-axis direction is sufficiently small and the light-emitting region 7 exists on the optical axis 4, detection efficiency E₀ satisfies the following relationship.

$$\begin{matrix}[ Mathematical Formula 14 ] & \\ {E}_{0} = \frac{( 1 - \frac{x}{h} ) \cdot \frac{D}{2} + \frac{w}{2}}{( 1 - \frac{x}{h} ) \cdot D} & ( Expression 19 )\end{matrix}$$

In the case of d=0, namely, when the size of the light-emitting region 7 in the Y-axis direction is sufficiently small, a Y-coordinate yₘ of the light-emitting region 7 at which detection efficiency E becomes zero (E=0) satisfies the following relationship.

$$\begin{matrix}[ Mathematical Formula 15 ] & \\ {y}_{m} = \frac{1}{m \cdot \frac{x}{h}} \cdot \{ ( 1 — \frac{x}{h} ) \cdot \frac{D}{2} + \frac{w}{2} \} & ( Expression 20 )\end{matrix}$$

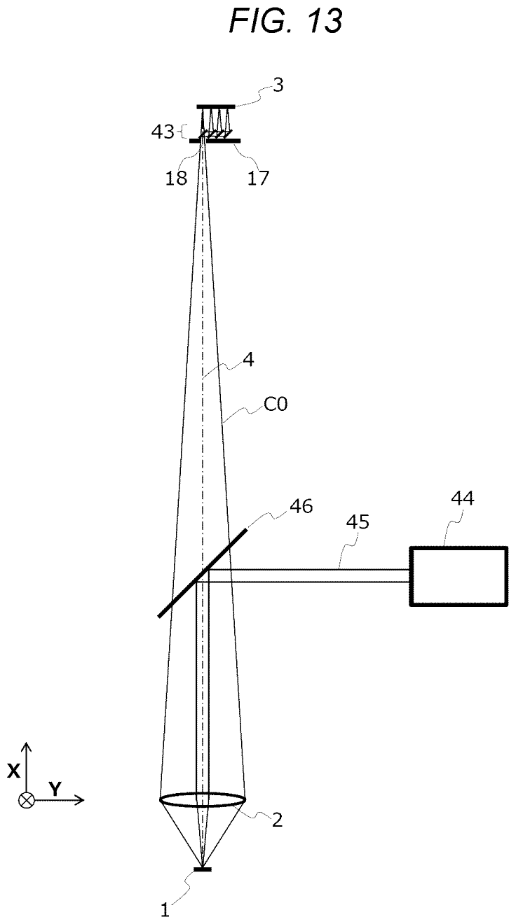

FIG. 13 is a schematic diagram illustrating a spectral imaging device by the snapshot method configured by combining an epi-fluorescence microscope with laser excitation and a dichroic-mirror array. As illustrated in FIG. 13, a right-handed XYZ-orthogonal-coordinate system is defined. Note that the coordinate system-symbol is translated from its exact location in FIG. 13 for easier viewing. Similarly to FIG. 10, the origin is set at a principal point of a condensing lens 2. An optical axis 4 of the condensing lens 2 is defined as the X-axis.

A measurement region 1 of a two-dimensionally distributed sample and an image sensor 3 for imaging the measurement region 1 are disposed perpendicular to the X-axis. The condensing lens 2 is an objective lens for a fluorescence microscope and is actually a combined lens of a plurality of single lenses, but is expressed as a single lens equivalent to the combined lens in the present specification.

A laser beam 45 oscillated from a laser-light source 44 travels in the Y-axis negative direction and is incident on a dichroic mirror 46 inclined by 45° with respect to the X-axis and the Y-axis. A reflected light travels in the X-axis negative direction, is focused by the condensing lens 2, and irradiates the measurement region 1 of the two-dimensionally distributed sample. The dichroic mirror 46 reflects lights having wavelengths equal to or shorter than the wavelength of the laser beam 45, at the incident angle of 45°. The dichroic mirror 46 transmits lights having wavelengths longer than the wavelength of the laser beam 45, at the incident angle of 45°, namely, fluorescences excited by the laser beam 45.

The laser beam 45 is reflected or scattered in the measurement region 1. The reflected or scattered laser lights are condensed by the condensing lens 2, are incident on the dichroic mirror 46 along the X-axis positive direction, and are reflected by the dichroic mirror 46 toward the Y-axis positive direction. Fluorescence emitted from an arbitrary point (a light-emitting point) in the measurement region 1 is condensed by the condensing lens 2 to form a light beam C0. The light beam C0 travels in the X-axis positive direction, passes through the dichroic mirror 46, and forms an image (a fluorescence image) on the image sensor 3. The size of the light-emitting point in the Y-axis direction is set as d=0 mm, and the Y-coordinate of the light-emitting point is denoted by y. In this manner, the fluorescence image of the measurement region 1 is formed on the image sensor 3.

Note that, in FIG. 13, in addition to the above, an iris 17, an aperture 18, and a dichroic-mirror array 43 including four types of dichroic mirrors are disposed in front of the image sensor 3 (on the X-axis negative side of the image sensor 3). That is, the two-dimensionally distributed sample, the single condensing lens 2, the dichroic-mirror array 43 in which the plural dichroic mirrors are arrayed, and the image sensor 3 are lined up in this order along the optical axis 4 of the condensing lens 2. As a result, four-color, four-split fluorescence images of the measurement region 1 are formed on the image sensor 3.

In another expression, in the right-handed XYZ-orthogonal-coordinate system, the two-dimensionally distributed sample in parallel with the YZ-plane, the single condensing lens 2 of which the optical axis 4 is aligned with the X-axis, the dichroic-mirror array 43 in which m dichroic mirrors in parallel with each other are arrayed in the Y-axis direction with m as an integer greater than or equal to 2, and the image sensor 3 parallel with the YZ-plane are disposed in the above-described order along the X-axis positive direction.

In FIG. 14, detailed views around the dichroic-mirror array 43 and the image sensor 3 are added to FIG. 13, and the same notations as in FIG. 10 are added. FIG. 14(a) (upper right) is the detailed view observed from the negative direction of the Z-axis, and FIG. 14(b) (lower right) is the detailed view observed from the negative direction of the Y-axis. In FIG. 14, the laser-light source 44, the laser beam 45, and the dichroic mirror 46 are omitted.

A focal length of the condensing lens 2 is denoted by f (not illustrated). A distance between the condensing lens 2 and the measurement region 1 is denoted by g. A distance between the condensing lens 2 and the image sensor 3 is denoted by h. A distance between the condensing lens 2 and the iris 17 or the aperture 18 is denoted by x. In the first embodiment, the condensing lens 2 having f=9.52 mm and D=10 mm is used, and h=200 mm is set based on the design of the condensing lens 2. In this case, g=1 mm from (Expression 1), and m=20 from (Expression 2).

A size of the image sensor 3 is 10 mm (width in the Y-axis direction)×10 mm (width in the Z-axis direction). A width of the aperture 18 in the Y-axis direction is denoted by w. A width of the aperture 18 in the Z-axis direction is denoted by v. The dichroic-mirror array 43 includes four types of dichroic mirrors M1, M2, M3 and M4.

The light beam C0 passes through the aperture 18, is split into four-split light beams C1, C2, C3 and C4 by the dichroic-mirror array 43, and forms the four-split images on the image sensor 3. An array interval of the four types of dichroic mirrors M1, M2, M3, and M4 in the Y-axis direction is denoted by p. The distance between the four-split images of the four-split light beams C1, C2, C3 and C4 is also p.

From FIG. 14, the present optical device clearly satisfies (Expression 5). That is, the dichroic-mirror array 43 is closer to the image sensor 3 than the condensing lens 2. Furthermore, from FIG. 14, the present optical device clearly satisfies (Expression 6). A direction in which the plural dichroic mirrors M1, M2, M3, and M4 are arrayed is a direction perpendicular to the optical axis 4.

In the example of FIG. 14, there is no lens between the dichroic-mirror array 43 and the image sensor 3. Therefore, the configuration of the optical device is simple.

FIG. 15 illustrates an improved version of the dichroic-mirror array 43 of FIG. 14 in detail. Hereafter, the improved version will also be referred to as the dichroic-mirror array 43. Similarly to FIG. 14, the right-handed XYZ-orthogonal-coordinate system is defined in the drawing. Note that the coordinate system-symbol is translated from its exact location in FIG. 15 for easier viewing, as in FIGS. 13 and 14. A long-pass filter 47 is disposed immediately behind the aperture 18 (on the positive X-axis direction side of the aperture 18). The dichroic mirror M1 is further disposed behind the long-pass filter 47 (on the positive X-axis direction side of the long-pass filter 47). With the dichroic mirror M1 as a starting point, the dichroic mirrors M2, M3, and M4 are arrayed at equal intervals on the right side (the Y-axis positive direction). The incident and emitting surfaces of the dichroic mirrors M1, M2, M3, and M4 are perpendicular to a straight line Y=−X on the XY-plane. In accordance with FIG. 15 of PTL 2, the aperture width is increased by shifting the four dichroic mirrors M1, M2, M3, and M4 in a stepwise manner along the X-axis direction. Therefore, the direction in which the dichroic mirrors M1, M2, M3, and M4 are arrayed is not strictly perpendicular to the optical axis 4 but is substantially perpendicular to the optical axis 4. However, in the present specification, such a direction is also called the perpendicular direction.

In FIG. 14, the contours of the light beam C0 and the split-light beams C1 to C4 are illustrated. In contrast, in FIG. 15, the optical axes and virtual parallel light beams 48 of the light beam C0 and the split-light beams C1 to C4 are illustrated. Each parallel light beam 48 is composed of eleven light-beam elements arrayed in parallel and at equal intervals. The total width of each parallel light beam 48 is aligned with the aperture width w of the dichroic-mirror array 43.

As in FIG. 14, the light beam C0 passes through the aperture 18 along the optical axis 4 and passes through the long-pass filter 47. The reflected light or scattered light of the laser beam 45 is blocked by the dichroic mirror 46 as shown in FIG. 13 (not transmitted through the dichroic mirror 46 but reflected by the dichroic mirror 46), and is further blocked by the long-pass filter 47. The light beam C0 transmitted through the long-pass filter 47 is incident on the dichroic mirror M1 and is split into the reflected light traveling in the Y-axis positive direction and the transmitted light traveling in the X-axis positive direction. The above transmitted light is the split-light beam C1 and is perpendicularly incident and imaged on the image sensor 3.

The light beam reflected by the dichroic mirror M1 is incident on the dichroic mirror M2 and is split into the transmitted light traveling in the Y-axis positive direction and the reflected light traveling in the X-axis positive direction. The above reflected light is the split-light beam C2, and is perpendicularly incident and imaged on the image sensor 3. The light beam transmitted through the dichroic mirror M2 is incident on the dichroic mirror M3 and is split into the transmitted light traveling in the Y-axis positive direction and the reflected light traveling in the X-axis positive direction. The above reflected light is the split-light beam C3 and is perpendicularly incident and imaged on the image sensor 3. The light beam transmitted through the dichroic mirror M3 is incident on the dichroic mirror M4 and forms the reflected light traveling in the X-axis positive direction. The above reflected light is the split-light beam C4 and is perpendicularly incident and imaged on the image sensor 3.

In this manner, the image of the measurement region of the sample is split into plural images (m=4 images with the number of dichroic mirrors being m=4) having different wavelength components. Then, the split images are measured by the image sensor 3.

Base materials of the long-pass filter 47 and the dichroic mirrors M1, M2, M3, and M4 are quartz glass having a refractive index of 1.46. Sizes of the long-pass filter 47 and the dichroic mirrors M1, M2, M3, and M4 are a width of a=3 mm (a dimension in the direction parallel to the XY-plane and parallel to the incident surface of the filter or each dichroic mirror), a thickness of b=1 mm (a dimension in the direction parallel to the XY-plane and perpendicular to the incident surface of the filter or each dichroic mirror), and a depth of c=15 mm (a dimension in the direction parallel to the Z-axis, not illustrated). The array interval of the dichroic mirrors M1, M2, M3, and M4 in the Y-axis direction is 2.5 mm. Note that, as can be seen from detailed analysis of FIG. 15, the distance between the split images of C2 and C3 and the distance between the split images of C3 C4 are 2.5 mm, whereas the distance between the split images of C1 C2 is slightly smaller at 2.1 mm. In the first embodiment, the mode value of 2.5 mm is set as the splitting pitch, p=2.5 mm.

The dichroic-mirror array 43 is arranged in a stepwise manner (stepwise arrangement). That is, the dichroic mirror M2 is shifted relative to the dichroic mirror M1 by 0.7 mm in the X-axis negative direction. The dichroic mirror M3 is shifted relative to the dichroic mirror M2 by 0.3 mm in the X-axis negative direction. The dichroic mirror M4 is shifted relative to the dichroic mirror M3 by 0.3 mm in the X-axis negative direction. These shift amounts are designed based on, for example, (Expression B) or (Expression D) described later such that the dichroic-mirror array 43 functions appropriately.

With the above configuration, as illustrated in FIG. 15, the aperture width w=1.4 mm is obtained. The aperture width in the depth direction is set to v=15 mm. When the total width of the parallel light beam 48 is larger than 1.4 mm, at least a part of the parallel light beam 48 is vignetted inside the dichroic-mirror array 43, and the entire parallel light beam 48 cannot reach the image sensor 3. Incidentally, when the dichroic-mirror array 43 is not arranged in a stepwise manner, namely, when the above shifts are set to 0 mm, the aperture width is greatly reduced to w=0.03 mm.

It is important to secure the large aperture width w in order to increase the amount of light received by the image sensor 3 to improve the measurement sensitivity. On the other hand, the aperture width w=1.4 mm is smaller than the effective diameter D=10 mm of the condensing lens 2, and (Expression 6) is satisfied. Accordingly, the basic performance for spectral imaging can be improved.

As described above, it is preferable that the aperture 18 of the dichroic-mirror array 43 provided in the iris 17 exists close to the dichroic-mirror array 43 on the condensing-lens side of the dichroic-mirror array 43. The width of the aperture 18 in the direction in which the plural dichroic mirrors M1, M2, M3, and M4 are arrayed is preferably smaller than the effective diameter of the condensing lens 2. It is also preferable that the aperture 18 of the dichroic-mirror array 43 provided in the iris 17 exists close to the dichroic-mirror array 43 on the condensing-lens side of the dichroic-mirror array 43 on the X-axis, and (Expression 5) is satisfied when the distance between the condensing lens 2 and the image sensor 3 in the X-axis direction is h and when the distance between the condensing lens 2 and the aperture 18 in the X-axis direction is x.

As described above, it is not preferable that the aperture width is too small or too large, but it is preferable that the aperture width is within an appropriate range.

On the other hand, as illustrated in FIG. 15, the distances (that is, a difference between the distance between the condensing lens 2 and the image sensor 3 and the distance between the condensing lens 2 and the iris 17, or the aperture 18) are set to h−x=10 mm (as in FIG. 15) or h−x=15 mm. In these cases, because of h=200 mm, x=190 mm or 185 mm, that is, x/h=95% or 92.5%, respectively. In both cases, (Expression 5) is satisfied. Accordingly, the basic performance of spectral imaging can be improved.

Hereinafter, a preferred structure of a dichroic-mirror array will be generalized according to PTL 2.

In a right-handed XYZ-orthogonal-coordinate system, in a dichroic-mirror array in which m dichroic mirrors D1 to Dm are arrayed in parallel to each other along the Y-axis positive direction, where m≥2,
(1) incident surfaces of the dichroic mirrors D1 to Dm are perpendicular to the XY-plane,
(2) an inclination of a straight line on the XY-plane obtained by projecting a normal line of each incident surface of the dichroic mirrors D1 to Dm on the XY-plane is negative, and an angle formed by the normal line and the X-axis is denoted by θ₀,
(3) a refractive index of a base material of the dichroic mirrors D1 to Dm is denoted by n₀, an average of widths of the dichroic mirrors D1 to Dm in a direction parallel to the XY-plane and perpendicular to the normal line of each incident surface is denoted by a, and an average of widths of the dichroic mirrors D1 to Dm in a direction parallel to the XY-plane and parallel to the normal line of each incident surface is denoted by b,
(4) when positions of adjacent two dichroic mirrors Dj and D(j+1) (where 1≤j≤(m−1)) on the XY-plane are compared, the dichroic mirror D(j+1) has a larger Y-coordinate and the dichroic mirror Dj has a larger X-coordinate, and
(5) averages of array intervals of adjacent two dichroic mirrors Dj and D(j+1) (where 2≤j≤(m−1)) in the Y-axis direction and the X-axis direction are denoted by Δy and Δx, respectively,
θ₀, n₀, a, b, Δy, and Δx satisfy a predetermined relationship such that an aperture width of the dichroic-mirror array in the Y-axis direction can be enlarged while optical-path lengths of the dichroic-mirror array can be reduced.

The dichroic mirror D1 is on the X-axis, and the m dichroic mirrors D1, D2, . . . , and Dm are lined up in order from the negative direction to the positive direction of the Y-axis.

Specifically,

$$\begin{matrix}[ Mathematical formula 16 ] & \\ a \cdot cos ( {θ}_{0} ) \leq Δ y \leq 2 \cdot a \cdot cos ( {θ}_{0} ) + b \cdot sin ( {θ}_{0} ) & ( Expression A )\end{matrix}$$

is preferably satisfied. Alternatively, when θ₂=sin⁻¹(1/n₀×sin(θ₀)),

$$\begin{matrix}[ Mathematical formula 17 ] & \\ 0 \leq Δ x \leq 2 \cdot b \cdot sin ( {θ}_{0} - {θ}_{2} ) / cos ( {θ}_{2} ) & ( Expression B )\end{matrix}$$

is preferably satisfied. Furthermore, (6) when array intervals of the adjacent two dichroic mirrors D1 and D2 in the Y-axis direction and the X-axis direction are denoted by Δy₀ and Δx₀,

$$\begin{matrix}[ Mathematical formula 18 ] & \\ a \cdot cos ( {θ}_{0} ) \leq Δ {y}_{0} \leq 2 \cdot a \cdot cos ( {θ}_{0} ) + b \cdot sin ( {θ}_{0} ) & ( Expression C )\end{matrix}$$

is preferably satisfied. Alternatively,

$$\begin{matrix}[ Mathematical formula 19 ] & \\ 0 \leq Δ {x}_{0} \leq 2 \cdot b \cdot sin ( {θ}_{0} ) & ( Expression D )\end{matrix}$$

is preferably satisfied.

The four-split dichroic-mirror array illustrated in FIG. 15 naturally satisfies (Expression A) to (Expression D). In the above, θ₀=45° is most effective in many cases from an optical viewpoint. In the case of θ₀≠45°, it may be preferable to incline an image sensor not parallel to the YZ-plane, for example, by θ₀ or θ₀−45°.

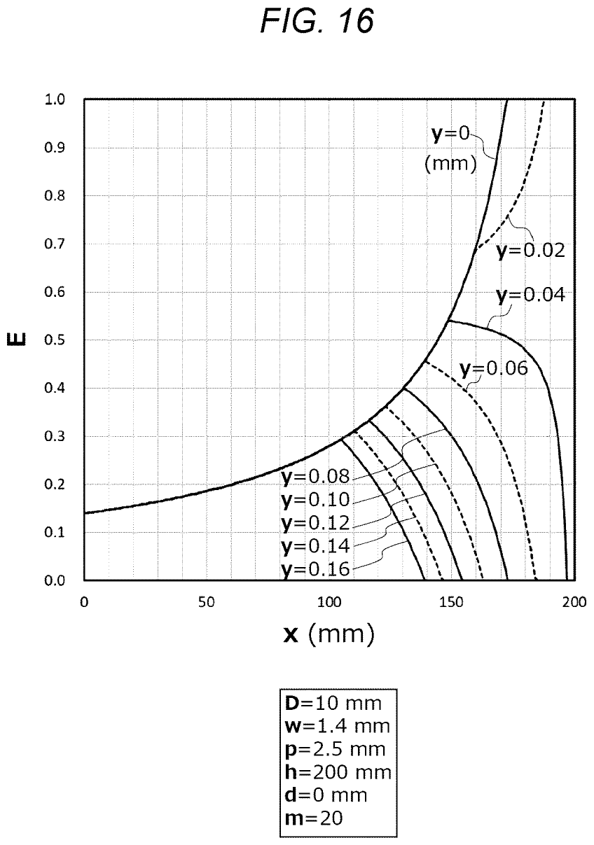

A graph of FIG. 16 illustrates results of calculating change in E when x is changed in a range of 0 to 200 mm using (Expression 17) and (Expression 18) with y as a parameter. The range of E on the graph's vertical axis from 0.0 to 1.0 corresponds to 0% to 100% in the present specification. E=100% is the detection efficiency obtained when there is no loss (blocking) of light by the iris 17 and the aperture 18, E=50% is half the detection efficiency of E=100%, and E=0% means that no light is detected. The conditions other than x are the same as above. That is, D=10 mm, w=1.4 mm, p=2.5 mm, h=200 mm, d=0 mm, and m=20. These conditions are also illustrated below the graph in FIG. 16.

First, at y=0 mm, E increases with x from E=14% at x=0 mm to E=100% at x=xt₀=173 mm, and E=100% is maintained for x>173 mm. Next, at y=0.04 mm, E increases with x from E=14% at x=0 mm similarly to the case of y=0 mm, but E decreases with x from E=54% at x=xt₀=148 mm to E=0% at x=197 mm, and E=0% is maintained for x>197 mm. Generally, as y increases, xt₀ decreases according to (Expression 14), and thus x at which E turns from increasing to decreasing decreases, and the minimum value of x when E=0% also decreases.

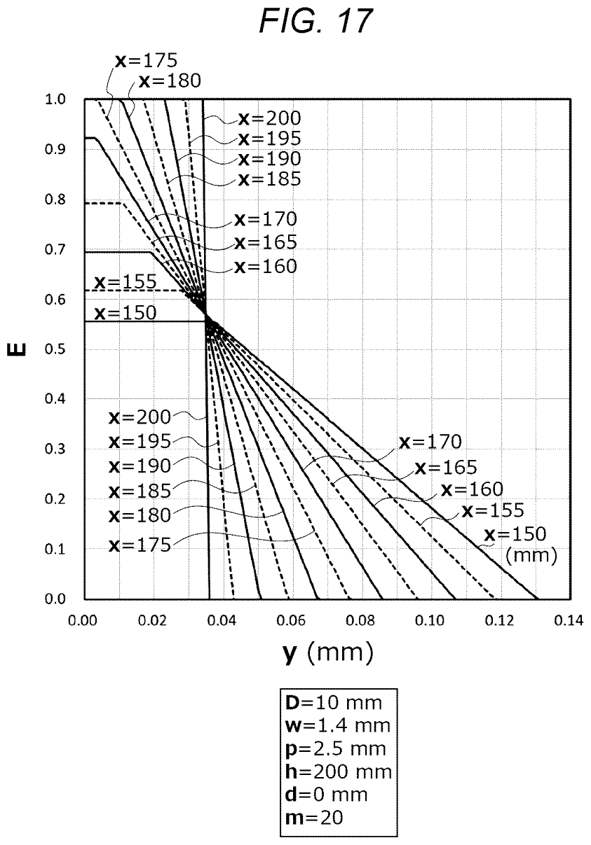

FIG. 17 illustrates a graph in which the horizontal axis and the parameter in FIG. 16 are interchanged, namely, a graph illustrating results of calculating change in E when y is changed in a range of 0 to 0.14 mm with x as the parameter.

As a first example, at x=190 mm (x/h=95%), E=100% at y=0 mm and 0.02 mm, E=38% at y=0.04 mm, and E=0% for y≥0.06 mm. The minimum value of Y-coordinate of the light-emitting point when E=0% is found to be yₘ=0.05 mm using (Expression 20). That is, because the optical system is symmetric with respect to the optical axis 4, light-emitting points where y≤±0.05 mm are measured, but light-emitting points where y>±0.05 mm are not measured. In other words, the region of the sample where y≤±0.05 mm, i.e., the 0.1-mm-width region of the sample in the Y-axis direction is imaged as the measurement region 1, but the region of the sample where y>±0.05 mm is not imaged as the measurement region 1. In general, the width of the measurement region 1 in the Y-axis direction for each split image is 2×yₘ.

In the present specification,-0.05 mm≤y≤0.05 mm is expressed as y≤±0.05 mm, and y<−0.05 mm or y>0.05 mm is expressed as y>±0.05 mm.

As a second example, at x=185 mm (x/h=93%), E=100% at y=0 mm, E=94% at y=0.02 mm, E=45% at y=0.04 mm, and E=0% for y≥0.06 mm. The minimum value of Y-coordinate of the light-emitting point when E=0% is found to be yₘ=0.06 mm using (Expression 20). That is, light-emitting points where y≤±0.06 mm are measured, but light-emitting points where y>±0.06 mm are not measured. In other words, the region of the sample where y≤±0.06 mm, i.e., the 0.12-mm-width region of the sample in the Y-axis direction is imaged as the measurement region 1, but the region of the sample where y>±0.06 mm is not imaged as the measurement region 1.

As a third example, at x=180 mm (x/h=90%), E=100% at y=0 mm, E=84% at y=0.02 mm, E=48% at y=0.04 mm, E=12% at y=0.06 mm, and E=0% for y≥0.08 mm. The minimum value of Y-coordinate of the light-emitting point when E=0% is found to be yₘ=0.07 mm using (Expression 20). That is, light-emitting points where y≤±0.07 mm are measured, but light-emitting points where y>±0.07 mm are not measured. In other words, the region of the sample where y≤±0.07 mm, i.e., the 0.14-mm-width region of the sample in the Y-axis direction is imaged as the measurement region 1, but the region of the sample where y>±0.07 mm is not imaged as the measurement region 1.

As a fourth example, at x=155 mm (x/h=78%), E=62% at y=0 mm and 0.02 mm, E=54% at y=0.04 mm, E=40% at y=0.06 mm, E=26% at y=0.08 mm, E=12% at y=0.1 mm, and E=0% for y≥0.12 mm. The minimum value of Y-coordinate of the light-emitting point when E=0% is found to be yₘ=0.12 mm using (Expression 20). That is, light-emitting points where y≤±0.12 mm are measured, but light-emitting points where y>±0.12 mm are not measured. In other words, the region of the sample where y≤±0.12 mm, i.e., 0.24-mm-width region of the sample in the Y-axis direction is imaged as the measurement region 1, but the region of the sample where y>±0.12 mm is not imaged as the measurement region 1.

As described above, as x/h increases (as x/h approaches 100%), a width of a measurement region 1 to be imaged becomes more limited, while signal intensity and contrast of an image to be measured increase. This is the preferable condition when split images with plural different colors are simultaneously measured. That is, since signal intensity of each light-emitting point is strong, sensitivity is high. Moreover, split images with plural different colors are measured without overlapping each other, so that each split image can be measured independently.

Based on the above study, in order to further improve the basic performance of spectral imaging, more preferable conditions than (Expression 5) will be clarified.

A first condition is that each split image has at least a portion that does not overlap with the other split images. The width of each split image in the Y-axis direction is 2×yₘ×m, whereas the array interval of split images is p. Therefore, the first condition is represented by the following expression with yₘ≤p/m in (Expression 20).

$$\begin{matrix}[ Mathematical formula 20 ] & \\ \frac{D + w}{D + 2 \cdot p} \leq \frac{x}{h} \leq 1 & ( Expression 21 )\end{matrix}$$

A second condition is that detection efficiency at least at the center of each of plural split images is maintained at E=100%. Therefore, the second condition is represented by the following expression with E₀≥1 in (Expression 19).

$$[ Mathematical formula 21 ]$$

$$\frac{D - w}{D} \leq \frac{x}{h} \leq 1 \qquad ( Expression 22 )$$

A third condition is that there is absolutely no overlap between plural split images. Therefore, the third condition is represented by the following expression with yₘ≤p/m/2 in (Expression 20).

$$[ Mathematical formula 22 ]$$

$$\frac{D + w}{D + p} \leq \frac{x}{h} \leq 1 \qquad ( Expression 23 )$$

Under the above conditions, namely, in the case of D=10 mm, w=1.4 mm, p=2.5 mm, and h=200 mm, the first condition is 155 mm≤x≤200 mm, namely, 78%≤x/h≤100%, the second condition is 175 mm≤x≤200 mm, namely, 88%≤x/h≤100%, and the third condition is 185 mm≤x≤200 mm, namely, 93%≤x/h≤100%. Accordingly, the first example and the second example described above satisfy the first to third conditions, the third example satisfies the first and second conditions, and the fourth example satisfies only the first condition.

### Second Embodiment

Under various conditions described in the first embodiment, laser-induced four-color-fluorescence spectral imaging for samples is performed by the configurations of FIGS. 13 to 15.

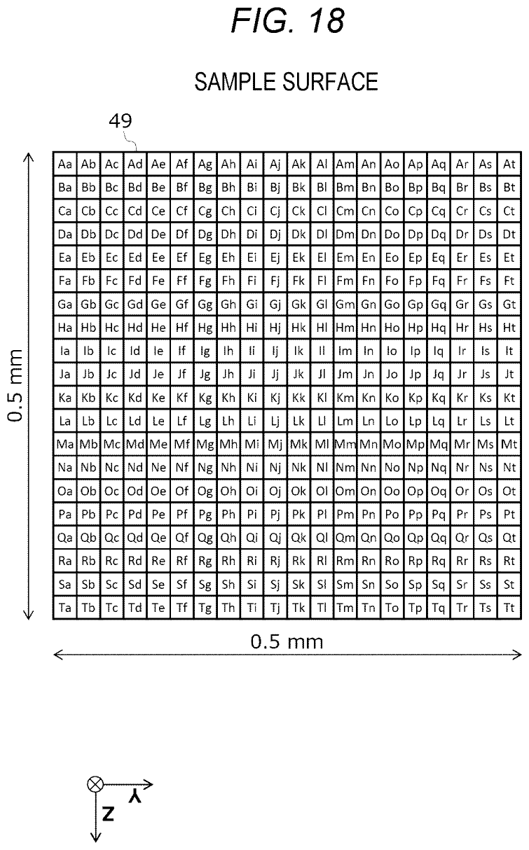

FIG. 18 illustrates a 0.5-mm×0.5-mm region of a sample surface 49 that is two-dimensionally distributed. As illustrated in FIG. 18, the right-handed XYZ-orthogonal-coordinate system common to FIGS. 13 to 15 is defined. Note that the coordinate-system symbol is translated from its exact location in FIG. 18 for easier viewing. A horizontal rightward direction is defined as the Y-axis positive direction. A vertical downward direction is defined as the Z-axis positive direction. A depth direction is defined as the X-axis positive direction. This region is divided into 400 sections of 0.025 mm×0.025 mm arranged in a grid of 20 rows x 20 columns for convenience, but the boundary lines of the sections do not emit light.

Characters described in each section indicate localized distributions of four types of fluorophores, and each character emits fluorescence by laser-beam irradiation. Each character has no meaning, but a section corresponding to an imaged characters can be specified because different characters are described in each section. Each section includes two characters, and a first character is an alphabet of a capital letter and a second character is an alphabet of a small letter. The first character changes as A, B, . . . , and T from a first line to a twentieth line, and the second character changes as a, b, . . . , and t from a first column to a twentieth column.

Each of the characters in the first line (the first character is A), the fifth line (the first character is E), the ninth line (the first character is I), the thirteenth line (the first character is M), and the seventeenth line (the first character is Q) is labeled with a first fluorophore. Fluorescence emitted by the first fluorophore is measured only in the first split image (the image of the split-light beam C1) among the four-split images.

Each of the characters in the second line (the first character is B), the sixth line (the first character is F), the tenth line (the first character is J), the fourteenth line (the first character is N), and the eighteenth line (the first character is R) is labeled with a second fluorophore. Fluorescence emitted by the second fluorophore is measured only in the second split image (the image of the split-light beam C2) among the four-split images.

Each of the characters in the third line (the first character is C), the seventh line (the first character is G), the eleventh line (the first character is K), the fifteenth line (the first character is O), and the nineteenth line (the first character is S) is labeled with a third fluorophore. The Fluorescence emitted by the third fluorophore is measured only in the third split image (the image of the split-light beam C3) among the four-split images.

Each of the characters in the fourth line (the first character is D), the eighth line (the first character is H), the twelfth line (the first character is L), the sixteenth line (the first character is P), and the twentieth line (the first character is T) is labeled with a fourth fluorophore. Fluorescence emitted by the fourth fluorophore is measured only in the fourth split image (the image of the split-light beam C4) among the four-split images.

In reality, because fluorescence spectrum of each fluorophore is broad, fluorescence emitted by each fluorophore is measured in plural split images (with plural different wavelength bands). This is called spectral overlap. A fluorescence-intensity ratio at which fluorescence by each fluorophore is measured in plural split images is obtained in advance. Then, spectral overlaps in measured plural split images of fluorescences from plural fluorophores can be canceled based on the above fluorescence-intensity ratios. This process is called color conversion, deconvolution, unmixing, or the like. In the second embodiment, this process is omitted, and it is assumed that split images with spectral overlap canceled are directly obtained.

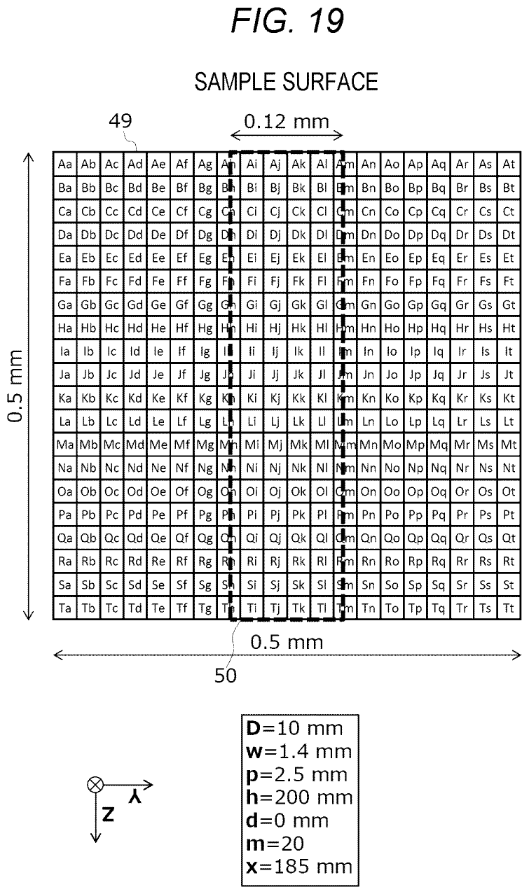

FIG. 19 illustrates a range of a measurement region 50 to be imaged by thick broken lines on the sample surface 49 in FIG. 18 under the conditions of the second example of the first embodiment, namely, in the case of D=10 mm, w=1.4 mm, p=2.5 mm, h=200 mm, d=0 mm, m=20, and x=185 mm. These conditions are also illustrated in the lower part in FIG. 19. The width of the measurement region 50 in the Y-axis direction is 2×yₘ=0.12 mm as described above. The width of the measurement region 50 in the Z-axis direction is 0.5 mm that is the entire width of the sample, because the aperture width is sufficiently large (v=15 mm).

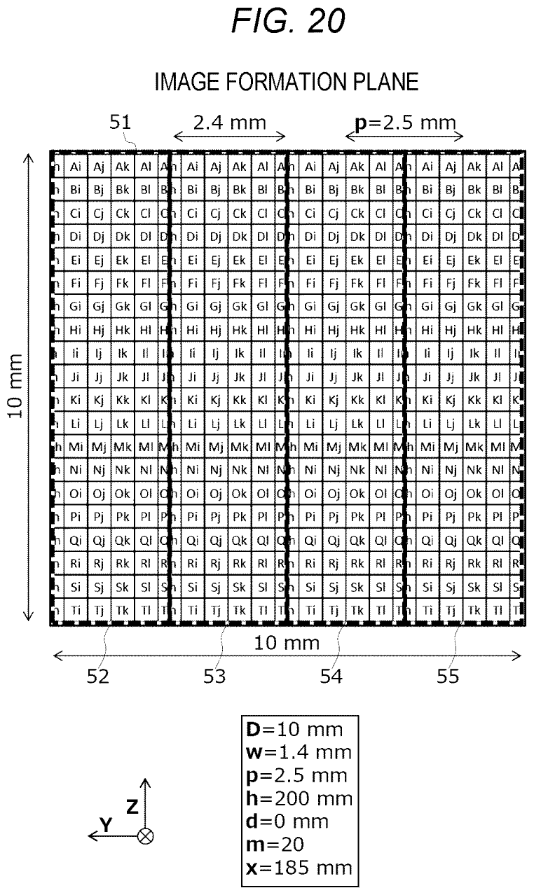

FIG. 20 illustrates a 10-mm×10-mm imaging region 51 of the image sensor 3 by solid lines. Four-split images of the measurement region 50 of a first split image 52, a second split image 53, a third split image 54, and a fourth split image 55, with the image magnification m=20 are indicated by thick broken lines. Note that, in FIG. 20, for easy understanding, it is assumed that lights with all wavelength bands can be equally measured in each split image.

As illustrated in FIG. 20, the right-handed XYZ-orthogonal-coordinate system common to FIG. 19 is defined. Note that the coordinate-system symbol is translated from its exact location in FIG. 20 for easier viewing. A horizontal leftward direction is defined as the Y-axis positive direction. A vertical upward direction is defined as the Z-axis positive direction. A depth direction is defined as the X-axis positive direction. Each of the four-split images 52, 53, 54 and 55 is point-symmetric with respect to the intersection point with the optical axis 4. Therefore, by defining the coordinate system as above, if the image magnification m=1, then the measurement region 50 and each of the four-split images 52, 53, 54 and 55 are apparently the same, and they show the same characters. In the second embodiment, while m=20, FIG. 20 displays FIG. 19 reduced by 1/20. Therefore, the conclusion is that the measurement region 50 in FIG. 19 and the four-split images 52, 53, 54 and 55 in FIG. 20 are the same (the same characters are described in the corresponding sections).

The width of each of the four-split images 52, 53, 54, and 55 in the Y-axis direction is 2×yₘ×m=2.4 mm, and their mutual interval is p=2.5 mm. The width of each split image in the Z-axis direction is 0.5×m=10 mm. In this manner, the four-split images 52, 53, 54, and 55 are simultaneously and independently measured without overlapping each other at all, and it can be confirmed from FIG. 20 that the third condition is satisfied.

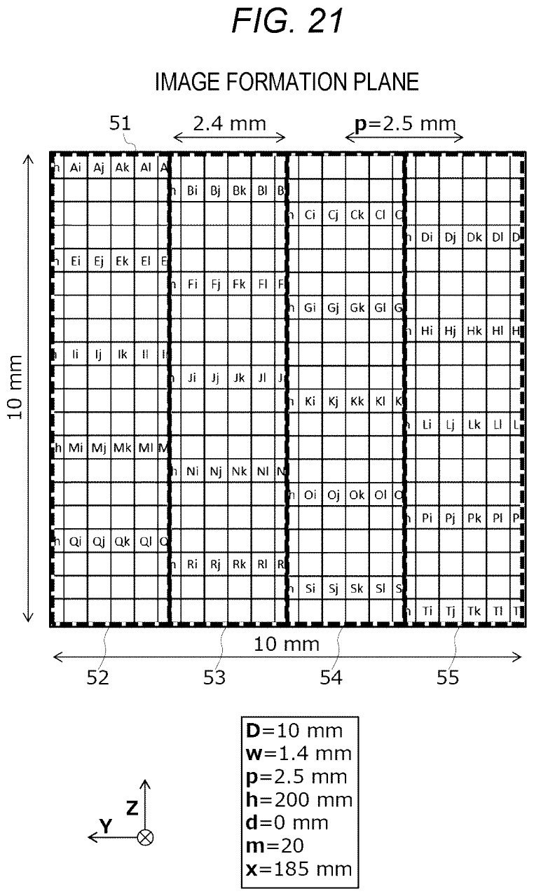

In FIG. 21, the above assumption in FIG. 20 is abandoned. That is, fluorescences emitted by the first fluorophore, the second fluorophore, the third fluorophore, and the fourth fluorophore are selectively measured in the split images 52, 53, 54 and 55, respectively. In other words, fluorescence emitted by the first fluorophore is measured only in the first split image, fluorescence emitted by the second fluorophore is measured only in the second split image, fluorescence emitted by the third fluorophore is measured only in the third split image, and fluorescence emitted by the fourth fluorophore is measured only in the fourth split image.

As described above, the 2.4-mm×10-mm image of the 0.12-mm×0.5-mm measurement region 50 on the sample surface 49 in which the four types of fluorophores are two-dimensionally distributed with 20 times magnification is split into four images with four colors. The split images are simultaneously and independently measured without overlapping each other, and the two-dimensional distribution of each of the four types of fluorophores on the measurement region 50 can be identified.

These split images 52, 53, 54, and 55 may be overlaid into a single image, so that the two-dimensional distribution of the four types of fluorophores on the measurement region 50 can be indicated in the single image.

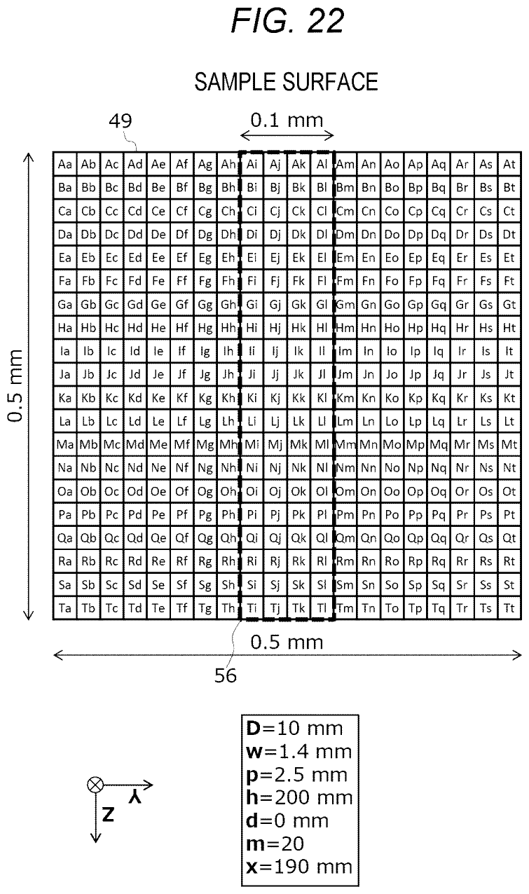

FIG. 22 illustrates a range of a measurement region 56 to be imaged by thick broken lines on the sample surface 49 in FIG. 18 under the conditions of the first example of the first embodiment, namely, in the case of D=10 mm, w=1.4 mm, p=2.5 mm, h=200 mm, d=0 mm, m=20, and x=190 mm. These conditions are also illustrated in the lower part in FIG. 22. The width of the measurement region 56 in the Y-axis direction is 2×yₘ=0.1 mm as described above. The width of the measurement region 56 in the Z-axis direction is 0.5 mm that is the entire width of the sample, because the aperture width is sufficiently large (v=15 mm).

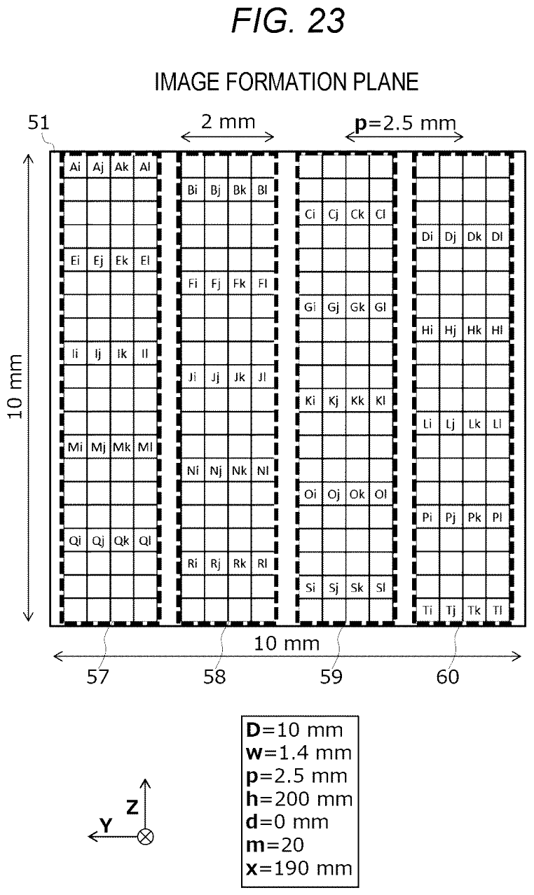

FIG. 23 illustrates the 10-mm×10-mm imaging region 51 of the image sensor 3 by the solid lines. Four-split images of the measurement region 56 of a first split image 57, a second split image 58, a third split image 59, and a fourth split image 60 with the image magnification m=20 are indicated by thick broken lines. Similarly to FIG. 21, four-color lights with different wavelength bands are selectively measured in four-split images, respectively.

As illustrated in FIG. 23, the right-handed XYZ-orthogonal-coordinate system common to FIG. 22 is defined. Similarly to FIG. 21, the horizontal leftward direction is defined as the Y-axis positive direction. The vertical upward direction is defined as the Z-axis positive direction. The depth direction is defined as the X-axis positive direction. The width of each of the four-split images 57, 58, 59, and 60 in the Y-axis direction is 2×yₘ×m=2 mm, and their mutual interval is p=2.5 mm. Therefore, there are generous gaps between the split images as compared with FIG. 21. The width of each split image in the Z-axis direction is 0.5×m=10 mm.

In this manner, the four-split images 57, 58, 59, and 60 are simultaneously and independently measured without overlapping each other at all, and it can be confirmed from FIG. 23 that the third condition is satisfied.

Fluorescences emitted by the first fluorophore, the second fluorophore, the third fluorophore, and the fourth fluorophore are selectively measured in the split images 57, 58, 59, and 60, respectively. That is, fluorescence emitted by the first fluorophore is measured only in the first split image, fluorescence emitted by the second fluorophore is measured only in the second split image, fluorescence emitted by the third fluorophore is measured only in the third split image, and fluorescence emitted by the fourth fluorophore is measured only in the fourth split image.

As described above, the 2-mm×10-mm image of the 0.1-mm×0.5-mm measurement region 56 on the sample surface 49 in which the four types of fluorophores are two-dimensionally distributed with 20 times magnification is split into four images with four colors. The split images are simultaneously and independently measured without overlapping each other, and the two-dimensional distribution of each of the four types of fluorophores on the measurement region 56 can be identified.

These split images 57, 58, 59, and 60 may be overlaid into a single image, so that the two-dimensional distribution of the four types of fluorophores on the measurement region 56 can be indicated as the single image.

In FIGS. 22 and 23, spectral imaging of the 0.1-mm x 0.5-mm measurement region 56 of the two-dimensionally distributed sample surface 49 by the snapshot method is performed. By combining the scanning method with the above snapshot method, spectral imaging of a wider measurement region under the same optical device configuration and under the same conditions becomes possible. For example, in FIGS. 13 and 14, the position of the measurement region 1 to be imaged can be changed on the sample surface 49 by moving the sample including the measurement region 1 in the Y-axis direction. Through the above process, it is possible to perform spectral imaging of a wider measurement region on the sample.

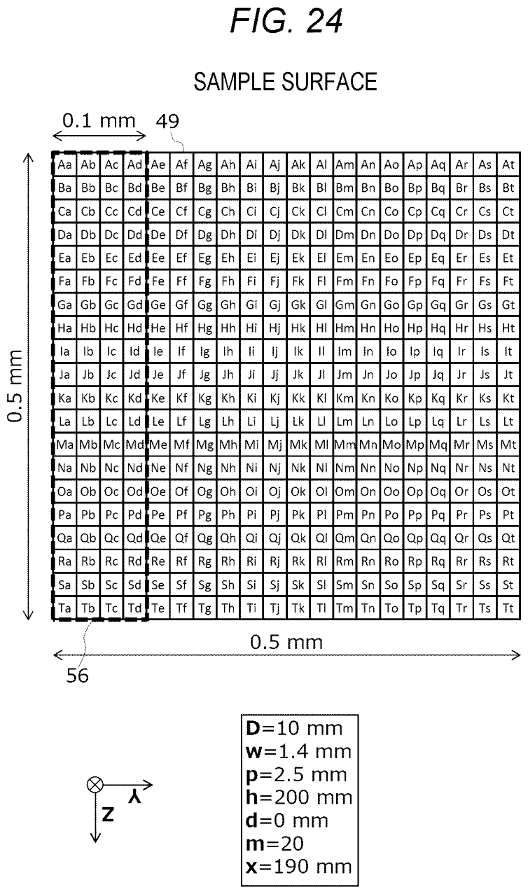

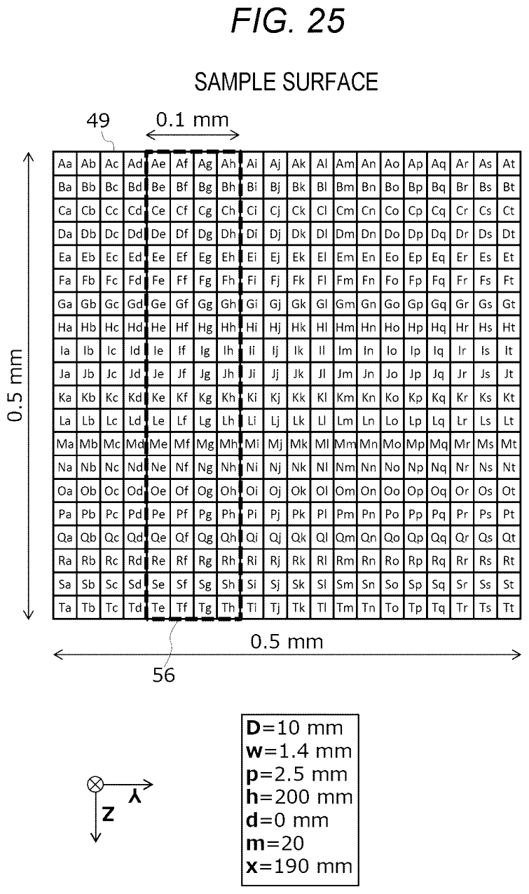

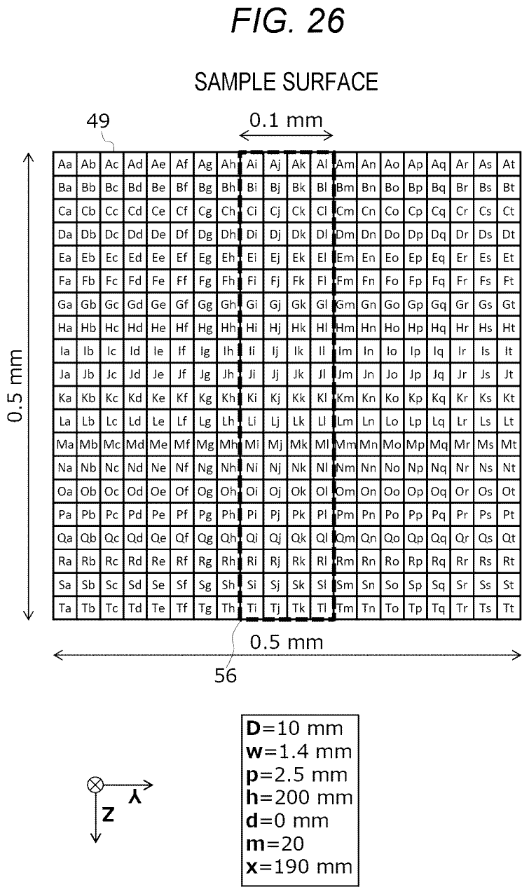

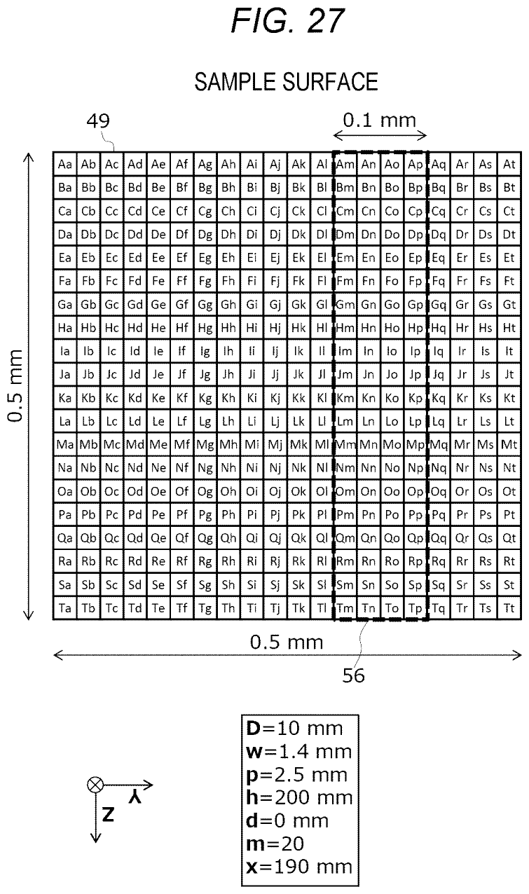

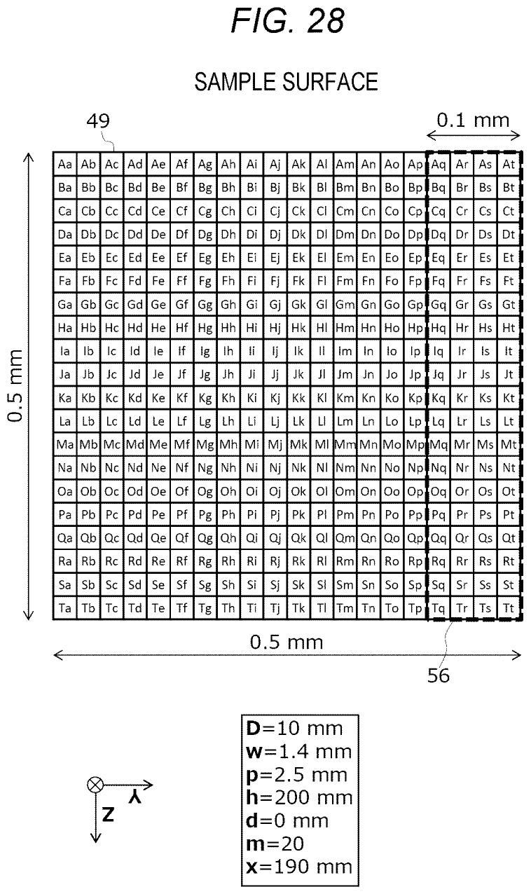

FIGS. 24 to 28 illustrate examples in which the position of the measurement region 56 to be imaged is changed on the sample surface 49. In FIG. 22, the measurement region 56 is fixed in the center on the sample surface 49. On the other hand, in FIGS. 24 to 28, the measurement region 56 moves from the left side (Y-axis negative direction) to the right side (Y-axis positive direction) on the sample surface 49 without overlap and without omission. Note that, the measurement region 56 in FIG. 26 is the same as the measurement region 56 in FIG. 22.

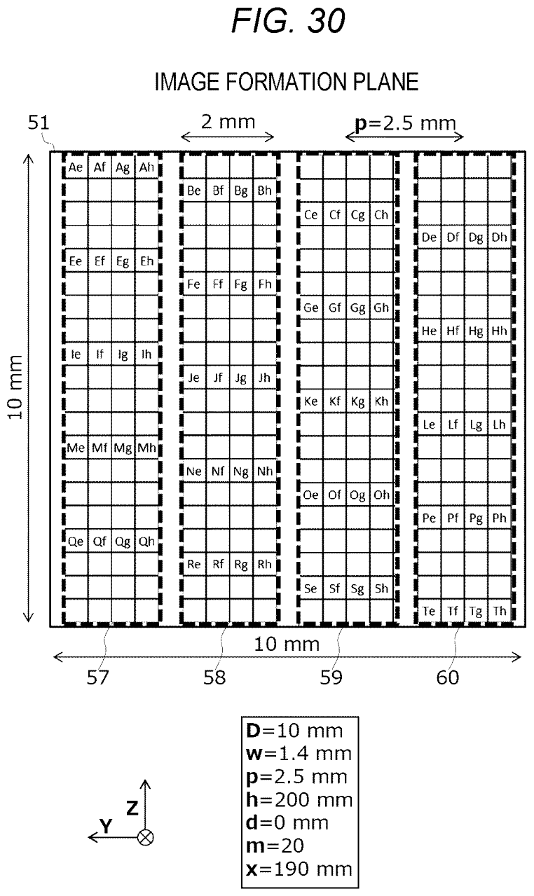

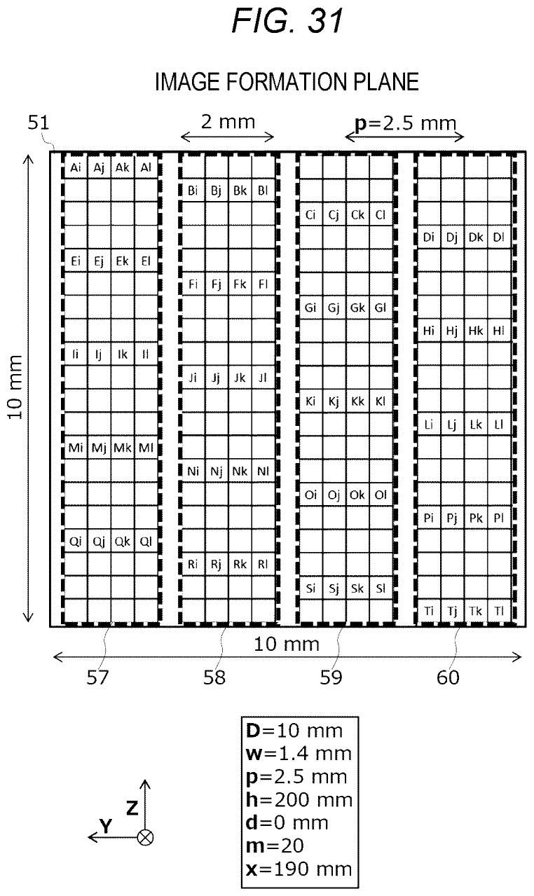

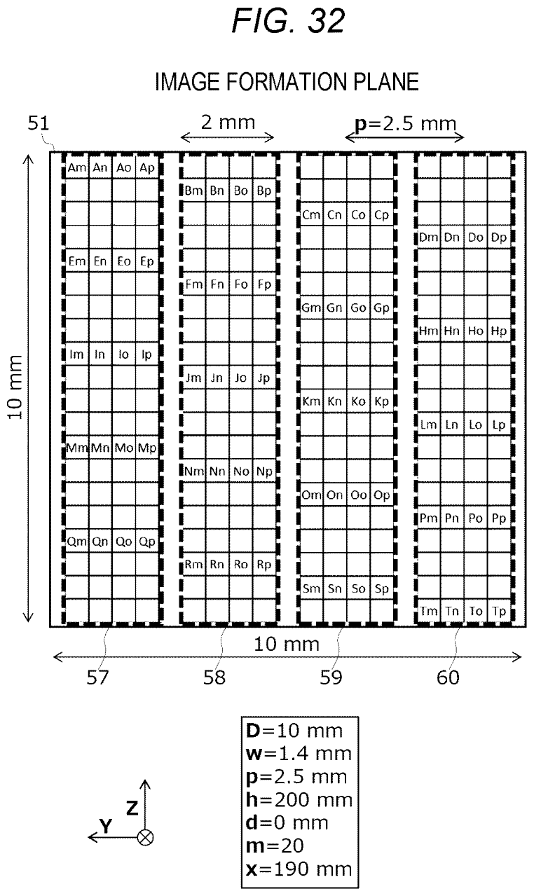

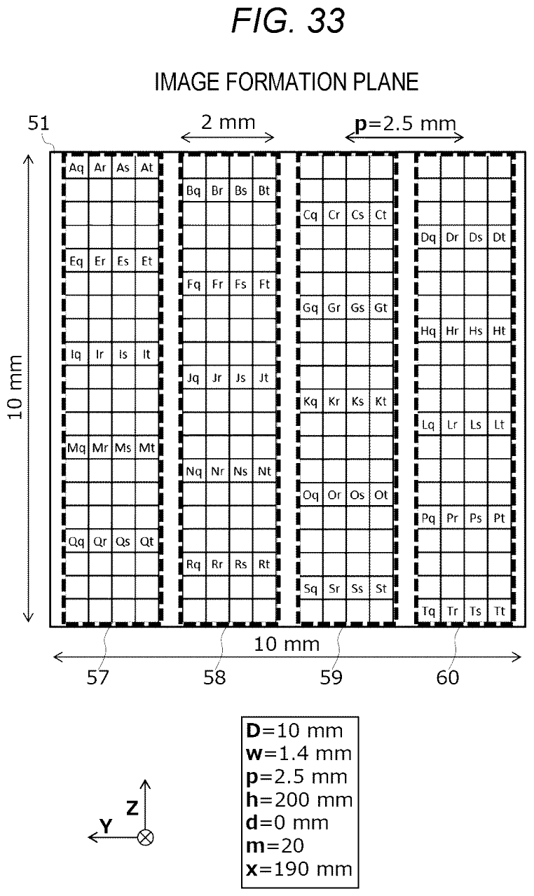

FIGS. 29 to 33 illustrate four-split images of the measurement regions 56 in FIGS. 24 to 28, respectively, for four-color spectral imaging of the sample surface 49. Note that, FIG. 31 is the same as FIG. 23. By combing the results of FIGS. 29 to 33, it is possible to perform four-color spectral imaging of the entire sample surface 49 in a single image.

### Third Embodiment

As described in the first and second embodiments, spectral imaging by the snapshot method in which images of a measurement region of a two-dimensionally distributed sample having spectral information of each point in the measurement region are acquired at once without scanning can be implemented by an optical device configuration as illustrated in FIGS. 13 to 15, which is small, simple, and low cost as compared with conventional optical devices. Moreover, light-utilization efficiency of the optical device is high, so that highly sensitive spectral imaging can be performed.

However, there may be a problem that there are slight differences in focus among plural split images with different wavelength bands (or, different colors). This is based on the fact that optical-path lengths of light beams forming the plural split images are slightly different from each other. For example, referring to FIG. 15, it is clear that “the optical-path length of C1”< “the optical-path length of C2”< “the optical-path length of C3”< “the optical-path length of C4”.

These optical-path-length differences are often negligible because they are smaller than an entire optical-path length from a condensing lens 2 to an image sensor 3 or a distance between the condensing lens 2 and the image sensor 3. However, because all the split images C1 to C4 cannot be strictly focused on the image sensor 3, there may be a problem when split images having higher resolution are required to be simultaneously acquired.

PTL 2 proposes that optical-path-length differences are eliminated by inserting optical-path-length-adjustment elements having different thicknesses into respective split optical paths. However, when actual optical-path-length-adjustment elements of a t transparent material having different thicknesses and a refractive index of 2 are inserted into the respective split optical paths according to FIG. 24(b) of PTL 2, it has been found that, contrary to expectation, differences in focus between the plural split images are rather enlarged. When examined in detail, according to the configuration of FIG. 24(b) of PTL 2, it become clear that the optical-path-length differences between the respective split optical paths are enlarged. In the present specification, a difference in a distance between a position where an image is focused for each optical path and an image sensor is sometimes referred to as an optical-path-length difference.

Therefore, a method for eliminating optical-path-length differences using optical-path-length-adjustment elements is reconsidered from a principled standpoint. In addition, the method that functions as expected is improved by considering how to implement the optical-path-length-adjustment elements simply, highly robustly, and at low cost.

First, FIG. 15 will be examined again in detail. The split image of C1 is adjusted to be in focus on the image sensor 3.

Under this condition, because “optical-path length of C1”< “optical-path length of C2”, the split image of C2 is in focus in front of the image sensor 3 (in the X-axis negative direction from the image sensor 3). Therefore, when a transparent member having a refractive index larger than 1 is inserted only into the optical path of C2, the position (X-coordinate) in the X-axis direction where the split image of C2 is focused approaches the image sensor 3 (the X-coordinate increases). Note that the transparent member is not inserted into the optical path of C1. That is, a transparent member (for example, a transparent solid member) is not inserted into an optical path of a light beam having a shortest optical-path length. In this way, the influence of the transparent member on the optical path can be avoided. By appropriately selecting the refractive index and the thickness of the transparent member, the split image of C2 can be focused onto the image sensor 3.

Similarly, by inserting the transparent members into the optical paths of C3 and C4, respectively, it is also possible to focus the split images of C3 and C4 on the image sensor 3. Note that, the thickness of the transparent member inserted into the optical path of C3 is larger than the thickness of the transparent member inserted into the optical path of C2. In addition, the thickness of the transparent member inserted into the optical path of C4 is larger than the thickness of the transparent member inserted into the optical path of C3.

On the other hand, referring again to FIG. 24(b) of PTL 2, it can be seen that the relationship between the thickness of the transparent member inserted into each optical path and the corresponding optical-path length is opposite to the above. That is, the transparent member is not inserted into the optical path of the light beam 24 (C4) having the longest optical-path length, the thinnest transparent member is inserted into the optical path of the light beam 23 (C3) having the second longest optical-path length, the second thinnest transparent member is inserted into the optical path of the light beam 22 (C2) having the third longest optical-path length, and the thickest transparent member is inserted into the optical path of the light beam 21 (C1) having the shortest optical-path length. For this reason, as described above, when the configuration of FIG. 24(b) of PTL 2 is implemented, the deviation between the focal positions of the plural split images is rather enlarged, that is, an adverse effect is obtained.

Based on the above study, more suitable transparent members, namely, more suitable optical-path-length-adjustment elements are devised.

Let Δh be the optical-path-length difference of an arbitrary split light beam with respect to the optical-path length of the split light having the shortest optical-path length between the condensing lens 2 and the image sensor 3 among the plural split light beams generated by the dichroic-mirror array 43 disposed between the condensing lens 2 and the image sensor 3. As described above, the shortest optical-path length can be approximated by the distance h between the condensing lens 2 and the image sensor 3. Accordingly, the optical-path length of an arbitrary split light beam can also be expressed as h+Δh.

A position (X-coordinate) where a split image of an arbitrary split light beam is focused in the X-axis direction moves forward (X-axis negative direction) by Δh. On the other hand, when a transparent member having a refractive index nₓ and a thickness t is inserted into the optical path of the arbitrary split light beam, the position (X-coordinate) where the split image of the arbitrary split light beam is focused in the X-axis direction moves backward (X-axis positive direction) by (1−1/nₓ)×t. Accordingly, in the case of Δh=(1−1/nₓ)×t, namely, when

$$[ Mathematical formula 23 ]$$

$$t = \frac{Δ h}{1 - \frac{1}{{n}_{x}}} \qquad ( Expression 24 )$$

is satisfied, a position where a split image of an arbitrary split light beam is focused in the X-axis direction can be aligned with the position where the split image of the split light beam having the shortest optical-path length is focused in the X-axis direction serving as the reference (Δh=0).

As can be seen from (Expression 24), it is important to change t according to Δh of the split light beam, more specifically, to increase t in proportion to Δh of the split light beam. That is, when the optical-path-length difference obtained by subtracting the shortest optical-path length from an arbitrary optical-path length among the m optical-path lengths of the m light beams that form the m split images between the condensing lens 2 and the image sensor 3 is Δh, preferably a transparent solid member having the thickness t in the optical axis direction of the light beam having the arbitrary optical-path length is inserted into the optical path of the light beam having the arbitrary optical-path length, and t and Δh have a proportional relationship.

The thickness t of the transparent member can be reduced by using a transparent member having a larger refractive index nₓ, so that the optical-path-length-adjustment elements can easily be mounted.

As will be described later, the use of the optical-path-length-adjustment elements of the thicker transparent members increases the distance h−x between the iris 17 or the aperture 18 and the image sensor 3, namely, decreases x and x/h. This makes it difficult to satisfy the conditions of (Expression 7) and (Expression 21) to (Expression 23) suitable for spectral imaging. Accordingly, it is effective to use a transparent member having a larger refractive index nₓ.

For example, glass or resin is preferably used as a transparent member. Its refractive index is desirably nₓ≥1.60, and more desirably nₓ≥1.80. Furthermore, its refractive index is more desirably set to nₓ≥2.00. Needless to say, it is also important to select a transparent member having a high transmittance of lights at the wavelength to be measured. In recent years, glasses having a high transparency (transmittance) and a refractive index of nₓ≥2.00 has been developed and sold by manufacturers such as AGC Inc., Nippon Electric Glass Co., Ltd., Corning Inc., HOYA Corporation, and Sumida Optical Glass Inc. It is effective to use such glass materials. Needless to say, it is also effective to use high refractive-index resins having high transparency.

The preferable optical-path-length-adjustment elements are applied to the dichroic-mirror array in FIG. 15. Actual calculation results of the optical-path lengths in the case of using the dichroic-mirror array 43 in FIG. 15 are “the optical-path length of C2”−“the optical-path length of C1”=2.1 mm, “the optical-path length of C3”−“the optical-path length of C1”=4.6 mm, and “the optical-path length of C4”−“the optical-path length of C1”=7.1 mm.

In the above calculations, reductions in the optical-path lengths due to each light beam passing through quartz glass having the refractive index of 1.46 that is the base material of each dichroic mirror are taken into consideration. Accordingly, with respect to “the optical-path length of C1” that is the split light beam having the shortest optical-path length, the optical-path-length difference of C1 is Δh=0 mm, the optical-path-length difference of C2 is Δh=2.1 mm, the optical-path-length difference of C3 is Δh=4.6 mm, and the optical-path-length difference of C4 is Δh=7.1 mm.

A high refractive-index glass having a refractive index of nₓ=2.00 is used as a member of each optical-path-length-adjustment element. In this case, according to (Expression 24), all the split images of C1, C2, C3 and C4 can be simultaneously focused onto the image sensor 3 by inserting the high refractive-index glasses having the thicknesses of t=0, 4.2, 9.2, and 14.2 mm into the optical paths of C1, C2, C3, and C4, respectively.

In the above description, the high-refractive-index glass having the thickness of t=0 mm is inserted into the optical path of C1, namely, the optical-path-length-adjustment element is not inserted into the optical path of C1. Alternatively, in the case where the high refractive-index glass having the thickness t=t₀ (≠0) is inserted into the optical path of C1, the same effect as described above can be obtained by inserting the high refractive-index glasses having the thickness t=t₀+4.2, t₀+9.2, and to +14.2 mm into the optical paths of C2, C3, and C4, respectively. However, the above also requires increasing the distance h−x between the iris 17 or the aperture 18 and the image sensor 3 by to, namely, x and x/h is required to decrease accordingly. This makes it difficult to satisfy the conditions of (Expression 7) and (Expression 21) to (Expression 23) suitable for spectral imaging, and thus the above is not necessarily preferable.

In general, it is preferable that an optical-path-length-adjustment element is not inserted into an optical path of a split light beam having a shortest optical-path length, and optical-path-length-adjustment elements are inserted into optical paths of the other split light beams. A thickness of each optical-path-length-adjustment element is preferably increased according to, more specifically, in proportion to an optical-path-length difference of an optical path into which an optical-path-length-adjustment element is inserted with respect to the shortest optical-path length.

(Expression 24) provides a suitable solution of an optical-path-length-adjustment element. It goes without saying that a similar effect can be achieved even under the condition slightly deviated from the suitable solution. Preferably,

$$[ Mathematical formula 24 ]$$

$$t = \frac{Δ h}{1 - \frac{1}{{n}_{x}}} \pm 20 \% \qquad ( Expression 25 )$$

is satisfied. Here, (Expression 25) means Δh/(1−1/nₓ)×80%≤t≤Δh/(1−1/nₓ)×120%. More preferably,

$$[ Mathematical formula 25 ]$$

$$t = \frac{Δ h}{1 - \frac{1}{{n}_{x}}} \pm 10 \% \qquad ( Expression 26 )$$

is satisfied. Here, (Expression 26) means Δh/(1−1/nₓ)×90%≤t≤Δh/(1−1/nₓ)×110%.

Needless to say, a configuration of an optical-path-length-adjustment element described above exhibits a similar effect in the case where the optical-path-length-adjustment element is applied to an arbitrary optical device such as a multicolor-detection device as in PTL 2 or PTL 3, not limited to a spectral imaging device. That is, by an optical device in which an arbitrary dichroic-mirror array and a configuration of an optical-path-length-adjustment element described above are combined, optical-path-length differences inherent in the dichroic-mirror array can be effectively canceled, and better optical performance can be obtained.

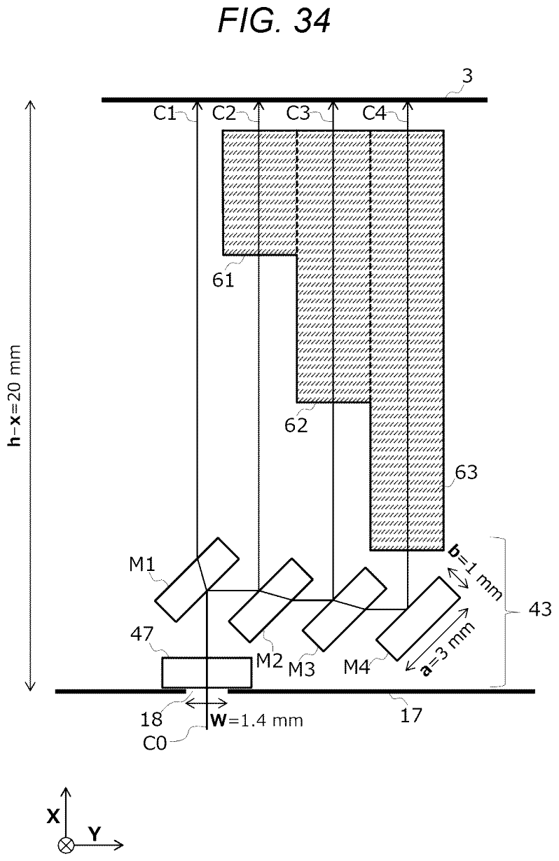

FIG. 34 illustrates a configuration in which the above optical-path-length-adjustment elements are inserted between the dichroic-mirror array 43 and the image sensor 3 in FIG. 15. Note that, the distance h−x between the iris 17 or the aperture 18 and the image sensor 3 is enlarged from 10 mm to 20 mm. That is, because h=200 mm is fixed, x decreases from 190 mm (x/h=95%) to 180 mm (x/h=90%). The virtual parallel light beams 48 in FIG. 15 are not illustrated in FIG. 34.

The member of the optical-path-length-adjustment element is the transparent solid member, i.e., the high refractive-index glass having the refractive index nₓ=2.00. The thickness of the optical-path-length-adjustment element in the X-axis direction is calculated by (Expression 24). The optical-path-length-adjustment element is not inserted into the optical path of C1. The thickness of an optical-path-length-adjustment element 61 inserted into the optical path of C2 in the X-axis direction is t=4.2 mm. The thickness of an optical-path-length-adjustment element 62 inserted into the optical path of C3 in the X-axis direction is t=9.2 mm. The thickness of an optical-path-length-adjustment element 63 inserted into the optical path of C4 in the X-axis direction is t=14.2 mm. Each of the widths and the depth of the optical-path-length-adjustment elements 61, 62, and 63 in the Y-axis direction and the Z-axis direction is 2.5 mm and 15 mm, respectively.

In this manner, a transparent solid member of which thickness changes according to an optical-path-length difference of a split light beam may be inserted into the optical path of the split light beam. The split light beam is one of the m-split light beams that form the m-split images.

The incident surfaces and the emitting surfaces of the optical-path-length-adjustment elements 61, 62, and 63 are perpendicular to the X-axis. More specifically, the incident surface and the emitting surface of each optical-path-length-adjustment element face the X-axis negative direction (the direction toward the dichroic-mirror array 43) and the X-axis positive direction (the direction toward the image sensor 3, respectively.

It is also important to optically polish at least the incident surface and the emitting surface of each optical-path-length-adjustment element to prevent reflection and scattering of lights on the incident surface and the emitting surface. Note that, it is not necessary that the entire incident surface and emitting surface are optically polished. It is preferable that at least the regions through which each split light beam passes on the incident surface and the emitting surface is optically polished.

Side surfaces of the optical-path-length-adjustment elements 61, 62, and 63 perpendicular to the Y-axis between the optical-path-length-adjustment elements 61 and 62 and between the optical-path-length-adjustment elements 62 and 63 are jointed, and then the optical-path-length-adjustment elements 61, 62, and 63 are integrated. In this manner, any two adjacent transparent solid members may be jointed, or plural transparent solid members may be integrated. These jointed surfaces (the surfaces to which the adjacent two transparent solid members are jointed) are transparent, and light beams can be transmitted through the jointed surfaces. The side surfaces perpendicular to the Y-axis other than the above jointed surface, specifically, the Y-axis negative-direction-side surface of the optical-path-length-adjustment element 61, the Y-axis negative-direction-side surface of the optical-path-length-adjustment element 62, and the Y-axis both-direction-side surfaces of the optical-path-length-adjustment element 63 may also be optically polished. As illustrated in FIG. 34, the X-coordinates of the emitting surfaces of the optical-path-length-adjustment elements 61, 62, and 63 are made equal so that the emitting surfaces are aligned on the same plane.

On the other hand, in FIG. 24(b) of PTL 2, the optical-path-length-adjustment elements 77, 78, and 79 are not integrated. Also in this respect, the configurations of FIG. 34 and FIG. 24(b) of PTL 2 are different from each other.

The integration of the optical-path-length-adjustment elements 61, 62, and 63 in this manner brings about the following effects.

First, handling and alignment of the optical-path-length-adjustment elements are facilitated. When the optical-path-length-adjustment elements 61, 62, and 63 are not integrated, the handling and the alignment of each optical-path-length-adjustment element are individually required. However, as described above, because each optical-path-length-adjustment element is fine, it is difficult to individually handle and align each optical-path-length-adjustment element, and mechanisms for implementing the handling and the alignment are likely to become large and expensive.

Next, the widths of the optical-path-length-adjustment elements 61, 62, and 63 in the Y-axis direction can be enlarged to the same extent as the array interval p=2.5 mm of the dichroic mirrors M1, M2, M3, and M4 in the Y-axis direction. Thus, it is possible to avoid effectively reducing the width w of the aperture 18 of the dichroic-mirror array 43 in the Y-axis direction by inserting the optical-path-length-adjustment elements, for example, by optical vignetting by the optical-path-length-adjustment elements. Alternatively, when each position of the split light beams C1 to C4 is displaced in the Y-axis direction or each position of the optical-path-length-adjustment elements is displaced in the Y-axis direction for some reason, it is possible to satisfactorily measure each split image by reducing risks that each split light beam deviates from the corresponding optical-path-length-adjustment element or the amount of light reaching the image sensor 3 decreases.

The alignment of the emitting surfaces of the optical-path-length-adjustment elements 61, 62, and 63 on the same plane brings about the following effects. First, the number of corners of the optical-path-length-adjustment elements is decreased, so that a risk that each split light beam scatters at the angles can be reduced. Next, at least the optical polishing of the emitting surfaces is facilitated. These effects can also be obtained by aligning the incident surfaces of the optical-path-length-adjustment elements 61, 62, and 63 on the same plane instead of the emitting surfaces. A specific effect of aligning the emitting surfaces of the optical-path-length-adjustment elements 61, 62, and 63 on the same plane is that, the stepwise arrangement on the incident surfaces of the optical-path-length-adjustment elements 61, 62, and 63, and the stepwise arrangement of the dichroic mirrors of the dichroic-mirror array 43 can be brought closer together. Specifically, the optical-path-length-adjustment element 63 can be brought close to the dichroic mirror M4. As a result, h−x can be reduced.

Making the jointed surfaces of the optical-path-length-adjustment elements 61, 62, and 63 transparent brings about the following effects. At least a part of a split light beam can transmit a jointed surface to form an image on the image sensor 3, so that the width w of the aperture 18 of the dichroic-mirror array 43 in the Y-axis direction can be avoided from being effectively reduced due to the insertion of the optical-path-length-adjustment elements. Alternatively, when each position of the split light beams C1 to C4 is displaced in the Y-axis direction or each position of the optical-path-length-adjustment elements is displaced in the Y-axis direction for some reason, it is possible to satisfactorily measure each split image by reducing risks that each split light beam deviates from the corresponding optical-path-length-adjustment element or the amount of light reaching the image sensor 3 decreases.

An integrated optical-path-length-adjustment element such as that shown in FIG. 34 can be manufactured by the following three methods.

A first method is an injection molding method. In particular, when a transparent member is resin, the integrated optical-path-length-adjustment element can be mass-produced at low cost by injection molding. As in FIG. 34, even when the transparent member is glass, injection molding can be used in recent years.

A second method is a method for cutting a block of a transparent member. In this method, it is somewhat difficult to optically polish the entire incident surface and emitting surface of the integrated optical-path-length-adjustment element after cutting the block to create the integrated optical-path-length-adjustment element as shown in FIG. 34. Specifically, it is physically difficult to optically polish a region of the incident surface of the optical-path-length-adjustment element 61 in the vicinity of the optical-path-length-adjustment element 62 and a region of the incident surface of the optical-path-length-adjustment element 62 in the vicinity of the optical-path-length-adjustment element 63. Note that, because it is easy to avoid transmission of each split light beam through these regions, these regions may be excluded from the target of the optical polishing.

A third method is a method for bonding the surfaces of the separately-produced optical-path-length-adjustment elements 61, 62, and 63 with an adhesive or the like. In this method, it is easy to optically polish the incident surfaces and the emitting surfaces or the entire side surfaces of the optical-path-length-adjustment elements 61, 62, and 63 before the bonding. The bonding surfaces can be made transparent by sufficiently thinning the adhesive layer using a transparent adhesive. It is preferable that the refractive index of the adhesive is higher, and the refractive index of the adhesive is closer to the refractive index of the optical-path-length-adjustment elements. In the third method, the separately-produced optical-path-length-adjustment elements 61, 62, and 63 may be jointed by compressing them while they are in contact using a dedicated device without using the adhesive. The integrated optical-path-length-adjustment element in FIG. 34 is manufactured by the third method.

In the above description, the transparent members having the same refractive index nₓ and the different thicknesses t are respectively inserted into the different split optical paths, but this is not always necessary. That is, transparent members having different refractive indexes nₓ may be inserted into different split optical paths. Note that, also in this case, (Expression 24) to (Expression 26) are preferably satisfied. For example, refractive indexes nₓ of transparent members inserted into optical paths of light beams except for a light beam having a shortest optical-path length can be changed in accordance with (Expression 24) to (Expression 26) such that thicknesses t of these transparent members are the same. In this way, unlike the stepwise-shaped optical-path-length-adjustment elements 61, 62, and 63 in FIG. 34, the optical-path-length-adjustment elements 61, 62, and 63 become a rectangular parallelepiped, so that handling and alignment of the optical-path-length-adjustment elements 61, 62, and 63 are further facilitated.

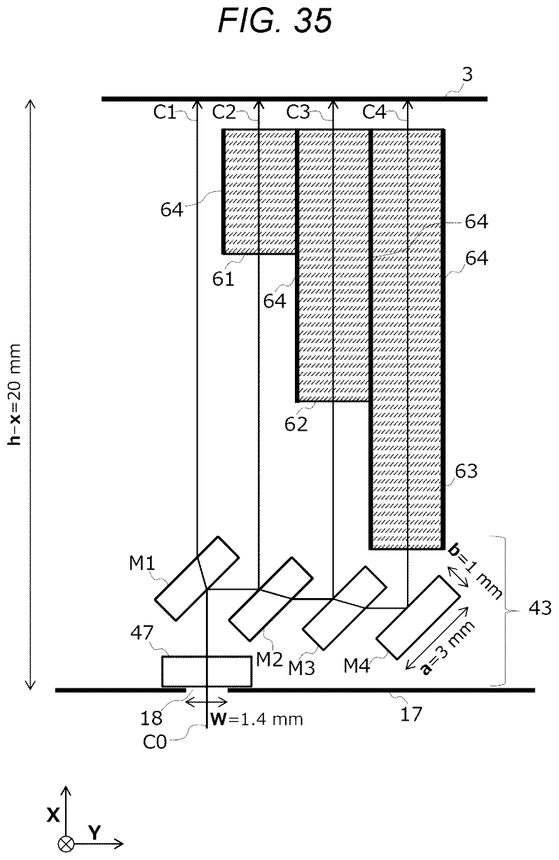

In FIG. 35, the side surfaces including the jointed surfaces of the optical-path-length-adjustment elements 61, 62, and 63 in FIG. 34 are made opaque. In this manner, each jointed surface between any adjacent two transparent solid members may be opaque. Specifically, black light-absorbing thin films 64 are formed on the side surfaces perpendicular to the Y-axis including the jointed surfaces. With such a configuration, interference between different split light beams can be avoided, and the images of the split light beams can be easily measured independently. Alternatively, quality degradation of the split images due to reflection of each split light beam on the side surfaces including the jointed surfaces, and each reflected split light beam overlaps with the split images, or the like can be avoided.

All of the four-split images can be focused on the image sensor 3 by the spectral imaging device according to the configuration using FIGS. 13, 14, and 34 in the second embodiment instead of the spectral imaging device according to the configuration using FIGS. 13, 14, and 15 in the second embodiment.

The conditions in the configuration using FIGS. 13, 14, and 15 in the second embodiment are D=10 mm, w=1.4 mm, p=2.5 mm, h=200 mm, d=0 mm, m=20, x=185 mm, or 190 mm (x/h=93% or 95%). Under the conditions, the third condition of (Expression 23) is satisfied. On the other hand, the conditions in the configuration using FIGS. 13, 14, and 34 in the second embodiment are D=10 mm, w=1.4 mm, p=2.5 mm, h=200 mm, d=0 mm, m=20, and x=180 mm (x/h=90%). Under the conditions, the second condition of (Expression 22) is satisfied, but the third condition of (Expression 23) is not satisfied. Accordingly, at least a part of the four-split images overlaps each other. In order to solve this newly generated problem, the following measures were added.

The specifications of the condensing lens 2 are changed from f=9.52 mm and D=10 mm to f=19.05 mm and D=10 mm. The distance between the condensing lens 2 and the image sensor 3 is changed from h=200 mm to h=400 mm. In this case, g=20 mm from (Expression 1), and m=20 from (Expression 2). Since h−x=20 mm as illustrated in FIG. 34, x=380 mm and x/h=95%. Accordingly, by these modifications, the third condition of (Expression 23) is satisfied by the configuration using FIG. 34. As a result, the four-split images can be prevented from overlapping each other at all. Because m=20 is maintained, the same four-split images as in FIGS. 23 and 29 to 33 can be acquired. Furthermore, as compared with the case of the second embodiment, all the four-split images can be accurately focused.

### Fourth Embodiment

Four-color spectral imaging using a four-split dichroic-mirror array is illustrated in the first to third embodiments. In a fourth embodiment, nine-color spectral imaging using a nine-split dichroic-mirror array is performed.

The device configuration follows FIGS. 13 and 14 except for the dichroic-mirror array. That is, the condensing lens 2 having f=9.52 mm and D=10 mm is used, and h=200 mm is set based on the design of the condensing lens 2. In this case, g=1 mm from (Expression 1), and m=20 from (Expression 2). Note that, the size of the image sensor 3 is enlarged to 15 mm (width in the Y-axis direction)×10 mm (width in the Z-axis direction).

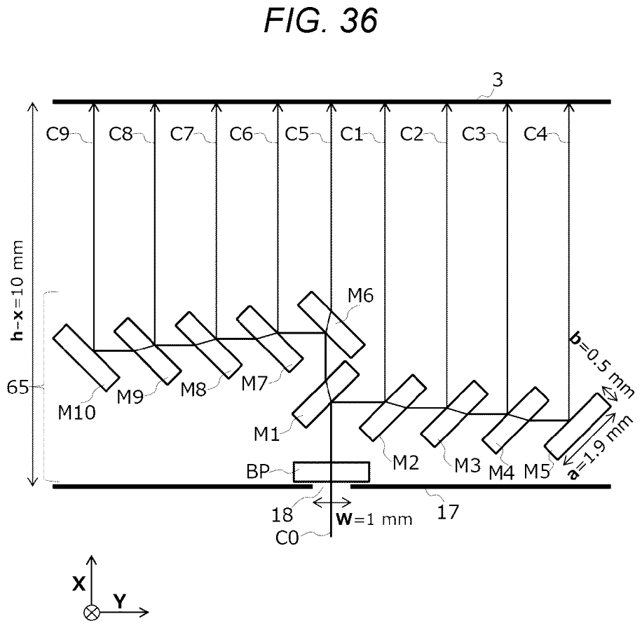

FIG. 36 illustrates structures of a nine-split dichroic-mirror array 65, an iris 17, an aperture 18, and an image sensor 3, which follow FIG. 29 of PTL 3. Similarly to FIG. 15, a right-handed XYZ-orthogonal-coordinate system is defined in FIG. 36. Note that the coordinate system-symbol is translated from its exact location in FIG. 36 for easier viewing. Only optical axes of a light beam C0 incident on the dichroic-mirror array 65 and nine-split light beams C1 to C9 split by and emitted from the dichroic-mirror array 65 are illustrated, and virtual parallel light beams 48 are not illustrated.

A bandpass filter BP is disposed immediately behind the aperture 18 (on the X-axis positive direction side of the aperture 18), and the dichroic mirror M1 is further disposed behind the bandpass filter BP (on the X-axis positive direction side of the bandpass filter BP). Subsequently, with the dichroic mirror M1 as a starting point, four dichroic mirrors M2, M3, M4, and M5 are arrayed at equal intervals in the right direction (the Y-axis positive direction). The dichroic mirrors M1 to M5 are shifted in a stepwise manner in the X-axis direction. The incident and emitting surfaces of the dichroic mirrors M1 to M5 are disposed so as to be perpendicular to a straight line Y=−X on the XY-plane.

On the other hand, a dichroic mirror M6 is disposed behind the dichroic mirror M1 (on the X-axis positive direction side of the dichroic mirror M1). Subsequently, with the dichroic mirror M6 as a starting point, four dichroic mirrors M7, M8, M9, and M10 are arrayed at equal intervals in the left direction (the Y-axis negative direction). The dichroic mirrors M6 to M10 are shifted in a stepwise manner in the X-axis direction. The incident and emitting surfaces of the dichroic mirrors M6 to M10 are disposed so as to be perpendicular to the straight line Y=X on the XY-plane.

Similarly to FIG. 15, the light beam C0 passes through the aperture 18 along the optical axis 4 and passes through the bandpass filter BP. The reflected light or scattered light of the laser beam 45 is blocked by the dichroic mirror 46 similarly to FIG. 13 (not transmitted through, but reflected by the dichroic mirror 46), and further blocked by the bandpass filter BP.

The light beam C0 transmitted through the bandpass filter BP is incident on the dichroic mirror M1 and is split into the reflected light traveling in the Y-axis positive direction and the transmitted light traveling in the X-axis positive direction. The reflected light beam by the dichroic mirror M1 is incident on the dichroic mirror M2 and is split into the transmitted light traveling in the Y-axis positive direction and the reflected light traveling in the X-axis positive direction. The reflected light beam by the dichroic mirror M2 is the split light beam C1, and is perpendicularly incident and imaged on the image sensor 3. The transmitted light beam through the dichroic mirror M2 is incident on the dichroic mirror M3 and is split into the transmitted light traveling in the Y-axis positive direction and the reflected light traveling in the X-axis positive direction. The reflected light beam by the dichroic mirror M3 is the split light beam C2, and is perpendicularly incident and imaged on the image sensor 3. The transmitted light beam through the dichroic mirror M3 is incident on the dichroic mirror M4 and is split into the transmitted light traveling in the Y-axis positive direction and the reflected light traveling in the X-axis positive direction. The reflected light beam by the dichroic mirror M4 is the split light beam C3, and is perpendicularly incident and imaged on the image sensor 3. The light beam transmitted through the dichroic mirror M4 is incident on and reflected by the dichroic mirror M5, and becomes the reflected light traveling in the X-axis positive direction. The reflected light beam by the dichroic mirror M5 is the split light beam C4, and is perpendicularly incident and imaged on the image sensor 3.

On the other hand, the transmitted light beam through the dichroic mirror M1 is incident on the dichroic mirror M6 and is split into the transmitted light traveling in the X-axis positive direction and the reflected light traveling in the Y-axis negative direction. The transmitted light beam through the dichroic mirror M6 is the split light beam C5, and is perpendicularly incident and imaged on the image sensor 3. The reflected light beam by the dichroic mirror M6 is incident on the dichroic mirror M7 and is split into the transmitted light traveling in the Y-axis negative direction and the reflected light traveling in the X-axis positive direction. The reflected light beam by the dichroic mirror M7 is the split light beam C6, and is perpendicularly incident and imaged on the image sensor 3. The transmitted light beam through the dichroic mirror M7 is incident on the dichroic mirror M8 and is split into the transmitted light traveling in the Y-axis negative direction and the reflected light traveling in the X-axis positive direction. The reflected light beam by the dichroic mirror M8 is the split light beam C7, and is perpendicularly incident and imaged on the image sensor 3. The light beam transmitted through the dichroic mirror M8 is incident on the dichroic mirror M9 and is split into the transmitted light traveling in the Y-axis negative direction and the reflected light traveling in the X-axis positive direction. The reflected light beam by the dichroic mirror M9 is the split light beam C8, and is perpendicularly incident and imaged on the image sensor 3. The light beam transmitted through the dichroic mirror M9 is incident on and reflected by the dichroic mirror M10, and becomes the reflected light traveling in the X-axis positive direction. The reflected light beam by the dichroic mirror M10 is the split light beam C9, and is perpendicularly incident and imaged on the image sensor 3.

Base materials of the bandpass filter BP and the dichroic mirrors M1 to M10 are quartz glass having a refractive index of 1.46. Sizes of the bandpass filter BP and the dichroic mirrors M1 to M10 are a width of a=1.9 mm (a dimension in the direction parallel to the XY-plane and parallel to the incident surface of the filter or each dichroic mirror), a thickness of b=0.5 mm (a dimension in the direction parallel to the XY-plane and perpendicular to the incident surface of the filter or each dichroic mirror), and a depth of c=15 mm (a dimension in the direction parallel to the Z-axis, not illustrated).

The array interval of the dichroic mirrors M1 to M5 and the dichroic mirrors M6 to M10 in the Y-axis direction is 1.6 mm. Note that, as can be seen from detailed analysis of FIG. 36, the distance between the split images of C1 and C2, the distance between the split images of C2 and C3, the distance between the split images of C3 and C4, the distance between the split images of C6 and C7, the distance between the split images of C7 and C8, and the distance between the split images of C8 C9 are 1.6 mm, respectively. The distance between the split images of C1 and C5, and the distance between the split images of C5 and C6 are slightly smaller than 1.6 mm. In the fourth embodiment, the mode value of 1.6 mm is set as the splitting pitch, p=1.6 mm.

The dichroic-mirror array 65 is arranged in a stepwise manner in the X-axis direction. That is, the dichroic mirror M2 is shifted relative to the dichroic mirror M1 by 0.35 mm in the X-axis negative direction. The dichroic mirror M3 is shifted relative to the dichroic mirror M2 by 0.16 mm in the X-axis negative direction. The dichroic mirror M4 is shifted relative to the dichroic mirror M3 by 0.16 mm in the X-axis negative direction. The dichroic mirror M5 is shifted relative to the dichroic mirror M4 by 0.16 mm in the X-axis negative direction. The dichroic mirror M7 is shifted relative to the dichroic mirror M6 by 0.35 mm in the X-axis negative direction. The dichroic mirror M8 is shifted relative to the dichroic mirror M7 by 0.16 mm in the X-axis negative direction. The dichroic mirror M9 is shifted relative to the dichroic mirror M8 by 0.16 mm in the X-axis negative direction. The dichroic mirror M10 is shifted relative to the dichroic mirror M9 by 0.16 mm in the X-axis negative direction. With the above configuration, as illustrated in FIG. 36, the aperture width w=1.4 mm is obtained. The aperture width in the depth direction is set to v=15 mm (not illustrated). (Expression 6) is satisfied because the effective diameter of the condensing lens 2 is D=10 mm.

On the other hand, since h−x=10 mm and h=200 mm as illustrated in FIG. 36, x=190 mm and x/h=95%. Accordingly, the third condition of (Expression 23) is satisfied, and therefore the nine split images can be simultaneously measured without overlapping each other. That is, spectral imaging by the snapshot method for measuring nine types of wavelength bands (nine colors) can be performed.

Hereinafter, a preferred structure for a dichroic-mirror array will be generalized according to PTL 3.

In a right-handed XYZ-orthogonal-coordinate system, in a dichroic-mirror array, m dichroic mirrors of DA1, DA2, . . . . DAm with m≥2 are arrayed in parallel with each other from the Y-axis negative direction toward the Y-axis positive direction. In addition, n dichroic mirrors of DB1, DB2, . . . . DBn with n≥2 are arrayed in parallel with each other in order from the Y-axis positive direction to the Y-axis negative direction. The dichroic mirror DAL and the dichroic mirror DB1 are arrayed along the X-axis. In the dichroic-mirror array,
(1) incident surfaces of the dichroic mirrors DA1 to DAm and the dichroic mirrors DB1 to DBn are perpendicular to the XY-plane,
(2) an inclination of a straight line on the XY-plane obtained by projecting a normal line of the incident surface of each of the dichroic mirrors DA1 to DAm on the XY-plane is negative, an inclination of a straight line on the XY-plane obtained by projecting a normal line of the incident surface of each of the dichroic mirrors DB1 to DBn on the XY-plane is positive, and the angle formed by each normal line of the incident surfaces of the dichroic mirrors DA1 to DAm and the dichroic mirrors DB1 to DBn with the X-axis is denoted by θ₀,
(3) a refractive index of a base material of the dichroic mirrors DA1 to DAm and the dichroic mirrors DB1 to DBn is denoted by n₀, an average of widths of these dichroic mirrors parallel to the XY-plane and in the direction perpendicular to the normal line of each incident surface is denoted by a, and an average of widths of these dichroic mirrors parallel to the XY-plane and in the direction parallel to the normal line of each incident surface is denoted by b,
(4) when positions of adjacent two dichroic mirrors DAj and DA(j+1) (where 1≤j≤(m−1)) on the XY-plane are compared, the dichroic mirror DA(j+1) has a larger Y-coordinate and the dichroic mirror DAj has a larger X-coordinate,
(5) when positions of the adjacent two dichroic mirrors DBj and DB(j+1) (where 1≤j≤(n−1)) on the XY-plane are compared, the dichroic mirror DBj has larger Y-coordinate and X-coordinate,
(6) the adjacent two dichroic mirrors DA1 and DB1 are on the X-axis, and the X-coordinate of the dichroic mirror DB1 is larger than the X-coordinate of the dichroic mirror DA1, and
(7) averages of array intervals of adjacent two dichroic mirrors DAj and DA(j+1) (where 2≤j≤(m−1)) and adjacent two dichroic mirrors DBj and DB(j+1) (where 2≤j≤(n−1)) in the Y-axis direction and the X-axis direction are denoted by Δy and Δx, respectively,
θ₀, n₀, a, b, Δy, and Δx satisfy a predetermined relationship such that an aperture width of the dichroic-mirror array in the Y-axis direction can be enlarged and such that optical-path lengths of the dichroic-mirror array can be reduced.

Specifically, (Expression A) or (Expression B) is preferably satisfied. Furthermore,
(8) when averages of the array intervals of the adjacent two dichroic mirrors DAL and DA2 and the adjacent two dichroic mirrors DB1 and DB2 in the Y-axis direction and the X-axis direction are denoted by Δy₀ and Δx₀, respectively,
(Expression C) or (Expression D) is preferably satisfied. In the above, setting θ₀=45° is most effective in many cases. In the case of θ₀≠45°, it may be preferable to incline an image sensor not parallel to the YZ-plane, for example, by θ₀ or θ₀−45°.

However, as in FIG. 15, because the optical-path lengths of the light beams forming the nine split images are different from each other, it is difficult to strictly focus all the nine split images on the image sensor 3. To solve the above-described difficulty, similarly to FIGS. 34 and 35, optical-path-length-adjustment elements are used to cancel differences in the optical-path lengths between the light beams. At the same time, similarly to the third embodiment, the specifications of the condensing lens 2 are changed from f=9.52 mm and D=10 mm to f=19.05 mm and D=10 mm, and the distance between the condensing lens 2 and the image sensor 3 is changed from h=200 mm to h=400 mm.

In the dichroic-mirror array 43 illustrated in FIG. 15, the plural dichroic mirrors are arrayed in one direction (Y-axis positive direction). On the other hand, in the dichroic-mirror array 65 illustrated in FIG. 36, the plural dichroic mirrors are arrayed in two directions (the Y-axis positive direction and the Y-axis negative direction) opposite to each other. Accordingly, when dichroic-mirror arrays having the same splitting number are compared, a maximum optical-path-length difference in a dichroic-mirror array according to FIG. 36 can further be reduced. This effect is described in detail in PTL 3.

Therefore, when optical-path-length differences in a dichroic-mirror array according to FIG. 36 are canceled using optical-path-length-adjustment elements proposed in the present specification, thicknesses of optical-path-length-adjustment elements can be reduced, which is more advantageous. That is, the effect is further enhanced by combining the method disclosed in the present specification with the method of PTL 3.

In the case of using the dichroic-mirror array 65 of FIG. 36, the optical-path-length differences of the split light beams are calculated. Since C5 has the shortest optical-path length, the optical-path-length difference of C5 is Δh=0 mm. Then, the optical-path-length difference of C1 is Δh=1.7 mm, the optical-path-length difference of C2 is Δh=3.2 mm, the optical-path-length difference of C3 is Δh=4.8 mm, the optical-path-length difference of C4 is Δh=6.3 mm, the optical-path-length difference of C6 is Δh=1.4 mm, the optical-path-length difference of C7 is Δh=2.9 mm, the optical-path-length difference of C8 is Δh=4.5 mm, and the optical-path-length difference of C9 is Δh=6.0 mm.

In the above calculations, reductions in the optical-path lengths due to each light beam passing through quartz glass having the refractive index of 1.46 that is the base material of each dichroic mirror are taken into consideration. High refractive-index glass having the refractive index of nₓ=2.00 is used as the members of the optical-path-length-adjustment elements. In this case, as calculated from (Expression 24), all the split light beams C1 to C9 can be simultaneously just focused on the image sensor 3 by inserting the high refractive-index glasses having thicknesses of t=3.4 mm, 6.5 mm, 9.6 mm, 12.7 mm, 0.0 mm, 2.7 mm, 5.8 mm, 8.9 mm, and 12.1 mm into the optical path of C1, C2, C3, C4, C5, C6, C7, C8, and C9, respectively. Note that no high refractive-index glasses are inserted into the optical path of C5 due to t=0.0 mm.

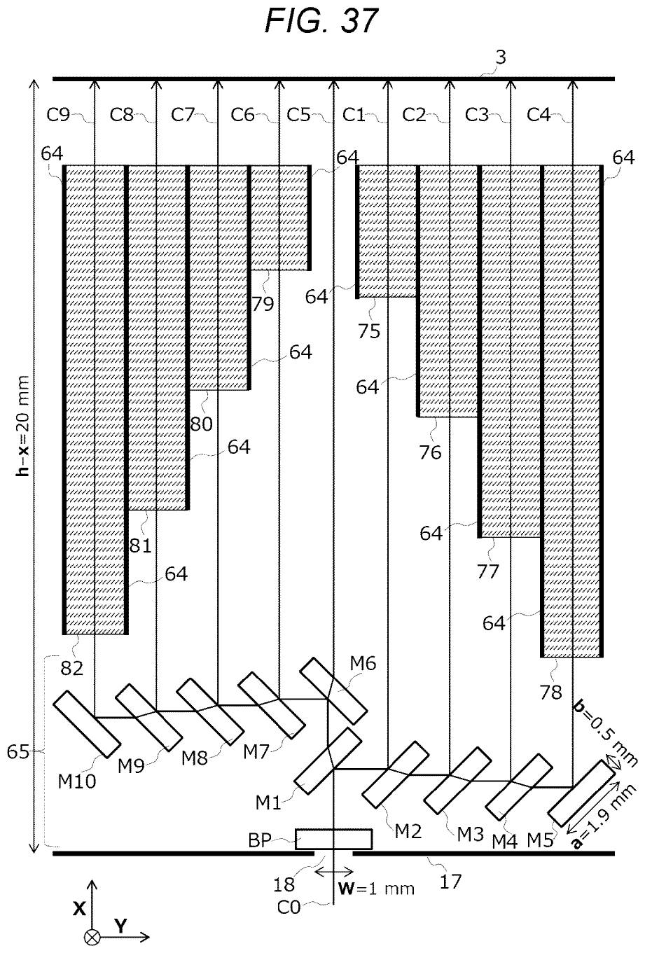

FIG. 37 illustrates a configuration where the above optical-path-length-adjustment elements are inserted between the dichroic-mirror array 65 and the image sensor 3 in FIG. 36. Note that, the distance h−x between the iris 17 or the aperture 18 and the image sensor 3 is enlarged from 10 mm to 20 mm. In this case, g=20 mm from (Expression 1), and m=20 from (Expression 2). Because of h=400 mm, x=380 mm and x/h=95%. Therefore, the third condition of (Expression 23) is satisfied by the configuration in FIG. 37. Accordingly, the nine-split images can be prevented from overlapping each other at all.

The member of the optical-path-length-adjustment elements is high refractive-index glass having the refractive index of nₓ=2.00. The thicknesses of optical-path-length-adjustment elements 75, 76, 77, 78, 79, 80, 81, and 82 inserted into the optical paths of C1, C2, C3, C4, C6, C7, C8, and C9 in the X-axis direction are t=3.4 mm, 6.5 mm, 9.6 mm, 12.7 mm, 2.7 mm, 5.8 mm, 8.9 mm, and 12.1 mm, respectively. Note that no high refractive-index glasses are inserted into the optical path of C5. The optical-path-length-adjustment elements 75 to 82 have the widths of 1.6 mm in the Y-axis direction and the depth of 15 mm in the Z-axis direction.

The incident surfaces and the emitting surfaces of the optical-path-length-adjustment elements 75 to 82 are perpendicular to the X-axis. More specifically, the incident surface and the emitting surface of each optical-path-length-adjustment element face the X-axis negative direction (the direction toward the dichroic-mirror array 64) and the X-axis positive direction (the direction toward the image sensor 3), respectively.

At least the regions through which each split light beam passes on each incident surface and each emitting surface is optically polished. Side surfaces of the optical-path-length-adjustment elements 75 to 78 perpendicular to the Y-axis between the optical-path-length-adjustment elements 75 and 76, between the optical-path-length-adjustment elements 76 and 77, and between the optical-path-length-adjustment elements 77 and 78 are jointed, and then the optical-path-length-adjustment elements 75 to 78 are integrated. On the other hand, side surfaces of the optical-path-length-adjustment elements 79 to 82 perpendicular to the Y-axis between the optical-path-length-adjustment elements 79 and 80, between the optical-path-length-adjustment elements 80 and 81, and between the optical-path-length-adjustment elements 81 and 82 are jointed, and then the optical-path-length-adjustment elements 79 to 82 are integrated. Similarly to FIG. 35, the black light-absorbing thin films 64 are formed on the side surfaces perpendicular to the Y-axis including the jointed surfaces.

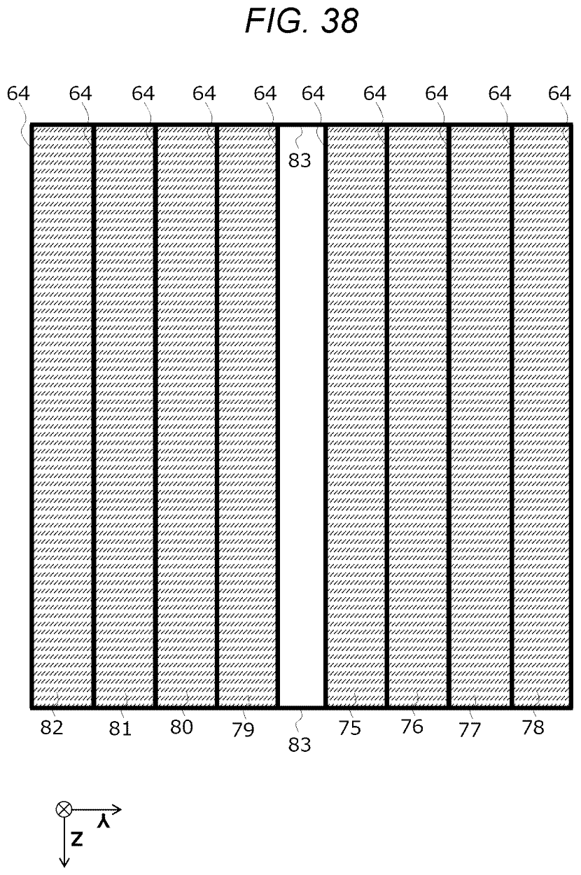

The X-coordinates of the emitting surfaces of the optical-path-length-adjustment elements 75 to 82 are made equal so that the emitting surfaces are aligned on the same plane. FIG. 38 illustrates the optical-path-length-adjustment elements 75 to 82 of FIG. 37 observed from the direction perpendicular to the YZ-plane. The optical-path-length-adjustment elements 75 to 78 and the optical-path-length-adjustment elements 79 to 82 are coupled by fixing surfaces of the optical-path-length-adjustment elements perpendicular to the Z-axis with bridges 83. As a result, the entire optical-path-length-adjustment elements 75 to 82 are integrated. The integration of the optical-path-length-adjustment elements 75 to 82 in this manner brings about the same effect as that of the third embodiment.

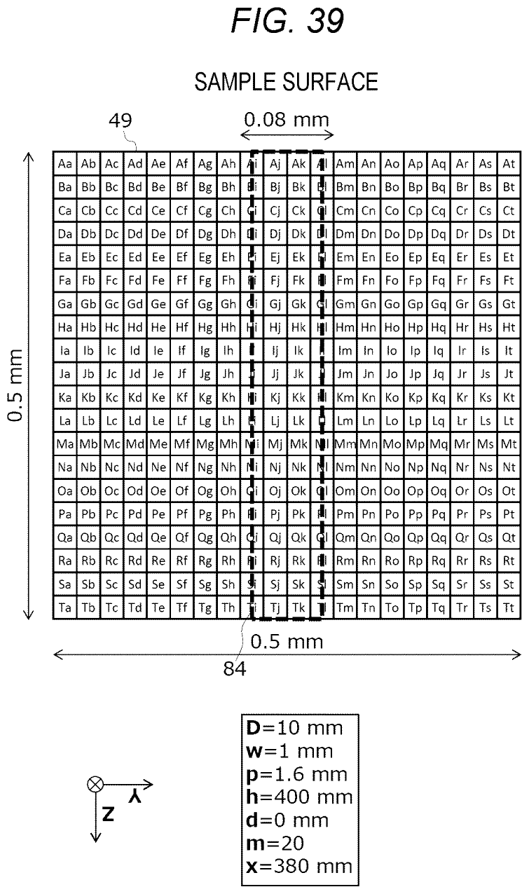

Similarly to FIG. 22, FIG. 39 illustrates a range of a measurement region 84 to be imaged by thick broken lines on the sample surface 49 in the case of D=10 mm, w=1 mm, p=1.6 mm, h=400 mm, d=0 mm, m=20, and x=380 mm. These conditions are also illustrated in the lower part in FIG. 39.

Under these conditions, because yₘ=0.04 mm is obtained from (Expression 20), the width of the measurement region 84 in the Y-axis direction is 2×yₘ=0.08 mm. The width of the measurement region 84 in the Z-axis direction is 0.5 mm that is the entire width of the sample, because the aperture width is sufficiently large (v=15 mm).

Characters on the sample surface 49 are the same as those in FIG. 18. Note that, characters described in each section indicate localized distributions of nine types of fluorophores, and each character emits fluorescence by laser-beam irradiation. Specifically, the details are as follows. Each character on the first line (the first character is A), the tenth line (the first character is J), and the nineteenth line (the first character is S) is labeled with a first fluorophore. Fluorescence emitted by the first fluorophore is measured only in the split image for C1. Each character on the second line (the first character is B), the eleventh line (the first character is K), and the twentieth line (the first character is T) is labeled with a second fluorophore. Fluorescence emitted by the second fluorophore is measured only in the split image for C2. Each character on the third line (the first character is C) and the twelfth line (the first character is L) is labeled with a third fluorophore. Fluorescence emitted by the third fluorophore is measured only in the split image for C3. Each character on the fourth line (the first character is D) and the thirteenth line (the first character is M) is labeled with a fourth fluorophore. Fluorescence emitted by the fourth fluorophore is measured only in the split image for C4. Each character on the fifth line (the first character is E) and the fourteenth line (the first character is N) is labeled with a fifth fluorophore. Fluorescence emitted by the fifth fluorophore is measured only in the split image for C5. Each character on the sixth line (the first character is F) and the fifteenth line (the first character is O) is labeled with a sixth fluorophore. Fluorescence emitted by the sixth fluorophore is measured only in the split image for C6. Each character on the seventh line (the first character is G) and the sixteenth line (the first character is P) is labeled with a seventh fluorophore. Fluorescence emitted by the seventh fluorophore is measured only in the split image for C7. Each character on the eighth line (the first character is H) and the seventeenth line (the first character is Q) is labeled with an eighth fluorophore. Fluorescence emitted by the eighth fluorophore is measured only in the split image for C8. Each character on the ninth line (the first character is I) and the eighteenth line (the first character is R) is labeled with a ninth fluorophore. Fluorescence emitted by the ninth fluorophore is measured only in the split image for C9.

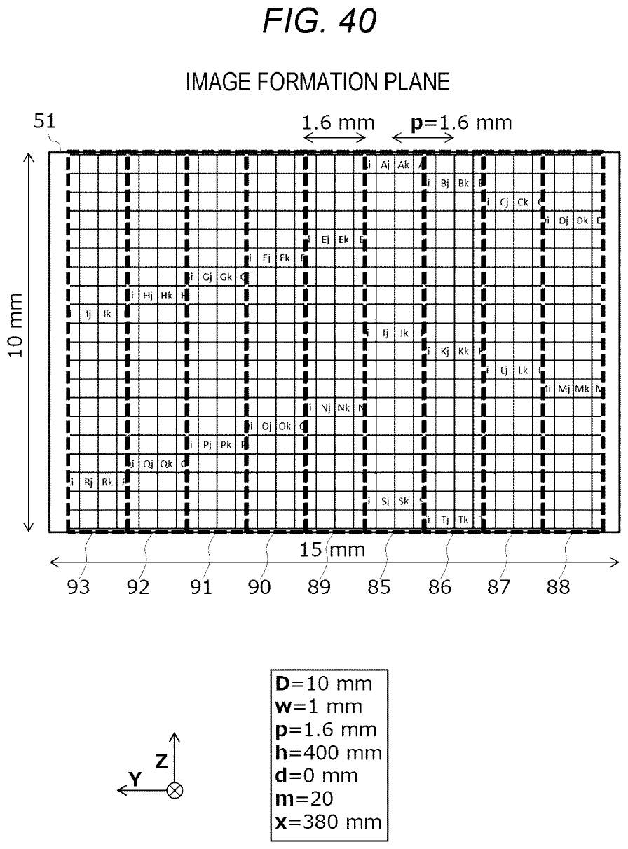

Similarly to FIG. 23, FIG. 40 illustrates the 15-mm×10-mm imaging region 51 of the image sensor 3 by the solid lines. The nine-split images of the measurement region 84 of the first split image 85 for C1, the second split image 86 for C2, the third split image 87 for C3, the fourth split image 88 for C4, the fifth split image 89 for C5, the sixth split image 90 for C6, the seventh split image 91 for C7, the eighth split image 92 for C8, and the ninth split image 93 for C9, with the image magnification m=20, are indicated by thick broken lines. Nine-color lights with different wavelength bands are selectively measured in the nine-split images, respectively.

The width of each of the nine-split images 85 to 93 in the Y-axis direction is 2×yₘ×m=1.6 mm, and their mutual interval is p=1.6 mm. Accordingly, the nine-split images 85 to 93 are simultaneously and independently measured without overlapping each other at all, and it can be confirmed from FIG. 40 that the third condition is satisfied. The total width of the nine-split images 85 to 93 in the Y-axis direction is 1.6×9=14.4 mm, and fits within the 15-mm width of the imaging region 51 of the image sensor 3 in the Y-axis direction.

Fluorescence emitted by the first fluorophore is measured only in the first split image for C1. Fluorescence emitted by the second fluorophore is measured only in the second split image for C2. Fluorescence emitted by the third fluorophore is measured only in the third split image for C3. Fluorescence emitted by the fourth fluorophore is measured only in the fourth split image for C4. Fluorescence emitted by the fifth fluorophore is measured only in the fifth split image for C5. Fluorescence emitted by the sixth fluorophore is measured only in the sixth split image for C6. Fluorescence emitted by the seventh fluorophore is measured only in the seventh split image for C7. Fluorescence emitted by the eighth fluorophore is measured only in the eighth split image for C8. Fluorescence emitted by the ninth fluorophore is measured only in the ninth split image for C9.

As described above, the 1.6-mm×10-mm image of the 0.08-mm×0.5-mm measurement region 84 on the sample surface 49 in which the nine types of fluorophores are two-dimensionally distributed with 20 times magnification is split into nine images with nine colors. The split images are simultaneously and independently measured without overlapping each other. Thus, the two-dimensional distribution of each of the nine types of fluorophores on the measurement region 84 can be identified. The two-dimensional distribution of the nine types of fluorophores on the measurement region 84 can be also indicated in a single image by overlaying these split images 85 to 93. Furthermore, all the nine-split images are tightly in focus, so that spectral imaging with high resolution and high analysis accuracy can be performed.

### REFERENCE SIGNS LIST

1 measurement region
2 condensing lens
3 image sensor
4 optical axis
5 to 7 light-emitting region
8 to 10 light-emitting-region image
9A A light-emitting-region image
9B B light-emitting-region image
9C C light-emitting-region image
11-12 light beam from light-emitting region 5
11 left-side contour of light beam 11-12
12 right-side contour of light beam 11-12
13-14 light beam from light-emitting region 6
13 left-side contour of light beam 13-14
14 right-side contour of light beam 13-14
15-16 light beam from light-emitting region 7
15 left-side contour of light beam 15-16
16 right-side contour of light beam 15-16
17 iris
18 aperture
19 to 21 weak light-emitting-region image
19A to 21A weak A light-emitting-region image
19B to 21B weak B light-emitting-region image
19C to 21C weak C light-emitting-region image
43 dichroic-mirror array
44 laser-light source
45 laser beam
46 dichroic mirror
47 long-pass filter
48 parallel light beam
49 sample surface
50 measurement region
51 imaging region of image sensor 3
52 to 55 four-split image of measurement region 50
56 measurement region
57 to 60 four-split image of measurement region 56
61 to 63 optical-path-length-adjustment element
64 black light-absorbing thin film
65 dichroic-mirror array
75 to 82 optical-path-length-adjustment element
83 bridge
84 measurement region
85 to 93 nine-split image of measurement region 84
A dichroic mirror
B dichroic mirror
BP bandpass filter
C dichroic mirror
C0 Light beam
C1 to C4 split light beam
D effective diameter of condensing lens
D1 to Dm dichroic mirror
E detection efficiency
M1 to M10 dichroic mirror
a width of dichroic mirror in direction parallel to incident surface on plane including optical axis of each split light beam
b width of dichroic mirror in direction perpendicular to incident surface on plane including optical axis of each split light beam
d size of light-emitting region in direction in which dichroic mirrors are arrayed
d′ size of weak light-emitting-region image in direction in which dichroic mirrors are arrayed
g distance between condensing lens and sample
h distance between condensing lens and image sensor
m image magnification
P splitting pitch
v aperture width of dichroic-mirror array in direction perpendicular to plane including optical axis of each split light beam
W aperture width of dichroic-mirror array in direction in which dichroic mirrors are arrayed
x distance between condensing lens and iris or aperture
y distance between light-emitting region and optical axis
y′ distance between weak light-emitting-region image and optical axis

1.-25. (canceled)

26. An optical device, wherein
a two-dimensionally distributed sample, a single condensing lens, a dichroic-mirror array in which plural dichroic mirrors are arrayed, and an image sensor are lined up in this order along an optical axis of the condensing lens,
a direction in which the plural dichroic mirrors are arrayed is perpendicular to the optical axis,
a light emitted from a measurement region on the sample and collected by the condensing lens is incident on the dichroic-mirror array, and the incident light is split into plural light beams having different wavelength components by the dichroic mirror array,
plural split images of the measurement region having different wavelength components are formed on and measured by the image sensor, and
an entrance of the dichroic-mirror array where the light first enter the dichroic-mirror array is closer to the image sensor than the condensing lens.

27. The optical device according to claim 26, wherein a lens does not exist between the dichroic-mirror array and the image sensor.

28. The optical device according to claim 26, wherein
the entrance is an aperture of the dichroic-mirror array provided in an iris,
the aperture is located adjacent to a side of the dichroic-mirror array facing the condensing lens, and
a width of the aperture in a direction in which the plural dichroic mirrors are arrayed is smaller than an effective diameter of the condensing lens.

29. An optical device, wherein, in a right-handed XYZ-orthogonal-coordinate system,
a sample two-dimensionally distributed in parallel with the YZ-plane, a single condensing lens having an optical axis aligned with the X-axis, a dichroic-mirror array in which m dichroic mirrors are arrayed in parallel with each other in the Y-axis direction with m being an integer greater than or equal to 2, and an image sensor parallel with the YZ-plane are disposed along the X-axis positive direction in the above order,
a light emitted from a measurement region on the sample and collected by the condensing lens is incident on the dichroic mirror array, and the incident light is split into m light beams having different wavelength components by the dichroic mirror array,
m split images of the measurement region having different wavelength components are formed on and measured by the image sensor,
an aperture of the dichroic-mirror array where the light first enter the dichroic-mirror array provided in an iris is located adjacent to a side of the dichroic-mirror array facing the condensing lens on the X-axis, and
when a distance between the condensing lens and the image sensor in the X-axis direction is denoted by h, and a distance between the condensing lens and the aperture in the X-axis direction is denoted by x,
$$[ Mathematical formula 1 ]$$
$$0.5 < \frac{x}{h} < 1$$
is satisfied.

30. The optical device according to claim 29, wherein a lens does not exist between the dichroic-mirror array and the image sensor.

31. The optical device according to claim 29, wherein, when an effective diameter of the condensing lens is denoted by D and a width of the aperture in the Y-axis direction is denoted by w,
$$[ Mathematical formula 2 ]$$
$$D > w$$
is satisfied.

32. The optical device according to claim 29, wherein, when an effective diameter of the condensing lens is denoted by D, a width of the aperture in the Y-axis direction is denoted by w, and an average of intervals between the m images is denoted by p,
$$[ Mathematical Formula 3 ]$$
$$\frac{D + w}{D + 2 \cdot p} \leq \frac{x}{h} \leq 1$$
is satisfied.

33. The optical device according to claim 29, wherein, when an effective diameter of the condensing lens is denoted by D and a width of the aperture in the Y-axis direction is denoted by w,
$$[ Mathematical Formula 4 ]$$
$$\frac{D - w}{D} \leq \frac{x}{h} \leq 1$$
is satisfied.

34. The optical device according to claim 29, wherein, when an effective diameter of the condensing lens is denoted by D, a width of the aperture in the Y-axis direction is denoted by w, and an average of intervals between the m images is denoted by p,
$$[ Mathematical formula 5 ]$$
$$\frac{D + w}{D + p} \leq \frac{x}{h} \leq 1$$
is satisfied.

35. The optical device according to claim 29, wherein, when the m dichroic mirrors are D1, D2, . . . , Dm in order from a negative direction to a positive direction of the Y-axis,
incident surfaces of the m dichroic mirrors are perpendicular to the XY-plane, and an inclination of a straight line on the XY-plane obtained by projecting each normal line of the incident surfaces of the m dichroic mirrors onto the XY-plane is negative, and
when an angle formed by each normal line of the incident surfaces of the m dichroic mirrors and the X-axis is defined as θ₀, and
a refractive index of a substrate of the m dichroic mirrors is denoted by n₀, an average of widths of the m dichroic mirrors in a direction parallel to the XY-plane and perpendicular to each normal line of the incident surfaces is denoted by a, and an average of widths of the m dichroic mirrors in a direction parallel to the XY-plane and parallel to each normal line of the incident surfaces is denoted by b,
the dichroic mirror D1 is on the X-axis,
the dichroic mirror D(j+1) has a larger Y-coordinate and the dichroic mirror Dj has a larger X-coordinate when positions of adjacent two dichroic mirrors Dj and D(j+1) (where 1≤j≤(m−1)) on the XY-plane are compared,
when an array interval of the adjacent two dichroic mirrors D1 and D2 in the Y-axis direction is denoted by Δy₀, and an array interval of the adjacent two dichroic mirrors D1 and D2 in the X-axis direction is denoted by Δx₀, and
an average of array intervals of the adjacent two dichroic mirrors Dj and D(j+1) (where 2≤j≤(m−1)) in the Y-axis direction is denoted by Δy, and an average of array intervals of the adjacent two dichroic mirrors Dj and D(j+1) in the X-axis direction is denoted by Δx,
θ₀, n₀, a, b, Δy₀, Δy, Δx₀, and Δx satisfy a predetermined relationship such that a width of the aperture in the Y-axis direction can be enlarged and such that optical-path lengths of the dichroic-mirror array can be reduced.

36. The optical device according to claim 35, wherein
$$[ Mathematical formula 6 ]$$
$$a \cdot cos ( {θ}_{0} ) \leq Δ {y}_{0} \leq 2 \cdot a \cdot cos ( {θ}_{0} ) + b \cdot sin ( {θ}_{0} )$$
$$a \cdot cos ( {θ}_{0} ) \leq Δ y \leq 2 \cdot a \cdot cos ( {θ}_{0} ) + b \cdot sin ( {θ}_{0} )$$
is satisfied.

37. The optical device according to claim 35, wherein, when θ₂=sin⁻¹(1/n₀×sin(θ₀)),
$$[ Mathematical formula 7 ]$$
$$0 \leq Δ {x}_{0} \leq 2 \cdot b \cdot sin ( {θ}_{0} )$$
$$0 \leq Δ x \leq 2 \cdot b \cdot sin ( {θ}_{0} - {θ}_{2} ) / cos ( {θ}_{2} )$$
is satisfied.

38. An optical device, wherein, in a right-handed XYZ-orthogonal-coordinate system,
a sample two-dimensionally distributed in parallel with the YZ-plane, a single condensing lens having an optical axis aligned with the X-axis,
a dichroic-mirror array in which m dichroic mirrors DA1, DA2, . . . , DAm are arrayed in parallel with each other in order from a negative direction to a positive direction of the Y-axis direction with m being an integer greater than or equal to 2, and n dichroic mirrors DB1, DB2, . . . , DBn are arrayed in parallel with each other in order from the positive direction to the negative direction of the Y-axis direction with n being an integer greater than or equal to 2,
an image sensor parallel with the YZ-plane
the sample, the dichroic-mirror array, and the image sensor are lined up along the X-axis positive direction in the above order,
a light emitted from a measurement region on the sample and collected by the condensing lens is incident on the dichroic mirror array, and the incident light is split into (m+n−1) light beams having different wavelength components by the dichroic mirror array,
(m+n−1) split images of the measurement region having different wavelength components are formed on and measured by the image sensor,
an aperture of the dichroic-mirror array where the light first enter the dichroic-mirror array provided in an iris is located adjacent to a side of the dichroic-mirror array facing the condensing lens on the X-axis, and
when a distance between the condensing lens and the image sensor in the X-axis direction is denoted by h, and a distance between the condensing lens and the aperture in the X-axis direction is denoted by x,
$$[ Mathematical formula 1 ]$$
$$0.5 < \frac{x}{h} < 1$$
is satisfied.

39. The optical device according to claim 38, wherein,
incident surfaces of the m dichroic mirrors and the n dichroic mirrors are perpendicular to the XY-plane, a straight line obtained by projecting each normal line of the incident surfaces of the m dichroic mirrors onto the XY-plane has a negative inclination in the XY-plane, and a straight line obtained by projecting each normal line of the incident surfaces of the n dichroic mirrors onto the XY-plane has a positive inclination in the XY-plane,
when an angle formed by each normal line of the incident surfaces of the m dichroic mirrors and the n dichroic mirrors with respect to the X-axis is θ₀, and
a refractive index of a substrate of the m dichroic mirrors and the n dichroic mirrors is denoted by n₀, an average of widths of the m dichroic mirrors and the n dichroic mirrors in a direction parallel to the XY-plane and perpendicular to each normal line of the incident surfaces is denoted by a, and an average of widths of the m dichroic mirrors and the n dichroic mirrors in a direction parallel to the XY-plane and parallel to each normal line of the incident surfaces is denoted by b,
the adjacent two dichroic mirrors DA1 and DB1 are on the X-axis, and an X-coordinate of the dichroic mirror DB1 is larger than the X-coordinate of the dichroic mirror DA1,
the dichroic mirror DA(j+1) has a larger Y-coordinate and the dichroic mirror DAj has a larger X-coordinate when positions of adjacent two dichroic mirrors DAj and DA(j+1) (where 1≤j≤(m−1)) on the XY-plane are compared,
the dichroic mirror DBj has a larger Y-coordinate and a larger X coordinate when positions of adjacent two dichroic mirrors DBj and DB(j+1) (where 1≤j≤(n−1)) on the XY-plane are compared,
when an average of an array interval of the adjacent two dichroic mirrors DA1 and DA2 in the Y-axis direction and an array interval of the adjacent two dichroic mirrors DB1 and DB2 in the Y-axis direction is denoted by Δy₀,
an average of an array interval of the adjacent two dichroic mirrors DA1 and DA2 in the X-axis direction and an array interval of the adjacent two dichroic mirrors DB1 and DB2 in the X-axis direction is denoted by Δx₀, and
an average of array intervals of adjacent two dichroic mirrors DAj and DA(j+1) (where 2≤j≤(m−1)) in the Y-axis direction and array intervals of adjacent two dichroic mirrors DBj and DB(j+1) (where 2≤j≤(n−1) in the Y-axis direction is denoted by Δy, and an average of array intervals of adjacent two dichroic mirrors DAj and DA(j+1) (where 2≤j≤(m−1)) in the X-axis direction and array intervals of adjacent two dichroic mirrors DBj and DB(j+1) (where 2≤j≤(n−1)) in the X-axis direction is denoted by Δx,
θ₀, n₀, a, b, Δy₀, Δy, Δx₀, and Δx satisfy a predetermined relationship such that a width of the aperture in the Y-axis direction can be enlarged and such that optical-path lengths of the dichroic-mirror array can be reduced.

40. The optical device according to claim 39, wherein
$$[ Mathematical Formula 8 ]$$
$$a \cdot cos ( {θ}_{0} ) \leq Δ {y}_{0} \leq 2 \cdot a \cdot cos ( {θ}_{0} ) + b \cdot sin ( {θ}_{0} )$$
$$a \cdot cos ( {θ}_{0} ) \leq Δ y \leq 2 \cdot a \cdot cos ( {θ}_{0} ) + b \cdot sin ( {θ}_{0} )$$
is satisfied.

41. The optical device according to claim 39, wherein, when θ₂=sin⁻¹(1/n₀×sin(θ₀)),
$$[ Mathematical formula 9 ]$$
$$0 \leq Δ {x}_{0} \leq 2 \cdot b \cdot sin ( {θ}_{0} )$$
$$0 \leq Δ x \leq 2 \cdot b \cdot sin ( {θ}_{0} - {θ}_{2} ) / cos ( {θ}_{2} )$$
is satisfied.

42. The optical device according to claim 35, wherein θ₀=45°.
